(19) United States
(12) Patent Application Publication
(10) Pub. No.: US 2023/0161093 A1
(43) Pub. Date: May 25, 2023

(54) LIGHT GUIDE DISPLAY SYSTEM FOR PROVIDING INCREASED POWER EFFICIENCY

(71) Applicant: Meta Platforms Technologies, LLC, Menlo Park, CA (US)

(72) Inventors: Xiayu FENG, Kirkland, WA (US); Sihui HE, Sunnyvale, CA (US); Zhexin ZHAO, Redmond, WA (US); Lu LU, Kirkland, WA (US)

(21) Appl. No.: 17/535,450

(22) Filed: Nov. 24, 2021

(51) Int. Cl. F21V 8/00; G02B 27/01; G02B 6/34

(52) U.S. Cl. CPC G02B 6/0016; G02B 27/0172; G02B 6/34; G02B 6/0038

(57) ABSTRACT

A device includes a light guide. The device also includes an in-coupling element coupled with the light guide and configured to couple a first image light into the light guide as a second image light propagating inside the light guide via total internal reflection (“TIR”), and to couple a portion of the second image light out of the light guide as a third image light. The device further includes a recycling element coupled with the light guide and configured to couple the third image light back into the light guide as a fourth image light propagating inside the light guide via TIR.

### TECHNICAL FIELD

The present disclosure relates generally to optical devices and, more specifically, to a light guide display system for providing an increased power efficiency.

### BACKGROUND

An artificial reality system, such as a head-mounted display (“HMD”) or heads-up display (“HUD”) system, generally includes a near-eye display (“NED”) system in the form of a headset or a pair of glasses, and configured to present content to a user via an electronic or optic display within, for example, about 10-20 mm in front of the eyes of a user. The NED system may display virtual objects or combine images of real objects with virtual objects, as in virtual reality (“VR”), augmented reality (“AR”), or mixed reality (“MR”) applications. For example, in an AR system, a user may view both images of virtual objects (e.g., computer-generated images (“CGIs”)) and the surrounding environment by, for example, seeing through transparent display glasses or lenses (also referred to as an optical see-through AR system).

One example of an optical see-through AR system may include a pupil-expansion light guide display system, in which an image light representing a CGI may be coupled into a light guide (e.g., a transparent substrate), propagate within the light guide, and be coupled out of the light guide at different locations to expand an effective pupil. Diffractive optical elements may be coupled with the light guide to couple the image light into or out of the light guide via diffraction, such as surface relief gratings, holographic gratings, metasurface gratings, etc.

### SUMMARY OF THE DISCLOSURE

Consistent with an aspect of the present disclosure, a device is provided. The device includes a light guide. The device also includes an in-coupling element coupled with the light guide and configured to couple a first image light into the light guide as a second image light propagating inside the light guide via total internal reflection (“TIR”), and to couple a portion of the second image light out of the light guide as a third image light. The device further includes a recycling element coupled with the light guide and configured to couple the third image light back into the light guide as a fourth image light propagating inside the light guide via TIR.

Consistent with another aspect of the present disclosure, a device is provided. The device includes a light guide. The device also includes an in-coupling grating coupled with the light guide and configured to couple, via diffraction, a first image light having a first polarization into the light guide as a second image light propagating inside the light guide via total internal reflection (“TIR”). The device also includes a retardation film coupled with the light guide and configured to convert the second image light incident thereon as a third image light having a second polarization that is orthogonal to the first polarization. The in-coupling grating is configured to receive the third image light having the second polarization from the retardation film and allow the third image light to propagate inside the light guide via TIR as a fourth image light.

Consistent with another aspect of the present disclosure, a device is provided. The device includes a light guide. The device also includes an in-coupling element coupled with the light guide and configured to couple a first image light into the light guide as a second image light. The device also includes an out-coupling element coupled with the light guide and including a plurality of out-coupling gratings configured to be selectively activated to couple the second image light out of the light guide. The device also includes at least one redirecting element coupled with the light guide. The device further includes a controller configured to control the in-coupling element to selectively direct the second image light to propagate in one of a plurality of selectable directions inside the light guide. The at least one redirecting element is configured to redirect the second image light when the second image light is received from the in-coupling element, to propagate toward a predetermined portion of the out-coupling element.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIGS. 1A and 1B schematically illustrate diagrams of a conventional light guide display system implemented in a near-eye display (“NED”);

FIGS. 2A and 2B schematically illustrate diagrams of a light guide display system configured to provide an increased power efficiency, according to an embodiment of the present disclosure;

FIG. 2C schematically illustrates a diagram of a light guide display system configured to provide an increased power efficiency, according to an embodiment of the present disclosure;

FIGS. 3A and 3B schematically illustrate diagrams of a light guide display system configured to provide an increased power efficiency, according to an embodiment of the present disclosure;

FIG. 3C schematically illustrates a diagram of a light guide display system configured to provide an increased power efficiency, according to an embodiment of the present disclosure;

FIG. 4A schematically illustrates a diagram of a light guide display system configured to provide an active eye-box, according to an embodiment of the present disclosure;

FIG. 4B schematically illustrates a three-dimensional (“3D”) view of light propagating paths in a light guide shown in FIG. 4A, according to an embodiment of the present disclosure;

FIGS. 4C-4E schematically illustrates diagrams of light propagating paths in a light guide shown in FIG. 4A, according to various embodiments of the present disclosure;

FIG. 4F schematically illustrates a diagram of a light guide display system configured to provide an active eye-box, according to an embodiment of the present disclosure;

FIG. 5A schematically illustrates a diagram of an optical system configured to provide an increased power efficiency, according to an embodiment of the present disclosure;

FIG. 5B schematically illustrates a diagram of an optical system configured to provide an increased power efficiency, according to an embodiment of the present disclosure;

FIG. 6A is a flowchart illustrating a method for providing an increased power efficiency according to an embodiment of the present disclosure;

FIG. 6B is a flowchart illustrating a method for providing an increased power efficiency according to an embodiment of the present disclosure;

FIG. 6C is a flowchart illustrating a method for providing an increased power efficiency according to an embodiment of the present disclosure;

FIG. 7A schematically illustrates a diagram of a near-eye display (“NED”), according to an embodiment of the present disclosure;

FIG. 7B schematically illustrates a cross-sectional view of half of the NED shown in FIG. 7A, according to an embodiment of the present disclosure;

FIGS. 8A and 8B illustrate schematic diagrams of a grating in a diffraction state and a non-diffraction state, respectively, according to an embodiment of the present disclosure;

FIGS. 9A and 9D illustrate schematic diagrams of a grating in a non-diffraction state, according to an embodiment of the present disclosure;

FIGS. 9B and 9E illustrate schematic diagrams of the grating shown in FIG. 9A in a diffraction state, according to an embodiment of the present disclosure;

FIGS. 9C and 9F illustrate schematic diagrams of the grating shown in FIG. 9A in a diffraction state, according to an embodiment of the present disclosure;

FIG. 9G illustrates a schematic diagram of the grating shown in FIG. 9A implemented into a light guide display assembly disclosed herein, according to an embodiment of the present disclosure;

FIGS. 10A and 10B illustrate schematic diagrams of a grating in a diffraction state and a non-diffraction state, respectively, according to an embodiment of the present disclosure;

FIGS. 10C and 10D illustrate schematic diagrams of a grating in a diffraction state and a non-diffraction state, respectively, according to an embodiment of the present disclosure;

FIG. 11A schematically illustrates a three-dimensional (“3D”) view of a liquid crystal polarization hologram (“LCPH”) element, according to an embodiment of the present disclosure;

FIGS. 11B-11D schematically illustrate various views of a portion of the LCPH element shown in FIG. 11A, showing in-plane orientations of optically anisotropic molecules in the LCPH element, according to various embodiments of the present disclosure; and

FIGS. 11E-11H schematically illustrate various views of a portion of the LCPH element shown in FIG. 11A, showing out-of-plane orientations of optically anisotropic molecules in the LCPH element, according to various embodiments of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The term “film plane” refers to a plane in the film, layer, coating, or plate that is perpendicular to the thickness direction. The film plane may be a plane in the volume of the film, layer, coating, or plate, or may be a surface plane of the film, layer, coating, or plate. The term “in-plane” as in, e.g., “in-plane orientation,” “in-plane direction,” “in-plane pitch,” etc., means that the orientation, direction, or pitch is within the film plane. The term “out-of-plane” as in, e.g., “out-of-plane direction,” “out-of-plane orientation,” or “out-of-plane pitch” etc., means that the orientation, direction, or pitch is not within a film plane (i.e., is non-parallel with a film plane). For example, the direction, orientation, or pitch may be along a line that is perpendicular to a film plane, or that forms an acute or obtuse angle with respect to the film plane. For example, an “in-plane” direction or orientation may refer to a direction or orientation within a surface plane, an “out-of-plane” direction or orientation may refer to a thickness direction or orientation non-parallel with (e.g., perpendicular to) the surface plane.

The wavelength ranges, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof. The term “substantially” or “primarily” used to modify an optical response action, such as “transmit,” “reflect,” “diffract,” “block” or the like that describes processing of a light means that a major portion, including all, of a light is transmitted, reflected, diffracted, or blocked, etc. The major portion may be a predetermined percentage (greater than 50%) of the entire light, such as 100%, 98%, 90%, 85%, 80%, etc., which may be determined based on specific application needs.

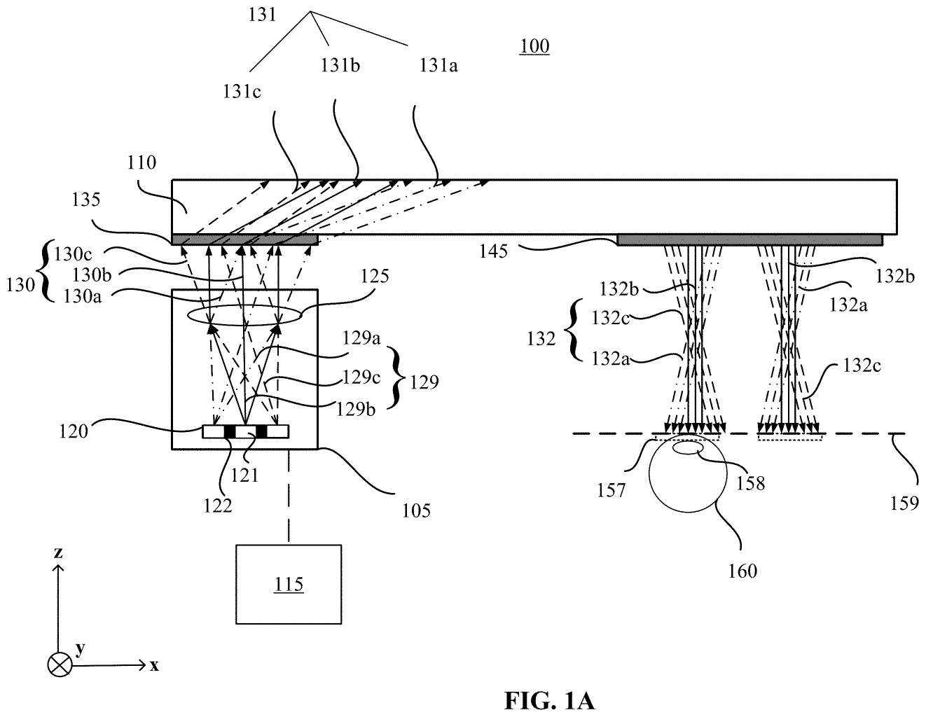

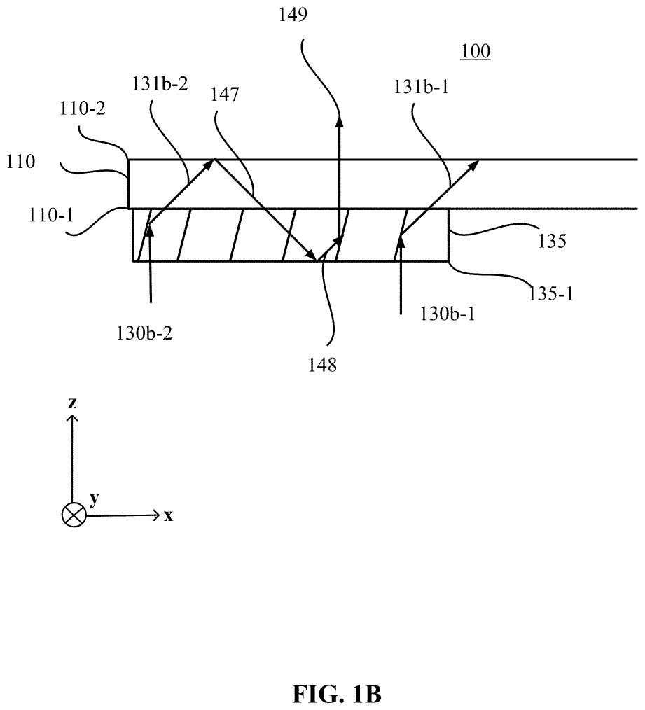

FIG. 1A illustrates an x-z sectional view of a conventional light guide display system or assembly 100 implemented into an NED. As shown in FIG. 1A, the system 100 may include a light source assembly 105, a light guide 110, and a controller 115. The system 100 may also include an in-coupling grating 135 and an out-coupling grating 145 coupled to the light guide 110. The light source assembly 105 may include a display element 120 and a collimating lens 125. The display element 120 may include a plurality of pixels 121 arranged in a pixel array, in which neighboring pixels 121 may be separated by, e.g., a black matrix 122. For illustrative purposes, FIG. 1A shows that the display element 120 includes three pixels 121. Any suitable number of pixels may be included in the display element 120. The display element 120 may output an image light 129, which includes bundles of divergent rays 129a, 129b, and 129c output from the respective pixels 121. For illustrative purpose, FIG. 1A shows three rays for each bundle. For example, three rays 129a are emitted from the left pixel 121, and three rays 129b are emitted from the middle pixel 121, and three rays 129c are emitted from the right pixel 121. The collimating lens 125 may convert the image light 129 into an input image light 130 propagating toward the light guide 110. The collimating lens 125 may convert the bundles of divergent rays 129a, 129b, and 129c to bundles of parallel rays 130a, 130b, and 130c, respectively. The respective bundles of parallel rays 130a, 130b, and 130c may have different incidence angles when the rays are incident onto the light guide 110. That is, the collimating lens 125 may transform or convert a linear distribution of the pixels 121 in the display element 120 into an angular distribution of the pixels 121 at the input side of the light guide 110.

The in-coupling grating 135 may couple, via diffraction, the input image light 130 into the light guide 110 as an in-coupled image light 131, which may propagate toward the out-coupling grating 145 via total internal reflection (“TIR”). For example, the in-coupling grating 135 may diffract the bundles of parallel rays 130a, 130b, or 130c as the bundles of parallel rays 131a, 131b, or 131c, respectively. The out-coupling grating 145 may couple, via diffraction, the input image light 130 as a plurality of output image lights 132, which may propagate toward a plurality of exit pupils 157 positioned in an eye-box region 159 of the system 100, respectively. For example, the out-coupling grating 145 may diffract the bundle of parallel rays 131a, 131b, or 131c as a plurality of bundles of parallel rays 132a, 132b, or 132c. Each output image light 132 may include a bundle of parallel rays 132a, a bundle of parallel rays 132b, and a bundle of parallel rays 132c. Thus, the combination of light guide 110, the in-coupling grating 135, and the out-coupling grating 145 may replicate the input image light 130 at the output side to expand an effective pupil of the system 100.

The eye-box region 159 is a region in space where an eye pupil 158 of an eye 160 of a user can perceive the full extent of the virtual image delivered by the light guide 110 from the light source assembly 105. The eye-box region 159 overlaps with all, or most, of the possible positions of the eye pupil 158 of the user. This feature, referred to as “pupil expansion,” creates the effect of a full real-life image as perceived by the user, rather than a moving eye pupil characteristic provided by other viewing instruments (e.g., binoculars, microscopes, or telescopes).

The parameters of the eye-box region 159 (e.g., position, size, depth) are affected by a desirable field of view (“FOV”) and a desirable eye relief of the NED. An FOV is defined as an angular size of the image (e.g., the angular size of the diagonal of the image) as seen by the eye 160 of the user. An eye relief is a distance between the eye pupil 158 and a nearest component of the NED. The size of the eye-box region 159 may decrease as the FOV and/or the eye relief increase. A large eye-box region 159 allows the user to move the eye pupil 158 in a wider range without losing sight of the image generated by the light source assembly 105, and provides a wide range of accommodation to interpupillary distance (“IPD”) variation among different users. Typical IPD values range between 51 mm to 77 mm, depending on the age, gender, and other physiological factors of the user. Although a large eye-box region 159 provides accommodation for eye movement in a wide range and IPD variation among different users, the image light out-coupled from the light guide 110 is distributed across the entire eye-box region 159. Thus, the average light intensity provided at the eye-box region 159 may be low, and the brightness of the image perceived by the eye pupil 158 may be low. On the other hand, the area of the eye pupil 158 only occupies a small portion of the eye-box region 159. The size of the eye pupil of an average adult user may vary in a range of 4-8 millimeters (“mm”) in diameter when dilated (e.g., when in dark), or in a range of 2-4 mm in diameter when constricted (e.g., in bright light). In other words, the size of the eye pupil may vary in the range of 2-8 mm depending on the light intensity (or brightness) of the image light. Therefore, the eye pupil 158 only receives a small portion of the image light propagating through the eye-box region 159. A significant portion of the image light propagating through the eye-box region 159 may not be received by the eye pupil 158, and may be lost. Accordingly, the light guide display system 100 may not be power efficient.

In addition, in the conventional light guide display system 100, the optical efficiency at the input side of the light guide 110 (or the input efficiency of the in-coupling grating) may be affected by the in-coupling grating 135. FIG. 1B illustrates an x-z sectional view showing the interactions between the bundle of parallel rays 130b and the light guide 110 coupled with the in-coupling grating 135. The bundle of parallel rays 130b may be referred to as an input image light 130b. The in-coupling grating 135 disposed at a first surface 110-1 of the light guide 110 may couple, via diffraction, the input image light 130b as an in-coupled image light 131b. For example, the input image light 130b may include a bundle of parallel rays, e.g., a ray 130b-1 being a rightmost ray of the bundle, and a ray 130b-2 being a leftmost ray of the bundle. The in-coupling grating 135 may couple, via diffraction, the rays 130b-1 and 130b-2 as in-coupled rays 131b-1 and 131b-2, respectively. The in-coupled ray 131b-1 may propagate inside the light guide 110 via TIR toward the out-coupling grating 145 (not shown in FIG. 1B), without interacting with the in-coupling grating 135 again.

The in-coupled ray 131b-2 may be reflected, via TIR, at a second surface 110-2 of the light guide 110 as a ray 147, which may propagate through the light guide 110 and the volume of the in-coupling grating 135 toward an interface 135-1 of the in-coupling grating 135 and an outside environment (e.g., air). The ray 147 may be reflected, via TIR, at the interface 135-1 as a ray 148 propagating back to the volume of the in-coupling grating 135. The in-coupling grating 135 may couple, via diffraction, the ray 148 out of the light guide 110 as a ray 149. That is, the in-coupling grating 135 may couple a portion of the in-coupled image light 131 (e.g., the in-coupled ray 131b-2) out of the light guide 110, and the ray 130b-2 of the input image light 130b may not propagate inside the light guide 110 via TIR toward the out-coupling grating 145. Thus, the optical efficiency at the input side of the light guide 110 (or the input efficiency of the in-coupling grating 135) may be reduced. Accordingly, the power efficiency of the light guide display system 100 may be low. The power efficiency of the light guide display system 100 may be directly affected by the input efficiency. Thus, when the input efficiency is increased, the overall power efficiency of the light guide display system can be increased.

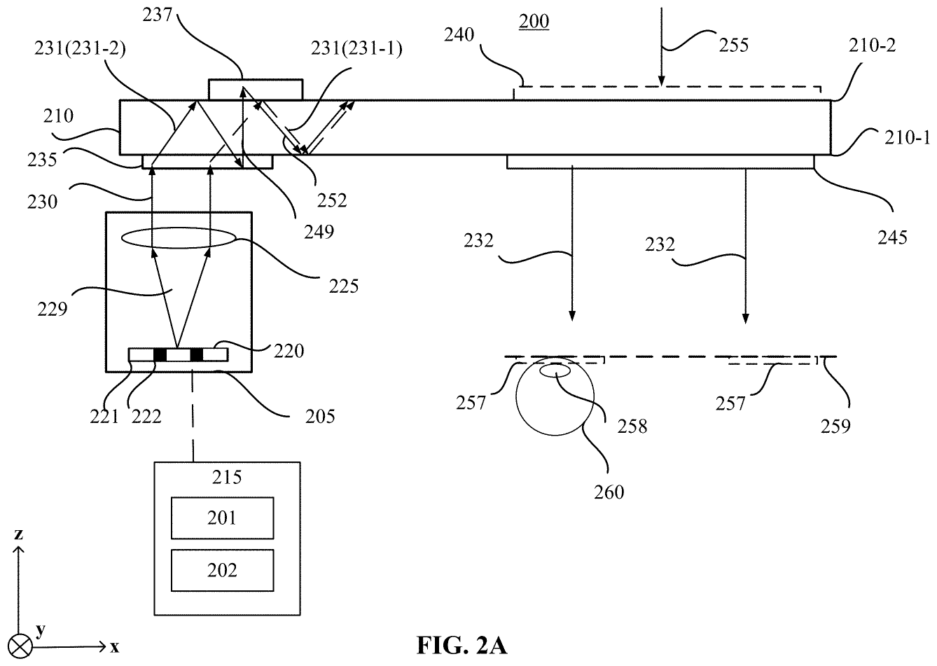

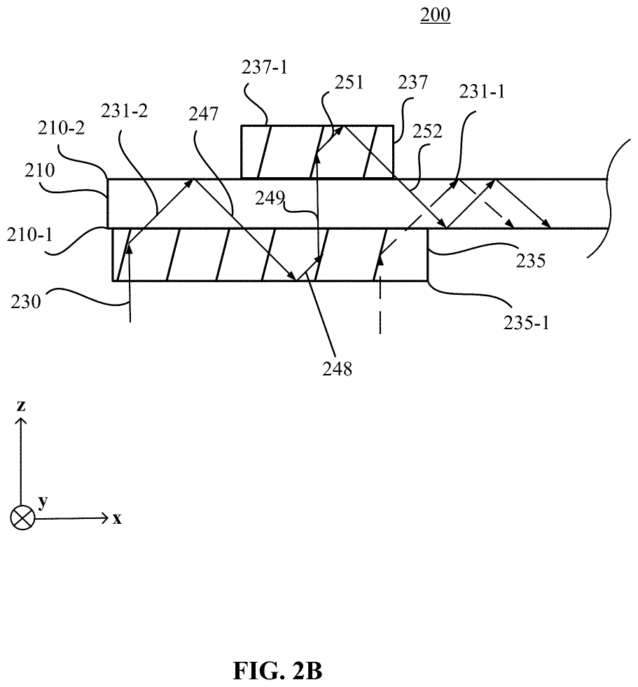

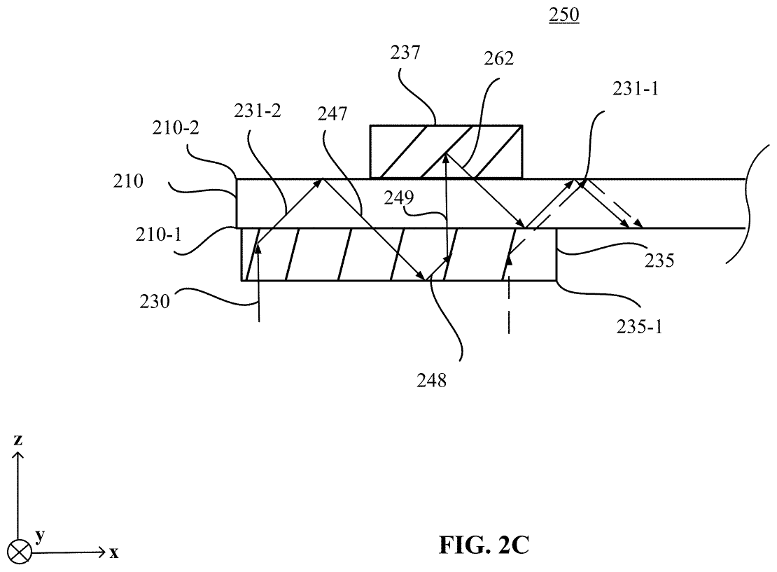

The present disclosure provides a light guide display system configured to provide an increased power efficiency. FIG. 2A illustrates a schematic diagram of a light guide display system or assembly 200 for providing an increased input efficiency, according to an embodiment of the present disclosure. As shown in FIG. 2A, the light guide display system 200 may include a light source assembly 205, a light guide 210, and a controller 215. The light source assembly 205 may include a display element 220 and a collimating lens 225. The light guide 210 may be coupled with an in-coupling element 235 and a recycling element 237 at an input side of the light guide 210, and coupled with an out-coupling element 245 at an output side of the light guide 210. The light source assembly 205 may output an input image light 230 toward the light guide 210. The in-coupling element 235 may couple the input image light 230 as an in-coupled image light 231 with a predetermined TIR propagation angle inside the light guide 210. When a light propagates within the light guide through TIR, the angle formed by the TIR path of a light/ray and the normal of the inner surface of the light guide (or the incidence angle of the light/ray incident onto the inner surface of the light guide) may be referred to as a TIR guided angle or a TIR propagation angle. A first portion 231-1 of the in-coupled image light 231 (referred to as a first in-coupled image light 231-1 for discussion purposes) may propagate inside the light guide 210 via TIR toward the out-coupling element 245, without interacting with the in-coupling element 235.

A second portion 231-2 of the in-coupled image light 231 (referred to as a second in-coupled image light 231-2 for discussion purposes) may interact with the in-coupling element 235 again as propagating inside the light guide 210 via TIR. The second in-coupled image light 231-2 may be coupled out of the light guide 210 by the in-coupling element 235, as an image light 249. The recycling element 237 may be configured to couple, via deflection, the image light 249 back into the light guide 210, as a third in-coupled image light 252. In some embodiments, the recycling element 237 may be configured to deflect the image light 249 as the third in-coupled image light 252 having the same predetermined TIR propagation angle as the in-coupled image light 231 inside the light guide 210. In other words, the third in-coupled image light 252 and the first in-coupled image light 231-1 may be configured to have substantially the same TIR propagation angle inside the light guide 210. The third in-coupled image light 252 may propagate inside the light guide 210 via TIR toward the out-coupling element 245. Because the image light 249, which would otherwise be coupled out of the light guide in a conventional light guide display system (e.g., shown in FIGS. 1A and 1B), is recycled by the recycling element 237 back into the light guide 210, the optical efficiency at the input side of the light guide 210 (or the input efficiency of the in-coupling grating 235) is increased. Accordingly, the power efficiency of the light guide display system 200 is increased.

The out-coupling element 245 may couple the combination of the first in-coupled image light 231-1 and the third in-coupled image light 252 propagating inside the light guide 210 at the same TIR propagation angle out of the light guide 210 as a plurality of output image lights 232. In some embodiments, the third in-coupled image light 252 and the second in-coupled image light 231-2 may be configured to also have substantially the same light intensity, and/or the same polarization state. For discussion purposes, in the disclosed embodiments, the third in-coupled image light 252 and the second in-coupled image light 231-2 are presumed to have substantially the same light intensity, and/or the same polarization state. Thus, the combination of the first in-coupled image light 231-1 and the third in-coupled image light 252 is presumed to be substantially the same as the in-coupled image light 231. That is, through the recycling element 237, light loss otherwise caused by the in-coupling element 235 coupling a portion of the in-coupled image light 231 out of the light guide 210, is significantly reduced.

The out-coupling element 245 may consecutively couple the in-coupled image light 231, which is incident onto the different positions of the out-coupling element 245, out of the light guide 210 at different positions of the out-coupling element 245. Thus, the out-coupling element 245 may replicate the input image light 230 at the output side of the light guide 210, to expand an effective pupil of the light guide display system 200. Because the first in-coupled image light 231-1 and the third in-coupled image light 252 propagate inside the light guide 210 at the same TIR propagation angle, the out-coupled image light of the first in-coupled image light 231-1 and the out-coupled image light of the third in-coupled image light 252 may form the same image, and no ghost image may be formed by the recycled third in-coupled image light 252 at the output side of the light guide 210.

The output image lights 232 may propagate toward a plurality of exit pupils 257 positioned in an eye-box region 259 of the light guide display system 200, respectively. The exit pupil 257 may be a location where an eye pupil 258 of an eye 260 of a user is positioned in the eye-box region 259 to receive the content of a virtual image output from the display element 220. In some embodiments, the exit pupils 257 may be arranged in a one-dimensional (“1D”) or a two-dimensional (“2D”) array within the eye-box region 259. The size of a single exit pupil 257 may be larger than and comparable with the size of the eye pupil 258. The exit pupils 257 may be sufficiently spaced apart, such that when one of the exit pupils 257 substantially coincides with the position of the eye pupil 258, the remaining one or more exit pupils 257 may be located beyond the position of the eye pupil 258 (e.g., falling outside of the eye 260). In some embodiments, all of the exit pupils 257 may be simultaneously available at the eye-box region 259. In some embodiments, one or more of the exit pupils 257 (but not all of the exit pupils 257) may be simultaneously available at the eye-box region 259, e.g., depending on the position of the eye pupil 258. In some embodiments, the light guide 210 may also receive a light 255 from a real-world environment, and may combine the light 255 with the output image light 232, and deliver the combined light to the eye pupil 258.

In some embodiments, each of the in-coupling element 235, the recycling element 237, and the out-coupling element 245 may be formed or disposed at (e.g., affixed to) a first surface 210-1 or a second surface 210-2 of the light guide 210. In some embodiments, each of the in-coupling element 235, the recycling element 237, and the out-coupling element 245 may be integrally formed as a part of the light guide 210, or may be a separate element coupled to the light guide 210. In some embodiments, the in-coupling element 235 and the recycling element 237 may be disposed at different surfaces of the light guide 210. For discussion purposes, FIG. 2A shows that the recycling element 237 and the in-coupling element 235 are disposed at opposite surfaces of the light guide 210, e.g., the in-coupling element 235 is disposed at the first surface 210-1 of the light guide 210, and the recycling element 237 and the out-coupling element 245 are disposed at the second surface 210-2 of the light guide 210. The recycling element 237 may at least partially overlap with the in-coupling element 235 along the light guide 210 in the direction from the in-coupling element 235 to the out-coupling element 245 (e.g., along the x-axis direction).

In some embodiments, the in-coupling element 235, the recycling element 237, or the out-coupling element 245 may include one or more diffraction gratings, one or more cascaded reflectors, one or more prismatic surface elements, an array of holographic reflectors, or any combination thereof. In some embodiments, each of the in-coupling element 235, the recycling element 237, and the out-coupling element 245 may include one or more diffraction gratings. Examples of diffraction gratings may include a holographic polymer-dispersed liquid crystal (“H-PDLC”) grating, a surface relief grating, a volume hologram, a polarization selective grating, a liquid crystal polarization hologram (“LCPH”) grating based on liquid crystals (“LCs”) (such as a Pancharatnam-Berry phase (“PBP”) grating, a polarization volume hologram (“PVH”) grating, etc.), a polarization hologram grating based on a birefringent photo-refractive holographic material other than LCs, a metasurface grating, etc. The diffraction grating may be a reflective or transmissive grating. The diffraction grating may be a passive or active grating. The diffraction grating may be polarization sensitive (or polarization selective) or polarization insensitive (or polarization non-selective).

The display element 220 may include a display panel, such as a liquid crystal display (“LCD”) panel, a liquid-crystal-on-silicon (“LCoS”) display panel, an organic light-emitting diode (“OLED”) display panel, a micro light-emitting diode (“micro-LED”) display panel, a laser scanning display panel, a digital light processing (“DLP”) display panel, or a combination thereof. In some embodiments, the display element 220 may include a self-emissive panel, such as an OLED display panel or a micro-LED display panel. In some embodiments, the display element 220 may include a display panel that is illuminated by an external source, such as an LCD panel, an LCoS display panel, or a DLP display panel. Examples of an external source may include a laser diode, a vertical cavity surface emitting laser, a light emitting diode, or a combination thereof. The display element 220 may output an image light 229 toward the collimating lens 225. The image light 229 may represent a virtual image having a predetermined image size.

For discussion purposes, FIG. 2A shows that the display element 220 includes a display panel that includes a plurality of pixels 221 arranged in an pixel array, in which neighboring pixels 221 may be separated by, e.g., a black matrix 222. For illustrative purposes, FIG. 2A shows that the display element 220 includes three pixels 221. Each pixel 221 may output a divergent image light (or a bundle of divergent rays) toward the collimating lens 225. A sum of the divergent image lights output from the respective pixels 221 may form the image light 229. For discussion purposes, FIG. 2A only shows the divergent image light (or a bundle of divergent rays) output from one of the three pixels 211 in the display element 220. The collimating lens 225 may be configured to condition the image light 229 from the display element 220 and output the input image light 230 toward the light guide 210. The collimating lens 225 may transform a linear distribution of pixels in the virtual image having the predetermined image size into an angular distribution of pixels in the image light 230. In some embodiments, the light source assembly 205 may include one or more addition optical components configured to condition the image light 229 output from the display element 220.

The light guide 210 may include one or more materials configured to facilitate the TIR of the TIR propagating image light 231. The light guide 210 may include, for example, a plastic, a glass, and/or polymers. The light guide 210 may have a relatively small form factor. In some embodiments, the light guide display system 200 may include additional elements configured to redirect, fold, and/or expand the TIR propagating image light 231. For example, as shown in FIG. 2A, one or more redirecting/folding elements 240 may be coupled to the light guide 210 to direct the in-coupled image light 231 propagating inside the light guide 210 in a predetermined direction. In some embodiments, the redirecting element 240 and the out-coupling element 245 may be disposed at a same surface or at different surfaces of the light guide 210. In some embodiments, the redirecting element 240 may be separately formed and disposed at (e.g., affixed to) the first surface 210-1 or the second surface 210-2, or may be integrally formed as a part of the light guide 210. In some embodiments, the redirecting element 240 may include one or more diffraction gratings, one or more cascaded reflectors, one or more prismatic surface elements, an array of holographic reflectors, or any combination thereof.

In some embodiments, the redirecting element 240 may be configured to expand the TIR propagating image light 231 in a first direction (e.g., a y-axis direction in FIG. 2A). The redirecting element 240 may redirect the expanded TIR propagating image light 231 to the out-coupling element 245. The out-coupling element 245 may couple the TIR propagating image light 231 out of the light guide 210, and expand the TIR propagating image light 231 in a second direction (e.g., an x-axis direction in FIG. 2A). Thus, a two-dimensional (“2D”) expansion of the image light 230 may be provided at the output side of the light guide 210. In some embodiments, multiple functions, e.g., out-coupling, redirecting, folding, and/or expanding the image light 230 may be combined into a single element, e.g. the out-coupling element 245, and hence, the redirecting element 240 may be omitted. For example, the out-coupling element 245 itself may provide a 2D expansion of the image light 230 at the output side of the light guide 210.

Although the light guide 210, the in-coupling element 235, the recycling element 237, and the out-coupling element 245 are shown as having flat surfaces for illustrative purposes, any of the light guide 210, the in-coupling element 235, the recycling element 237, and the out-coupling element 245 disclosed herein may include one or more curved surfaces or may have curved shapes. The controller 215 may be communicatively coupled with the light source assembly 205, and may control the operations of the light source assembly 205 to generate an input image light. The controller 215 may include a processor or processing unit 201 and a storage device 202. The storage device 202 may be a non-transitory computer-readable medium, such as a memory, a hard disk, etc., for storing data, information, and/or computer-executable program instructions or codes.

In some embodiments, the light guided display system 200 may include a plurality of light guides 210 disposed in a stacked configuration (not shown in FIG. 2A). At least one (e.g., each) of the plurality of light guides 210 may be coupled with the in-coupling element, the recycling element, the out-coupling element, and/or redirecting or folding element to provide an increased input efficiency. In some embodiments, the plurality of light guides 210 in the stacked configuration may be configured to output a polychromatic image light (e.g., a full-color image light including components of multiple colors). In some embodiments, the light guided display system 200 may include one or more light source assemblies 205 coupled to the one or more light guides 210. In some embodiments, at least one (e.g., each) of the light source assemblies 205 may be configured to emit a monochromatic image light of a specific wavelength band corresponding to a primary color (e.g., red, green, or blue) and an input FOV. In some embodiments, the light guided display system 200 may include three light guides 210 configured to deliver a component color image (e.g., a primary color image), e.g., red, green, and blue lights, respectively, in any suitable order, or simultaneously. In some embodiments, the light guide display system 200 may include two light guides configured to deliver component color images (e.g., primary color images) by in-coupling and subsequently out-coupling, e.g., a combination of red and green lights, and a combination of green and blue lights, respectively, in any suitable order or simultaneously.

For discussion purposes, in the following descriptions, the light guide display system 200 is presumed to not include the redirecting element 240. At least one of the in-coupling element 235, the recycling element 237, or the out-coupling element 245 may be a diffractive element that includes one or more diffraction gratings. For discussion purposes, a diffraction grating included in the in-coupling element 235 may be referred to as an in-coupling grating 235, a diffraction grating included in the recycling element 237 may be referred to as a recycling grating 237, and a diffraction grating included in the out-coupling element 245 may be referred to as an out-coupling grating 245.

FIG. 2B schematically illustrates a diagram showing a recycling of the in-coupled image light 231 in the light guide display system 200 shown in FIG. 2A, according to an embodiment of the present disclosure. FIG. 2B illustrates an enlarged view of the light propagating path of the input image light 230 in the light guide display system 200 shown in FIG. 2A. In some embodiments, both of the in-coupling grating 235 and the recycling grating 237 may be transmissive gratings or reflective gratings. In some embodiments, one of the in-coupling grating 235 and the recycling grating 237 may be a transmissive grating, and the other one of the in-coupling grating 235 and the recycling grating 237 may be a reflective grating.

For discussion purposes, FIG. 2B shows that both of the in-coupling grating 235 and the recycling grating 237 are transmissive gratings. In some embodiments, the in-coupling grating 235 and the recycling grating 237 may be transmissive type PVH gratings. Bragg planes of the in-coupling grating 235 or the recycling grating 237 are represented by slanted lines in the in-coupling grating 235 or the recycling grating 237. The in-coupling grating 235 may couple, via diffraction, the input image light 230 as an in-coupled image light 231. The first portion 231-1 of the in-coupled image light 231 (or the first in-coupled image light 231-1 represented by dashed lines) may propagate inside the light guide 210 via TIR toward the out-coupling element 245 (not shown in FIG. 2B), without interacting with the in-coupling grating 235 again.

The second portion 231-2 of the in-coupled image light 231 (or the second in-coupled image light 231-2 represented by solid lines) may be reflected, via TIR, at the second surface 210-2 of the light guide 210 as an image light 247, which may propagate through the light guide 210 and the volume of the in-coupling grating 235 toward an interface 235-1 of the in-coupling grating 235 and an outside environment (e.g., air). The in-coupling grating 235 may be configured to transmit (rather than diffract), the image light 247 toward the interface 235-1 with negligible or zero diffraction. The image light 247 may be reflected, via TIR, at the interface 235-1 as an image light 248 propagating back to the volume of the in-coupling grating 235. The in-coupling grating 235 may be configured to couple, via diffraction, the image light 248 out of the light guide 210 as an image light 249 propagating toward the recycling grating 237.

The recycling grating 237 may be configured to direct the image light 249 back to the light guide 210 as the third in-coupled image light 252 with the predetermined TIR propagation angle inside the light guide 210. For example, as shown in FIG. 2B, the recycling grating 237 may be configured to forwardly diffract the image light 249, which has been coupled out of the light guide 210, as an image light 251 propagating toward an interface 237-1 of the recycling grating 237 and the outside environment (e.g., air). The image light 251 may be reflected, via TIR, at the interface 237-1 as the image light 252, which propagates through the volume of the recycling grating 237 toward the light guide 210. The recycling grating 237 may be configured to transmit (rather than diffract) the image light 252 toward the light guide 210 with negligible or zero diffraction. The image light 252 may propagate inside the light guide 210 via TIR toward the out-coupling element 245 (not shown in FIG. 2B). In some embodiments, the image light 252 may propagate inside the light guide 210 via TIR toward the out-coupling element 245, without interacting with the in-coupling grating 235 again. In some embodiments, the image light 252 may interact with the in-coupling grating 235 again, and the image light 252 may follow a light propagating path that is similar to the first in-coupled image light 231-2 to be coupled into the light guide 210 again.

FIG. 2C illustrates a schematic diagram of a light guide display system or assembly 250 for providing an increased input efficiency, according to an embodiment of the present disclosure. The light guide display system 250 may include elements that are similar to or the same as those included in the light guide display system 200 shown in FIGS. 2A and 2B.

Descriptions of the same or similar elements or features can refer to the above corresponding descriptions, including those rendered in connection with FIGS. 2A and 2B.

FIG. 2C illustrates an enlarge view of the light propagating path of the input image light 230 in the light guide display system 250. In the embodiment shown in FIG. 2C, one of the in-coupling grating 235 and the recycling grating 237 may be a transmissive grating, and the other one of the in-coupling grating 235 and the recycling grating 237 may be a reflective grating. For discussion purposes, FIG. 2C shows that the in-coupling grating 235 is a transmissive grating, and the recycling grating 237 is a reflective grating. As shown in FIG. 2C, the recycling grating 237 may be configured to backwardly diffract the image light 249, which has been coupled out of the light guide 210, as an image light 262 (also referred to as third in-coupled image light 262 for discussion purposes) toward the light guide 210. The recycling grating 237 may be configured, such that the diffracted image light 262 may have the predetermined TIR propagation angle inside the light guide 210, thereby propagating inside the light guide 210 via TIR toward the out-coupling element 245 (not shown in FIG. 2C). That is, the recycling grating 237 may be configured to couple, via backward diffraction, the image light 249, which has been coupled out of the light guide 210, back into the light guide 210 again.

In some embodiments, the image light 262 may propagate inside the light guide 210 via TIR toward the out-coupling element 245, without interacting with the in-coupling grating 235 again. In some embodiments, the image light 262 may interact with the in-coupling grating 235 again, and the image light 262 may follow a light propagating path that is similar to the second in-coupled image light 231-2 to be coupled into the light guide 210 again.

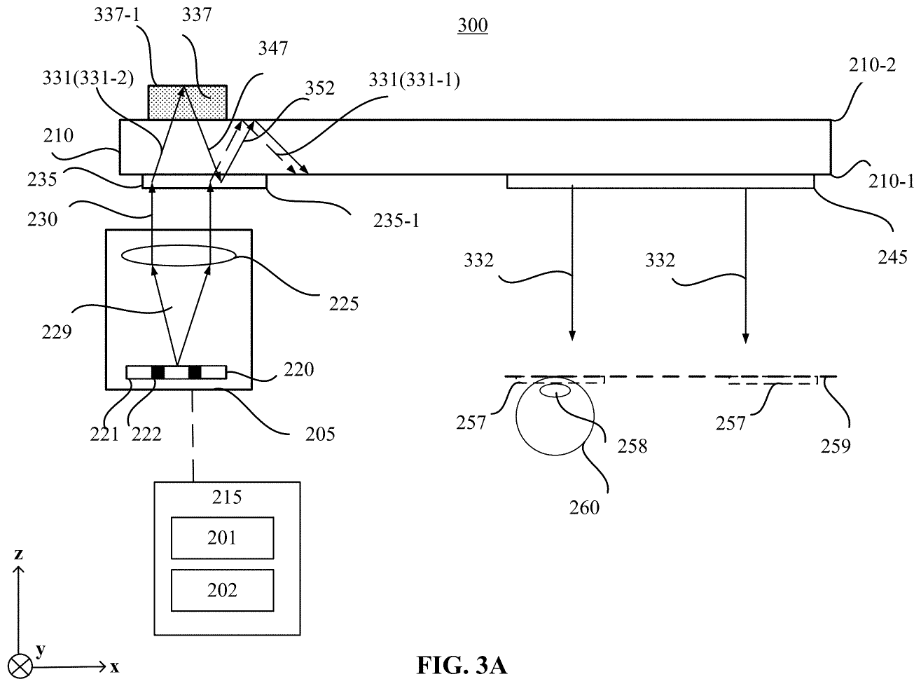

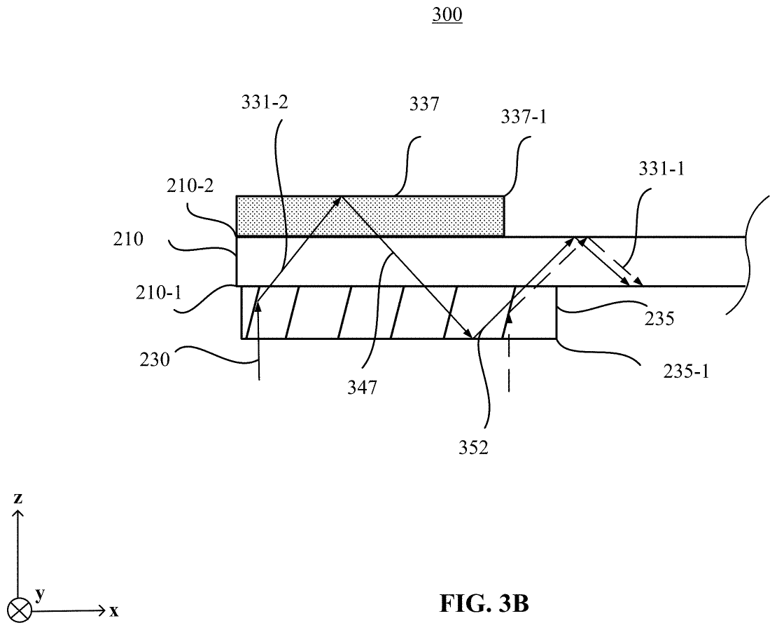

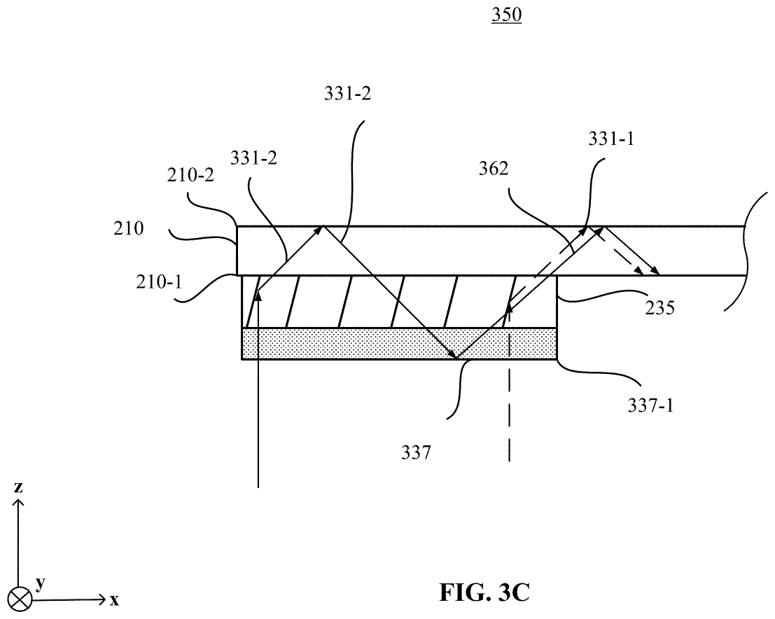

FIG. 3A illustrates a schematic diagram of a light guide display system or assembly 300 for providing an increased input efficiency, according to an embodiment of the present disclosure. The light guide display system 300 may include elements that are similar to or the same as those included in the light guide display system 200 shown in FIG. 2A, or the light guide display system 250 shown in FIG. 2B. Descriptions of the same or similar elements or features can refer to the above corresponding descriptions, including those rendered in connection with FIG. 2A, or FIG. 2B.

As shown in FIG. 3A, the light guide display system 300 may include the light source assembly 205, the controller 215, and the light guide 210. The light guide 210 may be coupled with the in-coupling grating 235 and one or more retardation films 337 at an input side of the light guide 210, and coupled with the out-coupling grating 245 at an output side of the light guide 210. The in-coupling grating 235 and the one or more retardation films 337 may be disposed at the same surface or opposite surfaces of the light guide 210. In some embodiments, the one or more retardation films 337 may at least partially overlap with the in-coupling grating 235 along the light guide 210 in the direction from the in-coupling grating 235 to the out-coupling grating 245 (e.g., in the x-axis direction). In some embodiments, although not shown, the one or more retardation films 337 may be disposed between the in-coupling grating 235 and the light guide 210.

The in-coupling grating 235 may be a polarization selective grating. For example, the in-coupling grating 235 may be configured to substantially diffract (e.g., forwardly or backwardly) an incident light with a first polarization, while substantially transmit an incident light with a second polarization other than (e.g., orthogonal to) the first polarization, with negligible or zero diffraction. In some embodiments, the first polarization and the second polarization may be linear polarizations with orthogonal polarization directions. In some embodiments, the first polarization and the second polarization may be circular polarizations with opposite handednesses. For example, the in-coupling grating 235 may be a PVH grating configured to substantially diffract (e.g., forwardly or backwardly) a circularly incident light with a first handedness, and substantially transmit a circularly incident light with a second handedness that is opposite to the first handedness, with negligible or zero diffraction.

The retardation film 337 may be fabricated based on any suitable materials, such as liquid crystals, polymers, or plastics, etc. In some embodiments, the retardation film 337 may include at least one of an A-film, an O-film, or a biaxial film. The retardation film 337 may function as a polarization controlling or converting element, configured to control a polarization of an image light before the image light is incident onto the in-coupling grating 235.

In the embodiment shown in FIG. 3A, the in-coupling grating 235 and the retardation films 337 are disposed at different surfaces of the light guide 210, e.g., disposed at the first surface 210-1 and second surface 210-2 of the light guide 210, respectively. FIG. 3B illustrates an enlarged view of the light propagating path of the input image light 230 in the light guide display system 300 shown in FIG. 3A. Referring to FIGS. 3A and 3B, the light source assembly 205 may output the input image light 230 toward the light guide 210. The in-coupling grating 235 may couple the input image light 230 as an in-coupled image light 331 with a predetermined TIR propagation angle inside the light guide 210. A first portion 331-1 of the in-coupled image light 331 may propagate inside the light guide 210 via TIR toward the out-coupling element 245, without interacting with the in-coupling grating 235 again. The first portion 331-1 is also referred to as a first in-coupled image light 331-1 for discussion purposes, and are represented by dashed lines in FIG. 3A.

A second portion 331-2 of the in-coupled image light 331 may interact with the in-coupling grating 235 again. The second portion 331-2 may also be referred to as a second in-coupled image light 331-2 for discussion purposes. For example, the second in-coupled image light 331-2 may first propagate through the light guide 210 and the retardation film 337 toward an interface 337-1 between the retardation film 337 and the outside environment (e.g., air). The second in-coupled image light 331-2 may be reflected via TIR, at the interface 337-1, as an image light 347. The retardation film 337 may be configured to provide a predetermined phase retardation to the second in-coupled image light 331-2 to re-configure, control, alter, affect, vary, change, modify, or maintain the polarization of the second in-coupled image light 331-2, such that the image light 347 output from the retardation film 337 back to the light guide 210 and the in-coupling grating 235 may have a predetermined polarization. The image light 347 may propagate through the light guide 210 and the volume of the in-coupling grating 235 toward the interface 235-1 of the in-coupling grating 235 and the outside environment (e.g., air). The image light 347 may be reflected, via TIR, at the interface 235-1 as an image light 352 propagating back to the volume of the in-coupling grating 235.

In some embodiments, the polarization of the image light 347 may not change while propagating inside the light guide 210. The retardation film 337 may be configured to provide the predetermined phase retardation to the second in-coupled image light 331-2, such that the predetermined polarization of the image light 347 output from the retardation film 337 may be the second polarization. Thus, the image light 347 and the image light 352 may have the same polarization, e.g., the second polarization. As the in-coupling grating 235 is a polarization selective grating configured to substantially diffract an incident light with the first polarization, while substantially transmit an incident light with the second polarization other than (e.g., orthogonal to) the first polarization with negligible or zero diffraction, the image light 352 having the second polarization may be transmitted through the volume of the in-coupling grating 235 toward the light guide 210, with negligible or zero diffraction.

In some embodiments, the polarization of the image light 347 may change while propagating inside the light guide 210. That is, the image light 347 and the image light 352 may have different polarizations. The predetermined polarization of the image light 347 may be configured, e.g., to be a polarization other than the second polarization, such that the image light 352 reflected from the interface 235-1 has the second polarization. Thus, the in-coupling grating 235 may transmit the image light 352 toward the light guide 210, with negligible or zero diffraction.

For example, in some embodiments, the in-coupling grating 235 may be a PVH grating configured to substantially diffract a left-handed circularly polarized (“LHCP”) light, and substantially transmit a right-handed circularly polarized (“RHCP”) light with negligible or zero diffraction. Thus, the predetermined phase retardation provided to the second in-coupled image light 331-2 by the retardation film 337 may be configured, such that the image light 352 reflected from the interface 235-1 may be an RHCP light. Thus, the in-coupling grating 235 may transmit the image light (e.g., RHCP light) 352 toward the light guide 210, with negligible or zero diffraction.

As the retardation film 337 does not change the TIR propagation angle of the second in-coupled image light 331-2, the image light 352 may propagate inside the light guide 210, via TIR, toward the out-coupling element 245, at the same predetermined TIR propagation angle. The image light 352 may also be referred to as a third in-coupled image light 352 for discussion purposes. Thus, as the in-coupling grating 235 substantially transmit the image light 352 toward the light guide 210 (rather than diffract the image light 352 out of the light guide 210), the optical efficiency at the input side of the light guide 210 (or the input efficiency of the in-coupling grating 235) is increased. Accordingly, the power efficiency of the light guide display system 300 is increased.

For discussion purposes, in the disclosed embodiments, the combination of the first in-coupled image light 331-1 and the third in-coupled image light 352 is presumed to be substantially the same as the in-coupled image light 331. The out-coupling element 245 may couple the in-coupled image light 331 out of the light guide 210 as a plurality of output image lights 332. The out-coupling element 245 may consecutively couple the in-coupled image light 331, which is incident onto the different positions of the out-coupling element 245, out of the light guide 210 at different positions of the out-coupling element 245. Thus, the out-coupling element 245 may replicate the input image light 230 at the output side of the light guide 210, to expand an effective pupil of the light guide display system 300. The plurality of output image lights 332 may propagate toward the plurality of exit pupils 257 positioned in the eye-box region 259 of the light guide display system 300, respectively. Because the first in-coupled image light 331-1 and the third in-coupled image light 352 propagate inside the light guide 210 at the same TIR propagation angle, the out-coupled image light of the first in-coupled image light 331-1 and the out-coupled image light of the third in-coupled image light 352 may form the same image, and no ghost image may be formed at the output side of the light guide 210.

FIG. 3C illustrates a schematic diagram of a light guide display system or assembly 350 for providing an increased input efficiency, according to an embodiment of the present disclosure. The light guide display system 350 may include elements that are similar to or the same as those included in the light guide display system 200 shown in FIGS. 2A and 2B, the light guide display system 250 shown in FIG. 2C, or the light guide display system 300 shown in FIGS. 3A and 3B. Descriptions of the same or similar elements or features can refer to the above corresponding descriptions, including those rendered in connection with FIGS. 2A and 2B, FIG. 2C, or FIGS. 3A and 3B.

FIG. 3C illustrates an enlarge view of the light propagating path of the input image light 230 in the light guide display system 350. In the embodiment shown in FIG. 3C, the in-coupling grating 235 and the retardation films 337 are disposed at the same surface of the light guide 210, e.g., the first surface 210-1. The second in-coupled image light 331-2 may propagate through the light guide 210, the volume of the in-coupling grating 235, and the retardation film 337 toward an interface 337-1 between the retardation film 337 and the outside environment (e.g., air). The second in-coupled image light 331-2 may be reflected via TIR, at the interface 337-1, as an image light 362. The retardation film 337 may be configured to provide a predetermined phase retardation to the second in-coupled image light 331-2, such that the image light 362 output from the retardation film 337 may be configured to have a predetermined polarization, e.g., the second polarization. As the in-coupling grating 235 is a polarization selective grating configured to substantially diffract an incident light with the first polarization, while substantially transmit an incident light with the second polarization other than (e.g., orthogonal to) the first polarization with negligible or zero diffraction, the image light 362 having the second polarization may be transmitted through the volume of the in-coupling grating 235 toward the light guide 210, with negligible or zero diffraction.

For example, in some embodiments, the in-coupling grating 235 may be a PVH grating configured to substantially diffract an LHCP light, and substantially transmit an RHCP light with negligible or zero diffraction. Thus, the predetermined phase retardation provided to the second in-coupled image light 331-2 by the retardation film 337 may be configured, such that the image light 362 reflected from the interface 235-1 may be an RHCP light. Thus, the in-coupling grating 235 may transmit the image light (e.g., RHCP light) 362 toward the light guide 210, with negligible or zero diffraction.

As the retardation film 337 does not change the TIR propagation angle of the second in-coupled image light 331-2, the image light 362 may propagate inside the light guide 210, via TIR, toward the out-coupling element 245, with the predetermined TIR propagation angle. The image light 362 may also be referred to as a third in-coupled image light 362 for discussion purposes. Thus, the optical efficiency at the input side of the light guide 210 (or the input efficiency of the in-coupling grating 235) is increased. Accordingly, the power efficiency of the light guide display system 350 is increased.

For discussion purposes, in the disclosed embodiments, the combination of the first in-coupled image light 331-1 and the third in-coupled image light 362 is presumed to be substantially the same as the in-coupled image light 331. The out-coupling element 245 may couple the in-coupled image light 331 (e.g., the combination of the first in-coupled image light 331-1 and the third in-coupled image light 362) out of the light guide 210 as a plurality of output image lights 332 toward the plurality of exit pupils 257, respectively.

In conventional technology, an out-coupling element (e.g., the size, the structure) is designed for a full, large eye-box, which may cause energy waste and more rainbow effects. In some embodiments, the present disclosure provides a light guide display system configured to provide an active eye-box. The disclosed light guide display system may include a light guide (or a light guide stack), an in-coupling element, one or more redirecting elements, an out-coupling element, and a controller configured to control at least one of the in-coupling element, the one or more redirecting elements, and the out-coupling element. The out-coupling element may include a plurality of selectively activatable (i.e., active) out-coupling gratings. When a plurality of redirecting elements are included, the redirecting elements may be disposed at different portions of the light guide, and each redirecting element may redirect an image light received from the in-coupling element to a specific active out-coupling grating (or multiple specific active out-coupling gratings) included in the out-coupling element. The controller may control the in-coupling element to couple an input image light into the light guide in different, selectable propagating directions inside the light guide, based on eye-tracking information obtained by an eye-tracking system. For example, the controller may control the in-coupling element such that the input image light is coupled into the light guide as an in-coupled image light propagating in a direction toward one of the one or more redirecting elements via TIR, or propagating in a direction toward one or more active out-coupling gratings included in the out-coupling element via TIR. When the input image light is coupled into the light guide as the in-coupled image light propagating in the direction toward one of the one or more redirecting elements via TIR, the redirecting element may direct the in-coupled image light to one or more specific active out-coupling gratings included in the out-coupling element, such that the one or more specific active out-coupling gratings may couple the in-coupled image light out of the light guide to a small eye-box region, which is part of the full eye-box, rather than to the full eye-box. When the input image light is coupled into the light guide as the in-coupled image light propagating in the direction toward one or more specific active out-coupling gratings included in the out-coupling element via TIR, the one or more specific active out-coupling gratings may couple the in-coupled image light out of the light guide to a small eye-box region, which is part of the full eye-box, rather than to the full eye-box. The user's eye receives the image light from the small eye-box region, rather than from the full large eye-box. Thus, the light guide display system can increase the intensity of the image light received by the eye pupil, reduce the loss of the image light outside of the eye pupil, increase the power efficiency of the light guide display system, and reduce the rainbow effect in a see-though view.

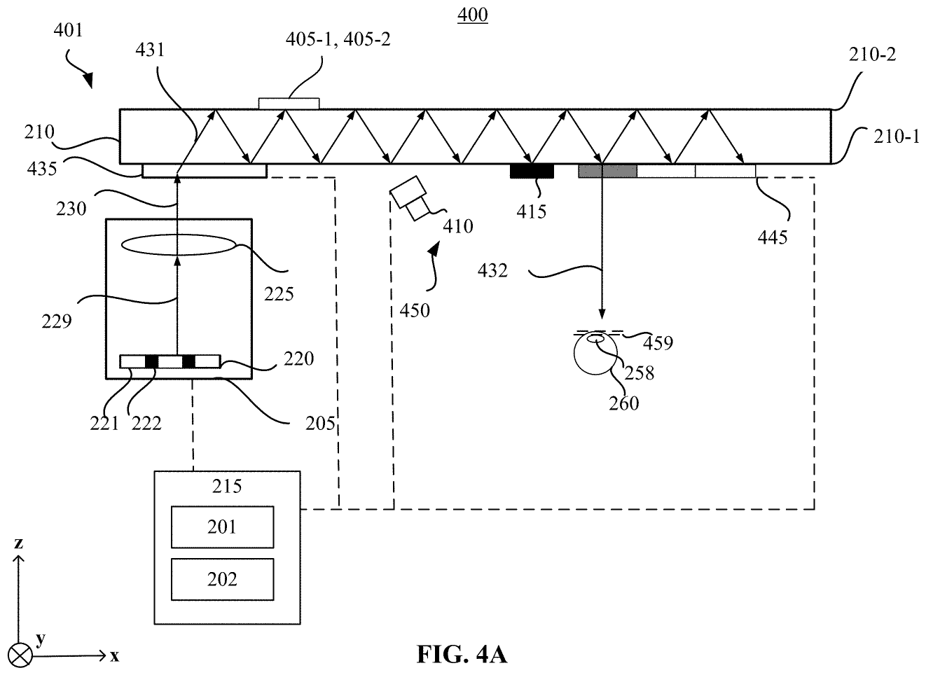

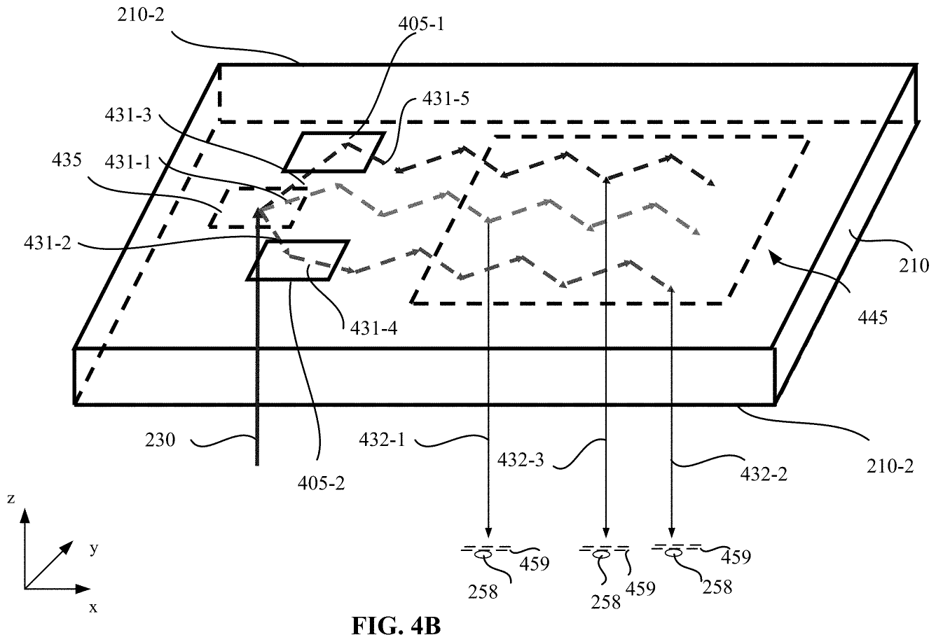

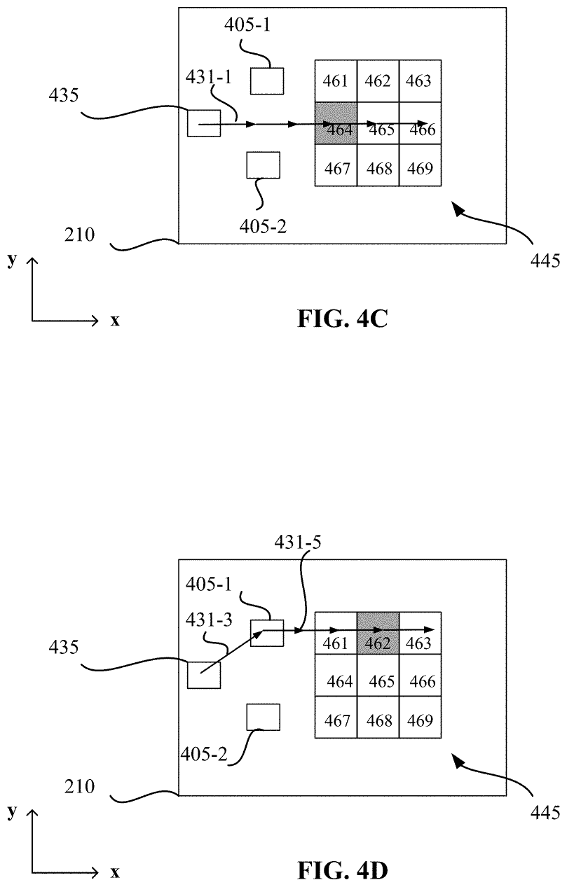

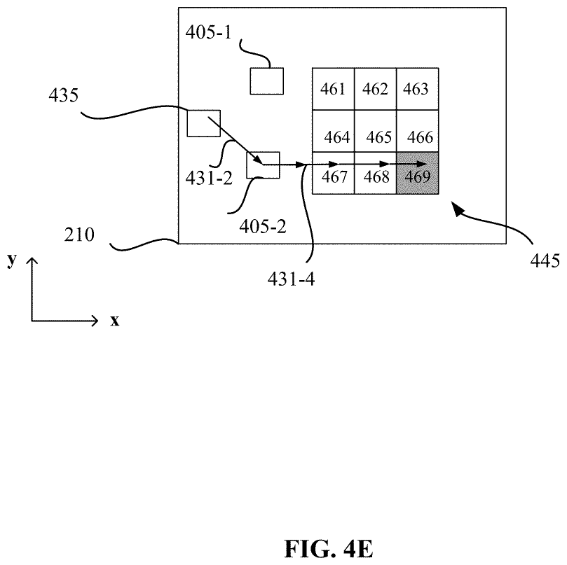

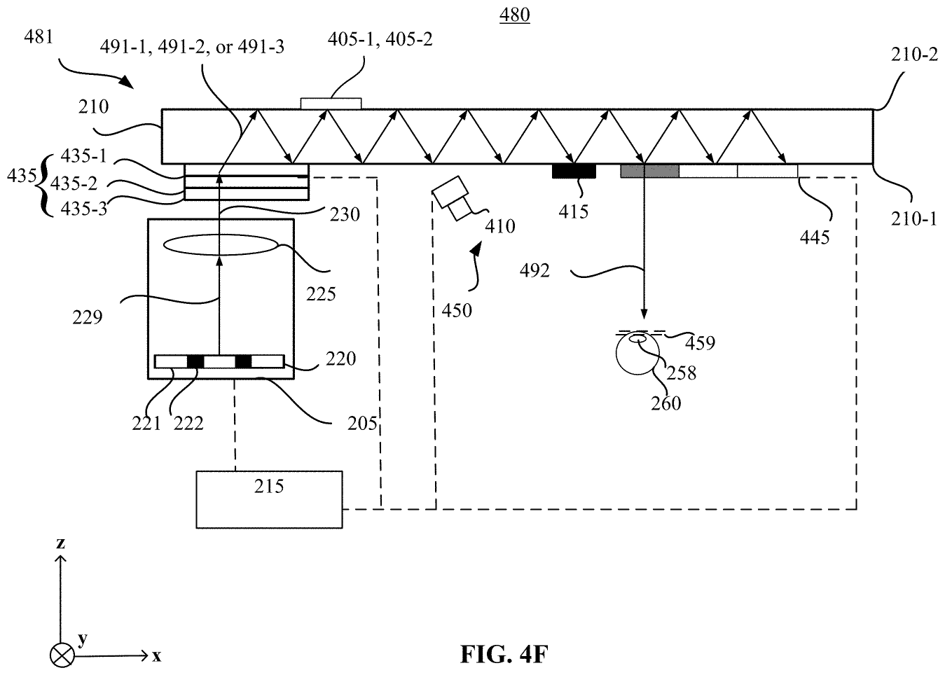

FIG. 4A schematically illustrates an x-y sectional view of an optical system 400, according to an embodiment of the present disclosure. The optical system 400 may be a part of a system (e.g., an NED, an HUD, an HMD, a smart phone, a laptop, or a television, etc.) for VR, AR, and/or MR applications. The optical system 400 may include a light guide display system 401, and an eye tracking system 450. The light guide display system 401 may include elements that are similar to or the same as those included in the light guide display system 200 shown in FIGS. 2A and 2B, the light guide display system 250 shown in FIG. 2C, the light guide display system 300 shown in FIGS. 3A and 3B, or the light guide display system 350 shown in FIG. 3C. Descriptions of the same or similar elements or features can refer to the above corresponding descriptions, including those rendered in connection with FIGS. 2A and 2B, FIG. 2C, FIGS. 3A and 3B, or FIG. 3C.

The light guide display system 401 may be configured to project an image light (that forms computer-generated virtual images) into a display window in a field of view (“FOV”). The eye tracking system 450 may be configured to provide eye-tracking information, based on which a position of the eye pupil 258 of the user of the light guide display system 401 may be determined. The light guide display system 401 may be configured to guide the image light 230 output from the light source assembly 205 to an eye-box 459 where the eye pupil 258 of the user is positioned. The location, the size, and/or the shape of the eye-box 459 may vary according to the eye-tracking information. The location of the eye-box 459 may be dynamically aligned with the position of the eye pupil 258. The size of the eye-box 459 may be comparable with (e.g., the same as or slightly larger than) the size of the eye pupil. The size of the eye pupil of an average adult user may vary in a range of 4-8 millimeters (“mm”) in diameter when dilated (e.g., when in dark), or vary in a range of 2-4 mm in diameter when constricted (e.g., in bright light). In other words, the size of the eye pupil may vary in the range of 2-8 mm depending on the light intensity (or brightness) of the received light. Such an eye-box 459 may be referred to as an active eye-box.

As shown in FIG. 4A, the light guide display system 401 may include the light source assembly 205, the light guide 210, and the controller 215. The light guide 210 may be coupled with an in-coupling element 435, one or more redirecting/folding elements (e.g., 405-1 and 405-2), an out-coupling element 445. FIG. 4B illustrates a three-dimensional (“3D”) view of the light guide 210 coupled with the in-coupling element 435, the one or more redirecting/folding elements (e.g., 405-1 and 405-2), and the out-coupling element 445 shown in FIG. 4A, according to an embodiment of the present disclosure. For discussion purposes, FIG. 4B shows that the light guide display system 401 includes two redirecting elements 405-1 and 405-2. Each of the in-coupling element 435, the redirecting elements 405-1 and 405-2, and the out-coupling element 445 may be formed or disposed at (e.g., affixed to) a first surface 210-1 or a second surface 210-2 of the light guide 210. In some embodiments, each of the in-coupling element 435, the redirecting elements 405-1 and 405-2, and the out-coupling element 445 may be integrally formed as a part of the light guide 210, or may be a separate element coupled to the light guide 210. For discussion purposes, FIGS. 4A and 4B show that the redirecting elements 405-1 and 405-2 are disposed at the second surface 210-2 of the light guide 210, and the in-coupling element 435 and the out-coupling element 445 are disposed at the first surface 210-1 of the light guide 210. In some embodiments, at least one (e.g., each) of the in-coupling element 435 or the out-coupling element 445 may include one or more active gratings. In some embodiments, the redirecting elements 405-1 and 405-2 may include one or more active gratings. In some embodiments, the redirecting elements 405-1 and 405-2 may include one or more passive gratings.

In some embodiments, an active grating may be directly driven by an external field, e.g., an external electric field. In some embodiments, the active grating may be controlled or switched, e.g., by the controller 215, between operating in a diffraction state to diffract an incident light, and operating in a non-diffraction state to transmit the incident light with substantially zero or negligible diffraction. In some embodiments, the active grating that operates in the diffraction state may provide a fixed diffraction angle to an incident light with a fixed incidence angle. In some embodiments, the active grating that operates in the diffraction state may provide a tunable diffraction angle to the incident light with a fixed incidence angle. For example, the active grating may operate in different diffraction states under different driving voltages, thereby diffracting the incident light with the fixed incidence angle at different diffraction angles. In some embodiments, when the driving voltage applied to the active grating is changed, the grating period of the active grating may be changed, such that the active grating may diffract the incident light with the fixed incidence angle at different diffraction angles. In some embodiments, when the driving voltage applied to the active grating is changed, a modulation of the refractive index of the active grating may be changed, such that the active grating may diffract the incident light with the fixed incidence angle to different diffraction angles.

The active grating may be polarization sensitive (or polarization selective) or polarization insensitive (or polarization non-selective). The active grating may be a reflective grating or a transmissive grating. The active grating may be fabricated based on any suitable materials. In some embodiments, the active grating fabricated based on active liquid crystals (“LCs”) may include active LC molecules, orientations of which may be changeable by the external field (e.g., external electric field). Examples of active gratings may include, but not be limited to, holographic polymer-dispersed liquid crystal (“H-PDLC”) gratings, surface relief gratings provided (e.g., filled) with active LCs, Pancharatnam-Berry phase (“PBP”) gratings based on active LCs, polarization volume holograms (“PVHs”) based on active LCs, etc.

In some embodiments, a passive grating may not be directly driven by an external field, e.g., an external electric field. The passive grating may be polarization sensitive (or polarization selective) or polarization insensitive (or polarization non-selective). The passive grating may be a reflective grating or a transmissive grating. The passive grating may be fabricated based on any suitable materials. In some embodiments, the passive grating fabricated based on passive LCs may include passive LC molecules, orientations of which may not be changeable by the external field (e.g., external electric field). Examples of passive gratings may include, but not be limited to, H-PDLC gratings, surface relief gratings provided (e.g., filled) with passive LCs, PBP gratings based on passive LCs, PVH gratings based on passive LCs, etc.

FIG. 4B schematically illustrates a 3D view of light propagating paths in the light guide 210 coupled with the in-coupling element 435, the redirecting elements 405-1 and 405-2, and the out-coupling element 445 shown in FIG. 4A. FIGS. 4C-4E schematically illustrate x-y sectional views of light propagating paths in the light guide 210 coupled with the in-coupling element 435, the redirecting elements 405-1 and 405-2, and the out-coupling element 445 shown in FIG. 4B.

Referring to FIGS. 4A-4E, in some embodiments, the in-coupling element 435 may include an active grating (referred to as the in-coupling grating 435). Each of the redirecting elements 405-1 and 405-2 may include a passive grating (referred to as the redirecting grating 405-1 or 405-2). The in-coupling grating 435 that operates in the diffraction state may be configured to couple, via diffraction, the input image light 230 as an in-coupled image light (or TIR propagating light) 431-1, 431-2, or 431-3. The in-coupled image light 431-1, 431-2, or 431-3 may propagate inside the light guide 210 via TIR. The controller 215 may control the in-coupling grating 435 to operate in different diffraction states (e.g., by providing different driving voltages) to diffract the input image light 230 at different diffraction angles, such that the in-coupled image lights 431-1, 431-2, and 431-3 may propagate in different directions inside the light guide 210. The controller 215 may control the in-coupling grating 435 to switch between different diffraction states.

For example, referring to FIGS. 4B and 4C, the in-coupling grating 435 that operates in a first diffraction state (e.g., when driven by a first driving voltage) may couple, via diffraction, the input image light 230 as the in-coupled image light 431-1 propagating toward the out-coupling element 445, e.g., along the x-axis direction. The in-coupled image light 431-1 may have a predetermined TIR propagation angle inside the light guide 210.

Referring to FIG. 4B and FIG. 4E, the in-coupling grating 435 that operates in a second diffraction state (e.g., when driven by a second driving voltage) may couple, via diffraction, the input image light 230 as the in-coupled image light 431-2 propagating toward the redirecting grating 405-2. The redirecting grating 405-2 may be configured to diffract the in-coupled image light 431-2 as an in-coupled image light 431-4 propagating toward the out-coupling element 445 via TIR. The in-coupled image light 431-4 may have the same predetermined TIR propagation angle as the in-coupled image light 431-1, and may propagate toward the out-coupling element 445 along the same direction as the in-coupled image light 431-1, e.g., along the x-axis direction.

Referring to FIG. 4B and FIG. 4D, the in-coupling grating 435 that operates in a third diffraction state (e.g., under a third driving voltage) may couple, via diffraction, the input image light 230 as the in-coupled image light 431-3 propagating toward the redirecting grating 405-1. The redirecting grating 405-1 may be configured to diffract the in-coupled image light 431-3 as an in-coupled image light 431-5 propagating toward the out-coupling element 445 via TIR. The in-coupled image light 431-5 may have the same predetermined TIR propagation angle as the in-coupled image light 431-1, and propagate toward the out-coupling element 445 along the same direction as the in-coupled image light 431-1, e.g., along the x-axis direction.

Referring to FIGS. 4C-4E, the out-coupling element 445 may include a plurality of active gratings (referred to as out-coupling gratings) 461 to 469 arranged in a 2D array (e.g., 3×3 array). Each of the out-coupling gratings 461 to 469 may function as an active grating. The plurality of out-coupling gratings 461 to 469 may be independently or individually controlled, e.g., by the controller 215, between operating in the diffraction state to couple, via diffraction, an in-coupled image light incident thereon out of the light guide 210 as an output image light, and operating in the non-diffraction state to transmit the in-coupled image light incident thereon with substantially zero or negligible diffraction.

The eye tracking system 450 may be configured to provide eye tracking information, based on which a position of the eye pupil 258 of the user of the light guide display system 401 may be determined. Any suitable eye tracking system 450 may be used. The eye tracking system 450 may include, e.g., one or more light sources 415 configured to illuminate one or both eyes 260 of the user, and one or more optical sensors (e.g., cameras) 410 configured to capture images of one or both eyes 260. The eye tracking system 450 may be configured to track a position, a movement, and/or a viewing direction of the eye pupil 258. In some embodiments, the eye tracking system 450 may determine or detect a position and/or a movement of the eye pupil 258 up to six degrees of freedom for each eye 260 (i.e., 3D positions, roll, pitch, and yaw) based on captured image data of the eye pupil 258. In some embodiments, the eye tracking system 450 may measure a pupil size of the eye pupil 258.

In some embodiments, the controller 215 may be electrically coupled with, and may control, various devices in the eye tracking system 450. In the embodiment shown in FIG. 4A, the light guide display system 401 and the eye tracking system 450 may share the controller 215. In some embodiments, the light guide display system 401 and the eye tracking system 450 may have individual controllers. The eye tracking system 450 may provide a signal (or feedback) containing the position and/or movement of the eye pupil 258 to the controller 215.

In some embodiments, the controller 215 may control, based on the eye tracking information, the gratings included in at least one of the in-coupling element 435, the out-coupling element 445, or the redirecting elements 405-1 and 405-2 to direct the image light 230 emitted by the light source assembly 205 to the eye-box 459, which may be dynamically aligned with the eye pupil 258. In the embodiment shown in FIGS. 4A-4C, the controller 215 may control, based on the eye tracking information, the diffraction state of the in-coupling grating 435. For example, the controller 215 may control the in-coupling grating 435 to operate in the first diffraction state, the second diffraction state, or the third diffraction state, to couple (via diffraction) the input image light 231 as the in-coupled image light 431-1 propagating toward the out-coupling element 445, the in-coupled image light 431-2 propagating toward the redirecting grating 405-1, or the in-coupled image light 431-3 propagating toward the redirecting grating 405-2. In addition, the controller 215 may selectively control, based on the eye tracking information, one or more of the out-coupling gratings 461 to 469 to operate in the diffraction state, and selectively control the remaining one or more of the out-coupling gratings 461 to 469 to operate in the non-diffraction state. The one or more of the out-coupling gratings 461 to 469 that operate in the diffraction state may couple the in-coupled image light 431-1, 431-4, or 431-5 out of the light guide 210 as one or more output image lights 432 that provide (or form) the eye-box 459. An FOV of the image light 432 propagating through the eye-box 459 may be substantially the same as an FOV of the input image light 230.

The remaining one or more of the out-coupling gratings 461 to 469 controlled to operate in the non-diffraction state may function as a substantially optically uniform plate for the in-coupled image light 431-1, 431-4, or 431-5. That is, the remaining one or more of the out-coupling gratings 461 to 469 operating in the non-diffraction state may transmit the in-coupled image light 431-1, 431-4, or 431-5 therethrough with negligible or no diffraction. To selectively control an out-coupling grating to operate in the diffraction state, or to selectively control the out-coupling grating to operate in the non-diffraction state, the controller 215 may either switch the out-coupling grating from the diffraction state to the non-diffraction state, or from the non-diffraction state to the diffraction state, or maintain the diffraction state or the non-diffraction state, depending on the state of the out-coupling grating at a preceding time instance or time duration.

The controller 215 may dynamically adjust the size, shape and/or location of the eye-box 459 based on the real time eye tracking information, including, e.g., the size of the eye pupil 258, the position of the eye pupil 258, the moving direction of the eye pupil 258, the viewing direction of the eye pupil 258, or any suitable combination thereof. For example, at different time instances, based on the eye tracking information obtained in real time, the controller 215 may dynamically control different gratings (or different combinations of the gratings) included in at least one of the in-coupling element 435, the out-coupling element 445, or the redirecting elements 405-1 and 405-2 to direct the image light 230 of a predetermined FOV to the eye-box 459 at a different location and/or with a different size and/or shape.

FIG. 4B shows that the eye-box 459 may be located at different locations when the position of the eye pupil 258 changes. FIG. 4B shows the light propagating paths in the light guide 210 coupled with the in-coupling element 435, the redirecting elements 405-1 and 405-2, and the out-coupling element 445 during a first time instance, a second time instance, and a third time instance. FIG. 4C-4E show the light propagating paths in the light guide 210 coupled with the in-coupling element 435, the redirecting elements 405-1 and 405-2, and the out-coupling element 445 during the first time instance, the second time instance, and the third time instance, respectively.

Referring to FIGS. 4B and 4C, at a first time instance, the eye tracking system 450 or the controller 215 may detect or determine, based on image data relating to the eye pupil 258 captured by the optical sensor 410, that the eye pupil 258 is located at a first position. Based on the position information of the eye pupil 258, the controller 215 may control the in-coupling grating 435 to operate in the first diffraction state, e.g., by driving the in-coupling grating 435 with the first driving voltage. The in-coupling grating 435 that operates in the first diffraction state may couple, via diffraction, the input image light 230 as the in-coupled image light 431-1 propagating toward the out-coupling element 445, e.g., along the x-axis direction. Based on the position information of the eye pupil 258, the controller 215 may selectively control the out-coupling grating 464 of the out-coupling element 445 to operate in the diffraction state, and selectively control the remaining out-coupling gratings 461 to 463 and 465 to 469 to operate in the non-diffraction state. The out-coupling grating 464 that operates in the diffraction state may couple, via diffraction, the in-coupled image light 431-1 incident thereon as an output image light 432-1 that provides or forms the eye-box 459 at the first position where the eye pupil 258 is located. The out-coupling gratings 465 and 466 that operate in the non-diffraction state may transmit the in-coupled image light 431-1 therethrough with negligible or no diffraction. The output image light 432-1 may have the same FOV as the input image light 230. Thus, the eye pupil 258 located within the eye-box 459 at the first position may observe full content of an image generated by the light source assembly 205.

Thus, the in-coupling grating 435 that operates in the first diffraction state and the out-coupling grating 464 that operates in the diffraction state may direct the image light 230 to the eye-box 459 at the first position where the eye pupil 258 is located. The size and location of the eye-box 459 at the first position may be maintained for a first time period until a change in the eye tracking information of the eye pupil 258 is detected. The change may be a change in the size of the eye pupil 258, a change in the position of the eye pupil 258, a change in the moving direction of the eye pupil 258, and/or a change in the viewing direction of the eye pupil 258.

Although not shown in FIG. 4B and FIG. 4C, in some embodiments, the light guide display system 400 may also include a third redirecting element similar to the redirecting element 405-1 and 405-2. At the first time instance, the in-coupling element 435 may be controlled by the controller 215 to couple the input image light 230 into the light guide 210 as an in-coupled image light propagating toward the third redirecting element via TIR. The third redirecting element may then direct (e.g., diffract) the in-coupled image light as an in-coupled image light propagating toward the out-coupling element 445 via TIR, e.g., along the x-axis direction, such as to the out-coupling gratings 464 to 466. The out-coupling grating 464 that operates in the diffraction state may couple, via diffraction, the in-coupled image light 431-1 incident thereon as an output image light 432-1 that provides or forms the eye-box 459 at the first position where the eye pupil 258 is located. The out-coupling gratings 465 and 466 that operate in the non-diffraction state may transmit the in-coupled image light 431-1 therethrough with negligible or no diffraction. In such an embodiment, the input image light coupled into the light guide by the in-coupling element 435 may be first directed to one of the plurality of redirecting elements 405, and then directed by the redirecting element 405 to one or more of the active out-coupling gratings included in the out-coupling element 445.

Referring to FIG. 4B and FIG. 4E, at a second time instance, the eye tracking system 450 or the controller 215 may detect or determine, based on the image data relating to the eye pupil 258 captured by the optical sensor 410, that the eye pupil 258 has moved to, or is moving to, a second position different from the first position. Based on the new position information of the eye pupil 258, the controller 215 may control the in-coupling grating 435 to operate in the second diffraction state, e.g., by driving the in-coupling grating 435 with the second driving voltage. Thus, the in-coupling grating 435 may couple, via diffraction, the input image light 230 as the in-coupled image light 431-2 propagating toward the redirecting grating 405-2. The redirecting grating 405-2 may be configured to diffract the in-coupled image light 431-2 as the in-coupled image light 431-4 propagating toward the out-coupling element 445 via TIR, e.g., along the x-axis direction.

Based on the position information of the eye pupil 258, the controller 215 may selectively control the out-coupling grating 469 of the out-coupling element 445 to operate in the diffraction state, and selectively control the remaining out-coupling gratings 461 to 468 to operate in the non-diffraction state. The out-coupling grating 469 that operates in the diffraction state may couple, via diffraction, the in-coupled image light 431-4 incident thereon as an output image light 432-2 that provides or forms the eye-box 459 at the second position where the eye pupil 258 is located. The out-coupling gratings 467 and 468 that operate in the non-diffraction state may transmit the in-coupled image light 431-4 therethrough with negligible or no diffraction. The output image light 432-2 may have the same FOV as the input image light 230. Thus, the eye pupil 258 located within the eye-box 459 at the second position may observe full content of an image generated by the light source assembly 205.

Thus, the in-coupling grating 435 that operates in the second diffraction state and the out-coupling grating 459 that operates in the diffraction state may direct the image light 230 to the eye-box 459 at the second position where the eye pupil 258 is located. In some embodiments, at least one of the location, shape, and/or size of the eye-box 459 at the second time instance may be different from the at least one of the location, shape, and/or size of the eye-box 459 at the first time instance. The size and location of the eye-box 459 at the second position may be maintained for a second time period until a change in the eye tracking information of the eye pupil 258 is detected.

Referring to FIG. 4B and FIG. 4D, at a third time instance, the eye tracking system 450 or the controller 215 may detect or determine, based on the image data relating to the eye pupil 258 captured by the optical sensor 410, that the eye pupil 258 has moved to, or is moving to, a third position different from the second position. Based on the new position information of the eye pupil 258, the controller 215 may control the in-coupling grating 435 to operate in the third diffraction state, e.g., by driving the in-coupling grating 435 with the third driving voltage. Thus, the in-coupling grating 435 may couple, via diffraction, the input image light 230 as the in-coupled image light 431-3 propagating toward the redirecting grating 405-1. The redirecting grating 405-1 may be configured to diffract the in-coupled image light 431-3 as the in-coupled image light 431-5 propagating toward the out-coupling element 445 via TIR, e.g., along the x-axis direction.

Based on the position information of the eye pupil 258, the controller 215 may selectively control the out-coupling grating 462 of the out-coupling element 445 to operate in the diffraction state, and selectively control the remaining out-coupling gratings 461, and 463 to 469 to operate in the non-diffraction state. The out-coupling grating 462 that operates in the diffraction state may couple, via diffraction, the in-coupled image light 431-5 incident thereon as an output image light 432-3 that provides or forms the eye-box 459 at the third position where the eye pupil 258 is located. The out-coupling gratings 461 and 463 that operate in the non-diffraction state may transmit the in-coupled image light 431-5 therethrough with negligible or no diffraction. The output image light 432-3 may have the same FOV as the input image light 230. Thus, the eye pupil 258 located within the eye-box 459 at the third position may observe full content of an image generated by the light source assembly 205.

Thus, the in-coupling grating 435 that operates in the third diffraction state and the out-coupling grating 462 that operates in the diffraction state may direct the image light 230 to the eye-box 459 at the third position where the eye pupil 258 is located. In some embodiments, at least one of the location, shape, and/or size of the eye-box 459 at the third time instance may be different from the at least one of the location, shape, and/or size of the eye-box 459 at the second time instance. The size and location of the eye-box 459 at the third position may be maintained for a third time period until a change in the eye tracking information of the eye pupil 258 is detected.

Referring to FIGS. 4B-4E, based on the eye tracking information, the controller 215 may control the in-coupling grating 435 to operate in different diffraction states to couple the input image light 231 as the in-coupling image lights propagating in different directions. The redirecting grating 405-1 or 405-2 may direct the in-coupled image light received from the in-coupling grating 435 to propagate toward a selected portion (e.g., one of the row including gratings 461 to 463, and the row including the gratings 467 to 469) of the out-coupling element 445, which may otherwise not receive the in-coupled image light output from the in-coupling grating 435. In other words, the redirecting grating 405-1 or 405-2 may provide a local illumination to the selected portion of the out-coupling element 445. Based on the eye tracking information, the controller 215 may control one or more out-coupling gratings located in the selected portion of the out-coupling element 445 to operate in the diffraction state to couple the in-coupled image light directed thereto out of the light guide 210, and control the remaining one or more out-coupling gratings located in the selected portion of the out-coupling element 445 to operate in the non-diffraction state.

Compared to the conventional light guide display system 100 shown in FIGS. 1A and 1B that provides a full-size eye-box 159, the disclosed light guide display system 401 may increase the light intensity of the image light delivered to the eye pupil 258. The loss of the image light directed to regions outside the eye pupil 258 and the undesirable illumination around the eye pupil 258 may be reduced. As a result, the power consumption of the light source assembly 205 may be significantly reduced. In other words, the power efficiency of the light guide display system 401 may be significantly increased. The reduced power consumption may enable a smaller light source assembly 205 and a smaller power supply to be used, which in turn reduces the overall form factor of the optical system 400. On the other hand, benefits associated with a full-size eye-box (e.g., receiving at least the full FOV that determines the angular size of the image) may be retained with the active eye-box 459, and ghosting effects, distortion, and interference that may be observed in the full-size eye-box may be suppressed.

For illustrative purposes, FIG. 4B-4E show that during different time instances, based on the eye tracking information, the controller 215 selectively controls only one of the out-coupling gratings of the out-coupling element 445 to operate in the diffraction state, and selectively controls the remaining out-coupling gratings of the out-coupling element 445 to operate in the non-diffraction state. In some embodiments, although not shown, based on the eye tracking information, the controller 215 selectively controls more than one of the out-coupling gratings of the out-coupling element 445 to operate in the diffraction state, and selectively controls the remaining out-coupling gratings of the out-coupling element 445 to operate in the non-diffraction state.

For illustrative purposes, FIGS. 4A-4E show that the in-coupling grating 435 operates in three different diffraction state, and the out-coupling element 445 includes nine out-coupling gratings arranged in a 3×3 array. The two redirecting gratings 405-1 and 405-2 are disposed between the in-coupling grating 435 and the out-coupling element 445. The number of the diffraction states of the in-coupling grating 435 may be any suitable number, such as two, four, five, or six, etc. The number of out-coupling gratings included in the out-coupling element 445 may be any suitable number, such as four, or six, etc. The number of the redirecting gratings may be any suitable number, such as one, three, four, five, or six, etc. The number of the diffraction states of the in-coupling grating 435, and the number of the redirecting gratings may be determined, in part, by the number, the size, and the arrangement of the out-coupling gratings included in the out-coupling element 445.

In some embodiments, an active grating configured to operate in a plurality of (e.g., two) different diffraction states (e.g., at different driving voltages) to diffract the same incident light at a plurality of (e.g., three) different diffraction angles may be replaced by a plurality of (e.g., three) active gratings. Each of the plurality of (e.g., three) active gratings may be controlled or switched, e.g., by the controller 215, between operating in a diffraction state to diffract an incident light, and operating in a non-diffraction state to transmit the incident light with substantially zero or negligible diffraction. The plurality of (e.g., three) active gratings that operates in the diffraction state may diffract the same incident light at a plurality of (e.g., three) different diffraction angles.

FIG. 4F schematically illustrates an x-y sectional view of an optical system 480, according to an embodiment of the present disclosure. The optical system 480 may be a part of a system (e.g., an NED, an HUD, an HMD, a smart phone, a laptop, or a television, etc.) for VR, AR, and/or MR applications. The optical system 480 may include elements that are similar to or the same as those included in the optical system 400 shown in FIGS. 4A-4E. The optical system 480 may include a light guide display system 481 and the eye tracking system 450. The light guide display system 481 may include elements that are similar to or the same as those included in the light guide display system 200 shown in FIGS. 2A and 2B, the light guide display system 250 shown in FIG. 2C, the light guide display system 300 shown in FIGS. 3A and 3B, the light guide display system 350 shown in FIG. 3C, or the light guide display system 401 shown in FIGS. 4A-4E. Descriptions of the same or similar elements or features can refer to the above corresponding descriptions, including those rendered in connection with FIGS. 2A and 2B, FIG. 2C, FIGS. 3A and 3B, FIG. 3C, or FIGS. 4A-4E.

As shown in FIG. 4F, the light guide display system 481 may include the light source assembly 205, the light guide 210, the controller 215. The light guide 210 may be coupled with an in-coupling element 435, one or more redirecting/folding elements (e.g., 405-1 and 405-2), the out-coupling element 445. The in-coupling element 435 may include a plurality of in-coupling gratings 435-1, 435-2, and 435-3, each of which may be an active grating that is controlled or switched, e.g., by the controller 215, between operating in a diffraction state to diffract an incident light, and operating in a non-diffraction state to transmit the incident light with substantially zero or negligible diffraction. The plurality of in-coupling gratings 435-1, 435-2, and 435-3 may be stacked at the same surface of the light guide 210 or at different surfaces of the light guide 210. For discussion purposes, FIG. 4F shows that the in-coupling element 435 includes three in-coupling gratings 435-1, 435-2, and 435-3 stacked at the first surface 210-1 of the light guide 210.

Based on the eye tracking information, the controller 215 may control one of the in-coupling gratings 435-1, 435-2, and 435-3 to operate in the diffraction state, and the remaining of the in-coupling gratings 435-1, 435-2, and 435-3 to operate in the non-diffraction state. The in-coupling gratings 435-1, 435-2, and 435-3 may be configured (e.g., by configuring the grating periods, or modulations of the refractive indices, etc.), such that the in-coupling gratings 435-1, 435-2, and 435-3 operating in the diffraction state during different time instances may diffract the in-coupled image light 231 at different diffraction angles.

For example, when the controller 215 controls the in-coupling grating 435-1 to operate in the diffraction state, and the in-coupling grating 435-2 and 435-3 to operate in the non-diffraction state, the in-coupling grating 435-1 may couple, via diffraction, the input image light 230 as an in-coupled image light 491-1 propagating toward the out-coupling element 445, e.g., along the x-axis direction. The in-coupled image light 491-1 may have a predetermined TIR propagation angle inside the light guide 210.

For example, when the controller 215 controls the in-coupling grating 435-2 to operate in the diffraction state, and the in-coupling grating 435-1 and 435-3 to operate in the non-diffraction state, the in-coupling grating 435-2 may couple, via diffraction, the input image light 230 as the in-coupled image light 491-2 propagating toward the redirecting grating 405-2. The redirecting grating 405-2 may be configured to diffract the in-coupled image light 491-2 as an in-coupled image light having the same predetermined TIR propagation angle as the in-coupled image light 491-1, and propagating toward the out-coupling element 445 along the same direction as the in-coupled image light 491-1, e.g., along the x-axis direction.

For example, when the controller 215 controls the in-coupling grating 435-3 to operate in the diffraction state, and the in-coupling grating 435-1 and 435-2 to operate in the non-diffraction state, the in-coupling grating 435-3 may couple, via diffraction, the input image light 230 as the in-coupled image light 491-3 propagating toward the redirecting grating 405-1. The redirecting grating 405-1 may be configured to diffract the in-coupled image light 491-3 as an in-coupled image light having the same predetermined TIR propagation angle as the in-coupled image light 491-1, and propagating toward the out-coupling element 445 along the same direction as the in-coupled image light 491-1, e.g., along the x-axis direction.

Thus, the redirecting grating 405-1 or 405-2 may direct the in-coupled image light received from the in-coupling grating 435 to propagate toward a selected portion (e.g., one of the row including gratings 461 to 463, and the row including the gratings 467 to 469) of the out-coupling element 445, which may otherwise not receive the in-coupled image light output from the in-coupling grating 435. In other words, the redirecting grating 405-1 or 405-2 may provide a local illumination to the selected portion of the out-coupling element 445. Based on the eye tracking information, the controller 215 may control one or more out-coupling gratings located in the selected portion of the out-coupling element 445 to operate in the diffraction state to couple the in-coupled image light directed thereto out of the light guide 210, and control the remaining one or more out-coupling gratings located in the selected portion of the out-coupling element 445 to operate in the non-diffraction state.

The elements in the light guide display systems and the features of the light guide display systems as described in various embodiments may be combined in any suitable manner. For example, in some embodiments, the light guide 210 included in the light guide display system 401 shown in FIGS. 4A-4E may also be coupled with the recycling element 237 shown in FIGS. 2A and 2B or the recycling element 237 shown in FIG. 2C. In some embodiments, the light guide 210 included in the light guide display system 401 shown in FIGS. 4A-4E may also be coupled with the retardation film 337 shown in FIGS. 3A and 3B or the retardation film 337 shown in FIG. 3C. In some embodiments, the light guide 210 included in the light guide display system 481 shown in FIG. 4F may also be coupled with the recycling element 237 shown in FIGS. 2A and 2B or the recycling element 237 shown in FIG. 2C. In some embodiments, the light guide display system 481 shown in FIG. 4F may also be coupled with the retardation film 337 shown in FIGS. 3A and 3B or the retardation film 337 shown in FIG. 3C.

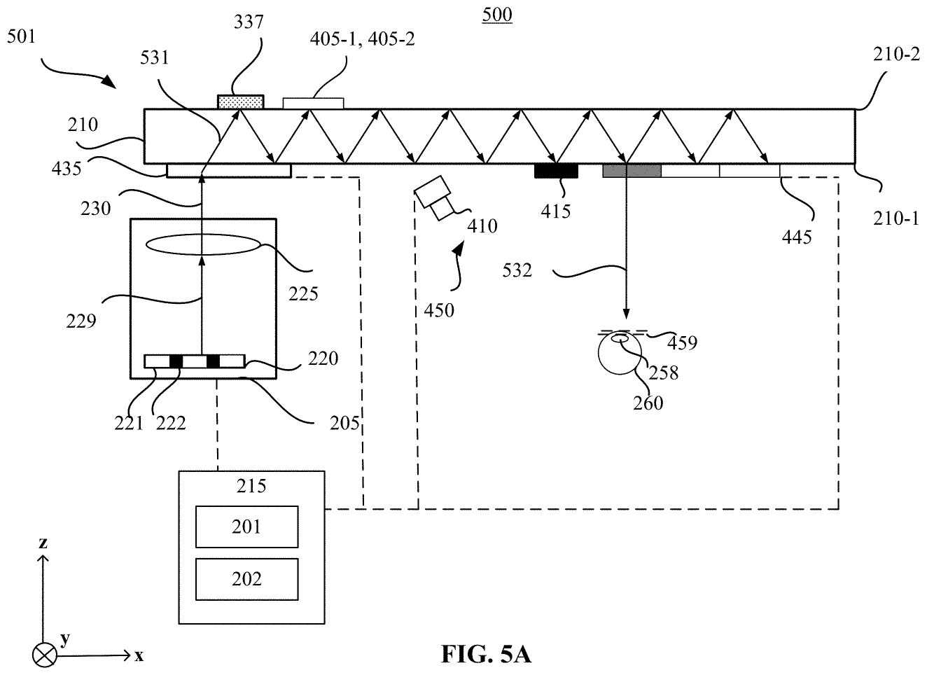

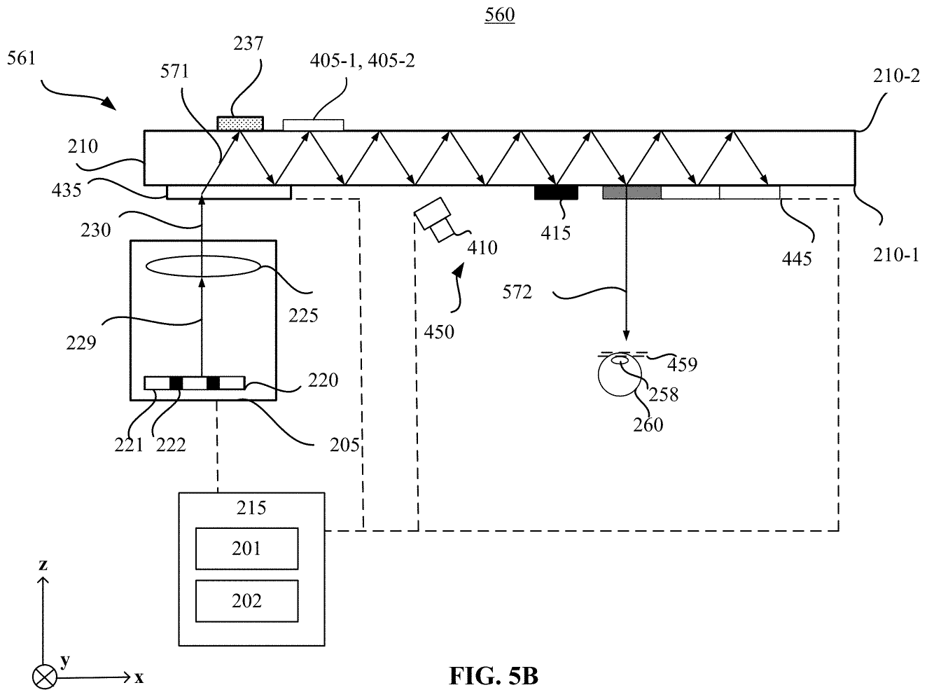

FIG. 5A schematically illustrates an x-y sectional view of an optical system 500, according to an embodiment of the present disclosure. The optical system 500 may be a part of a system (e.g., an NED, an HUD, an HMD, a smart phone, a laptop, or a television, etc.) for VR, AR, and/or MR applications. The optical system 500 may include elements that are similar to or the same as those included in the optical system 400 shown in FIGS. 4A-4E, or the optical system 480 shown in FIG. 4F. As shown in FIG. 5A, the optical system 500 may include a light guide display system 501 and the eye tracking system 450. The light guide display system 501 may include elements that are similar to or the same as those included in the light guide display system 200 shown in FIGS. 2A and 2B, the light guide display system 250 shown in FIG. 2C, the light guide display system 300 shown in FIGS. 3A and 3B, the light guide display system 350 shown in FIG. 3C, the light guide display system 401 shown in FIGS. 4A-4E, or the light guide display system 481 shown in FIG. 4F. Descriptions of the same or similar elements or features can refer to the above corresponding descriptions, including those rendered in connection with FIGS. 2A and 2B, FIG. 2C, FIGS. 3A and 3B, FIG. 3C, FIGS. 4A-4E, or FIG. 4F.

As shown in FIG. 5A, the optical system 500 may provide the active eye-box 459 based on the eye tracking information. For example, FIG. 5A shows that the controller 215 controls one of the out-coupling gratings of the out-coupling element 445 to operate in the diffraction state (e.g., the leftmost out-coupling grating filled with grey color), and the remaining out-coupling gratings of the out-coupling element 445 to operate in the non-diffraction state. The out-coupling grating operating in the diffraction state may couple an in-coupled image light 531 as an output image light 532 that provides the eye-box 459 at which the exit pupil 258 of the user is located.

In addition, the light guide 210 included in the light guide display system 501 may also be coupled with one or more retardation films 337. The in-coupling grating 435 may be a polarization selective grating configured to substantially diffract (e.g., forwardly or backwardly) an incident light with a first polarization, while substantially transmit an incident light with a second polarization other than (e.g., orthogonal to) the first polarization, with negligible or zero diffraction. In some embodiments, the in-coupling grating 435 may be a PVH grating configured to substantially diffract an LHCP (or an RHCP) light, and substantially transmit an RHCP (or LHCP) light with negligible or zero diffraction.

The retardation film 337 may be configured to control a polarization of the in-coupled image light 531 output from the retardation film 337 toward the in-coupling grating 435. Thus, when the in-coupled image light 531 output from the retardation film 337 interacts with the in-coupling grating 435, the in-coupled image light 531 may be transmitted through the volume of the in-coupling grating 435 with negligible or zero diffraction, instead of being diffracted out of the light guide 210. For example, when the in-coupling grating 435 is a PVH grating configured to substantially diffract an LHCP light, and substantially transmit an RHCP light with negligible or zero diffraction, the retardation film 337 may configure the in-coupled image light 531 output from the retardation film 337 and propagating toward the in-coupling grating 435 to be an RHCP light. Thus, when the in-coupled image light 531 (e.g., RHCP light) output from the retardation film 337 interacts with the in-coupling grating 435, the in-coupled image light 531 (e.g., RHCP light) may be substantially transmitted through the volume of the in-coupling grating 435, with negligible or zero diffraction. Thus, the optical efficiency at the input side of the light guide 210 (or the input efficiency of the in-coupling grating 435) may be improved. Accordingly, the power efficiency of the optical system 500 may be further improved.

FIG. 5B schematically illustrates an x-y sectional view of an optical system 560, according to an embodiment of the present disclosure. The optical system 560 may be a part of a system (e.g., an NED, an HUD, an HMD, a smart phone, a laptop, or a television, etc.) for VR, AR, and/or MR applications. The optical system 560 may include elements that are similar to or the same as those included in the optical system 400 shown in FIGS. 4A-4E, the optical system 480 shown in FIG. 4F, or the optical system 500 shown in FIG. 5A. As shown in FIG. 5B, the optical system 560 may include a light guide display system 561 and the eye tracking system 450. The light guide display system 561 may include elements that are similar to or the same as those included in the light guide display system 200 shown in FIGS. 2A and 2B, the light guide display system 250 shown in FIG. 2C, the light guide display system 300 shown in FIGS. 3A and 3B, the light guide display system 350 shown in FIG. 3C, the light guide display system 401 shown in FIGS. 4A-4E, the light guide display system 481 shown in FIG. 4F, or the light guide display system 501 shown in FIG. 5A. Descriptions of the same or similar elements or features can refer to the above corresponding descriptions, including those rendered in connection with FIGS. 2A and 2B, FIG. 2C, FIGS. 3A and 3B, FIG. 3C, FIGS. 4A-4E, FIG. 4F, or FIG. 5A.

As shown in FIG. 5B, the optical system 560 may provide the active eye-box 459 based on the eye tracking information. For example, FIG. 5B shows that the controller 215 controls one of the out-coupling gratings of the out-coupling element 445 to operate in the diffraction state (e.g., the leftmost out-coupling grating filled with grey color), and the remaining out-coupling gratings of the out-coupling element 445 to operate in the non-diffraction state. The out-coupling grating operating in the diffraction state may couple an in-coupled image light 571 as an output image light 572 that provides the eye-box 459 at which the exit pupil 258 of the user is located.

In addition, the light guide 210 included in the light guide display system 561 may also be coupled with one or more recycling elements 237. In some embodiments, a portion of the in-coupled image light 571 may interact with the in-coupling grating 435 again as propagating inside the light guide 210 via TIR, and may be coupled out of the light guide 210 by the in-coupling grating 435. The recycling element 237 may be configured to couple, via deflection, the portion of the in-coupled image light 571 that has been coupled out of the light guide 210 by the in-coupling grating 435, back into the light guide 210. Thus, the optical efficiency at the input side of the light guide 210 (or the input efficiency of the in-coupling grating 435) may be improved. Accordingly, the power efficiency of the optical system 560 may be further improved.

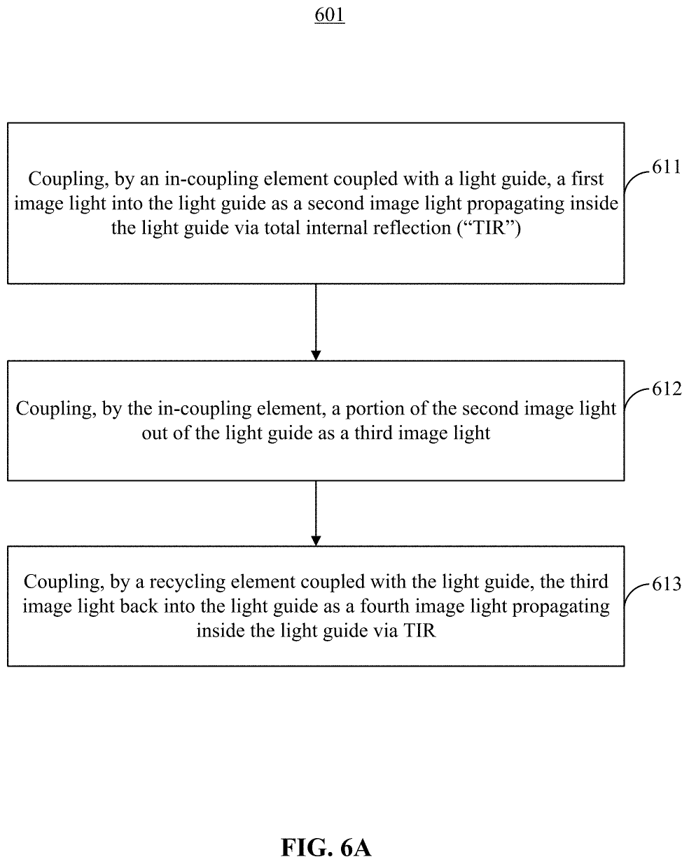

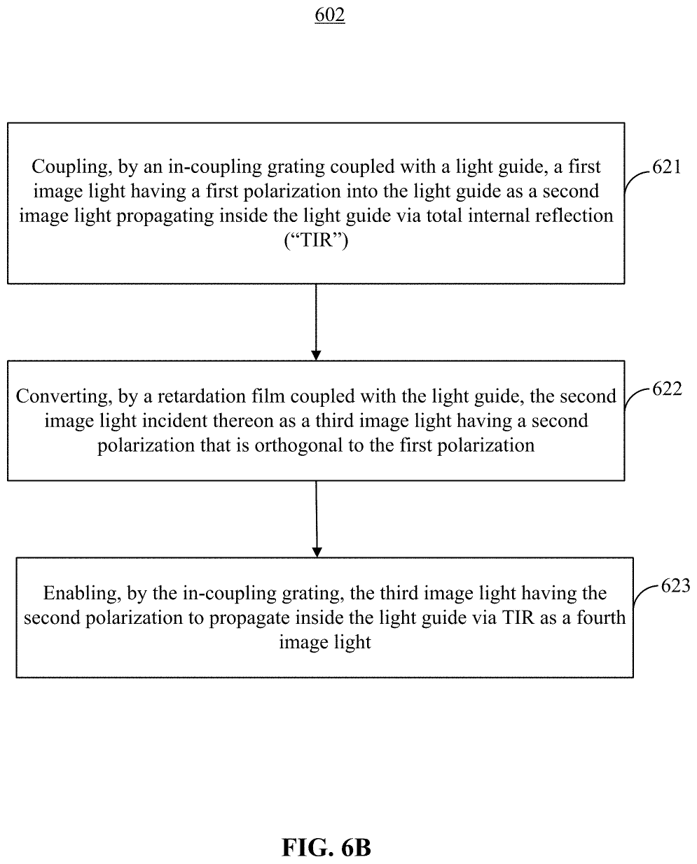

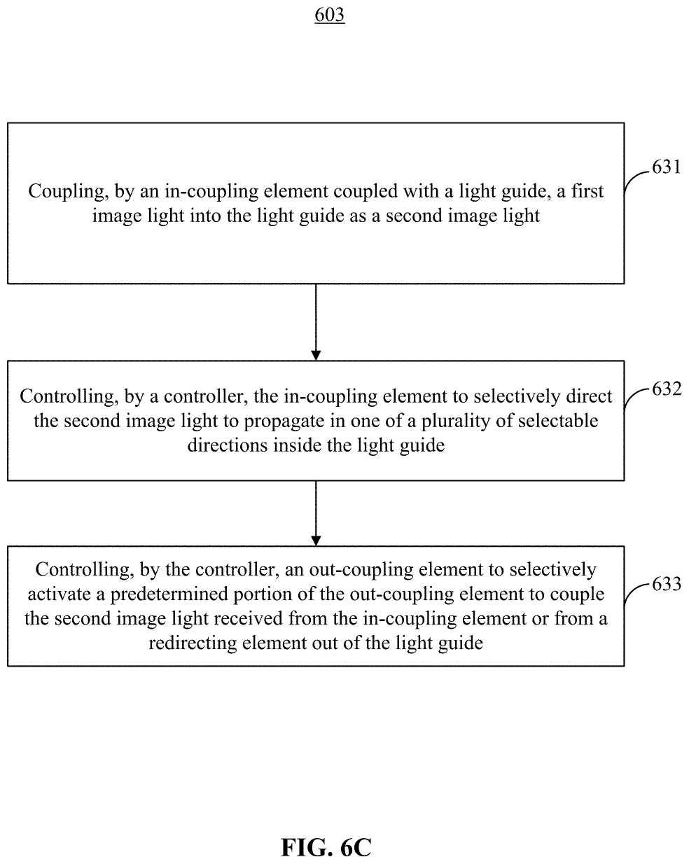

FIG. 6A is a flowchart illustrating a method 601 for providing an increased power efficiency, according to an embodiment of the present disclosure. The method 601 may include coupling, by an in-coupling element coupled with a light guide, a first image light into the light guide as a second image light propagating inside the light guide via total internal reflection (“TIR”) (step 611). The method 601 may also include coupling, by the in-coupling element, a portion of the second image light out of the light guide as a third image light (step 612). The method 601 may further include coupling, by a recycling element coupled with the light guide, the third image light back into the light guide as a fourth image light propagating inside the light guide via TIR (step 613).

Although not shown, the method 601 may include other steps and processes described above in connection with other figures. In some embodiments, the recycling element may include a recycling grating. The method 601 may also include diffracting, by the recycling grating, the third image light back into the light guide as the fourth image light having the same TIR propagation angle inside the light guide as the second image light. The portion of the second image light that propagates out of the light guide as the third image light may be a first portion. A second portion of the second image light may propagate inside the light guide via TIR. In some embodiments, the method 601 may also include coupling, by an out-coupling element coupled with the light guide, the fourth image light and the second portion of the second image light out of the light guide as an output image light.

FIG. 6B is a flowchart illustrating a method 602 for providing an increased power efficiency, according to an embodiment of the present disclosure. The method 602 may include coupling, by an in-coupling grating coupled with a light guide, a first image light having a first polarization into the light guide as a second image light propagating inside the light guide via total internal reflection (“TIR”) (step 621). In some embodiments, the method 602 may also include converting, by a retardation film coupled with the light guide, the second image light incident thereon as a third image light having a second polarization that is orthogonal to the first polarization (step 622). The method 602 may also include enabling, by the in-coupling grating, the third image light having the second polarization to propagate inside the light guide via TIR as a fourth image light (step 623). The in-coupling grating may enable the third image light to propagate inside the light guide via TIR through transmission and/or reflection.

In some embodiments, the in-coupling grating and the retardation film coupled with the light guide may be disposed at the same surface of the light guide, and the in-coupling grating may be disposed between the light guide and the retardation film. In some embodiments, the in-coupling grating and the retardation film coupled with the light guide may be disposed at opposite surfaces of the light guide. Although not shown, the method 602 may include other steps or processes described in connection with other figures. In some embodiments, the method 602 may include transmitting, by the volume of the in-coupling grating, the third image light having the second polarization as a fifth image light propagating toward an interface between the in-coupling grating and an outside environment. In some embodiments, the method 602 may include, totally internally reflecting, by the interface between the in-coupling grating and the outside environment, the fifth image light as the fourth image light propagating back to the volume of the in-coupling grating. In some embodiments, the method 602 may include, transmitting, by the volume of the in-coupling grating, the fourth image light into the light guide.

In some embodiments, the polarization of the image light propagation inside the light guide may be changed. In some embodiments, the method 602 may also include converting, by the retardation film coupled with the light guide, the second image light incident thereon as a third image light having a predetermined polarization. The method 602 may also include reflecting, by the in-coupling grating, the third image light propagating through a volume of the in-coupling grating at a surface of the in-coupling grating as a fourth image light having a second polarization that is orthogonal to the first polarization. The method 602 may also include, transmitting, by the volume of the in-coupling grating, the fourth image light having the second polarization as a fifth image light propagating inside the light guide via TIR.

FIG. 6C is a flowchart illustrating a method 603 for providing an increased power efficiency, according to an embodiment of the present disclosure. The method 603 may include coupling, by an in-coupling element coupled with a light guide, a first image light into the light guide as a second image light (step 631). The method 603 may also include controlling, by a controller, the in-coupling element to selectively direct the second image light to propagate in one of a plurality of selectable directions inside the light guide (step 632). The plurality of selectable directions may include one or more directions from the in-coupling element to one or more redirecting elements and/or a direction from the in-coupling element to the out-coupling element. The out-coupling elements may include a plurality of selectively activatable portions (e.g., out-coupling gratings). The method 603 may also include controlling, by the controller, an out-coupling element to selectively activate a predetermined portion of the out-coupling element to couple the second image light received from the in-coupling element or from a redirecting element out of the light guide (step 633).

Although not shown, the method 603 may include other steps or processes described above in connection with other figures. For example, in some embodiments, the method 603 may include, based on eye-tracking information, controlling, by the controller, the in-coupling element to selectively direct the second image light to propagate in one of the plurality of selectable directions inside the light guide. The method 603 may include, based on the eye-tracking information, controlling, by the controller, the out-coupling element to selectively activate one or more out-coupling gratings in the predetermined portion of the out-coupling element to couple the second image light received from the in-coupling element or from the redirecting element out of the light guide as an output image light propagating toward a small portion of a full eye-box. The small portion of the full eye-box may be aligned with a position of an eye pupil of a user, and may have a size that may be comparable with and slightly larger than the size of the eye pupil.

In some embodiments, the plurality of selectable directions may include a plurality of directions from the in-coupling element to a plurality of redirecting elements. The controller may control the in-coupling element such that the second image light is directed from the in-coupling element to one of the redirecting elements in one of the selectable directions. The redirecting element may redirect the second image light to one of the plurality of predetermined portions of the out-coupling element. The out-coupling element may couple the second image light out of the light guide, for example, to a small portion of a full eye-box corresponding to an eye pupil of a user. In some embodiments, the plurality of selectable directions may include one or more directions from the in-coupling element to one or more redirecting elements, and one or more directions from the in-coupling element to one or more predetermined portions of the out-coupling element. The controller may control the in-coupling element such that the second image light propagates from the in-coupling element either to one of the redirecting elements, which then redirects the second image light to one of the predetermined portions of the out-coupling element, or directly propagates from the in-coupling element to a predetermined portion of the out-coupling element.

The disclosed optical systems (e.g., light guide display systems) and method for providing an increased power efficiency (e.g., providing an increased input efficiency and/or an active eye-box) may be implemented in various systems, e.g., a near-eye display (“NED”), a head-up display (“HUD”), a head-mounted display (“HMD”), smart phones, laptops, or televisions, etc. In addition, the light guide display systems shown in the figures are for illustrative purposes to explain the mechanism for providing an increased power efficiency. The mechanism for providing an increased power efficiency may be applicable to any suitable display systems other than the disclosed light guide display systems. The gratings are for illustrative purposes. Any suitable light deflecting elements (e.g., non-switchable light deflecting elements, indirectly switchable light deflecting elements, and/or directly switchable light deflecting elements) may be used and configured to provide the increased power efficiency, following the same or similar design principles described herein with respect to the gratings.

A non-switchable light deflecting element may be a passive light deflecting element. In some embodiments, the passive light deflecting element may be polarization non-selective (or polarization independent). An indirectly switchable light deflecting element may be a passive light deflecting element that is polarization selective. The indirectly switchable light deflecting element may be switchable between different operating states when the polarization of the input light is switched by a polarization switch coupled with the passive light deflecting element. A directly switchable light deflecting element may be switchable between different operating states when a driving voltage applied to the directly switchable light deflecting element is controlled to be different voltages.

For example, the light deflecting element may include a polarization selective grating or a holographic element that includes sub-wavelength structures, liquid crystals, a photo-refractive holographic material, or a combination thereof. In some embodiments, the polarization non-selective light deflecting element may also be implemented and configured to provide an increased output pixel density. In some embodiments, the light deflecting elements may include diffraction gratings, cascaded reflectors, prismatic surface elements, an array of holographic reflectors, or a combination thereof. The controller may be configured to configure a light deflecting element to operate at a light deflection state to deflect an input light to change a propagating direction of the input light, or operate at a light non-deflection state in which the light deflecting element may not change the propagating direction of the input light.

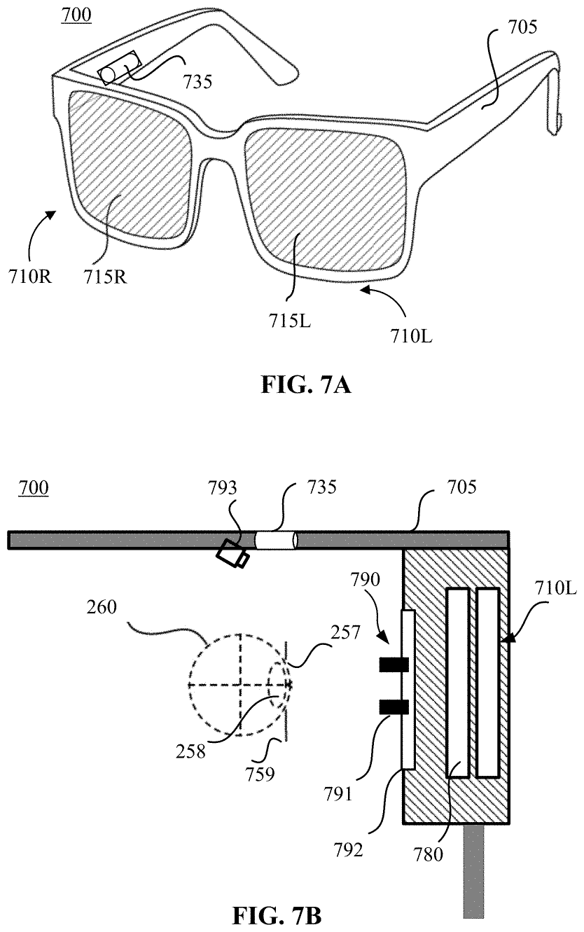

FIG. 7A illustrates a schematic diagram of a near-eye display (“NED”) 700 according to an embodiment of the present disclosure. FIG. 7B is a cross-sectional view of half of the NED 700 shown in FIG. 7A according to an embodiment of the present disclosure. For purposes of illustration, FIG. 7B shows the cross-sectional view associated with a left-eye display system 710L. The NED 700 may include a controller (not shown), which may be similar to the controller 215. The NED 700 may include a frame 705 configured to mount to a user's head. The frame 705 is merely an example structure to which various components of the NED 700 may be mounted. Other suitable type of fixtures may be used in place of or in combination with the frame 705. The NED 700 may include right-eye and left-eye display systems 710R and 710L mounted to the frame 705. The NED 700 may function as a VR device, an AR device, an MR device, or any combination thereof. In some embodiments, when the NED 700 functions as an AR or an MR device, the right-eye and left-eye display systems 710R and 710L may be entirely or partially transparent from the perspective of the user, which may provide the user with a view of a surrounding real-world environment. In some embodiments, when the NED 700 functions as a VR device, the right-eye and left-eye display systems 710R and 710L may be opaque to block the light from the real-world environment, such that the user may be immersed in the VR imagery based on computer-generated images.

The left-eye and right-eye display systems 710L and 710R may include image display components configured to project computer-generated virtual images into left and right display windows 715L and 715R in a field of view (“FOV”). The left-eye and right-eye display systems 710L and 710R may be any suitable display systems. In some embodiments, the left-eye and right-eye display systems 710L and 710R may include one or more optical systems (e.g., light guide display systems) disclosed herein, such as the light guide display system 200 shown in FIGS. 2A and 2B, the light guide display system 250 shown in FIG. 2C, the light guide display system 300 shown in FIGS. 3A and 3B, the light guide display system 350 shown in FIG. 3C, the light guide display system 401 shown in FIGS. 4A-4E, the light guide display system 481 shown in FIG. 4F, the light guide display system 501 shown in FIG. 5A, or the light guide display system 561 shown in FIG. 5B. For illustrative purposes, FIG. 7A shows that the left-eye display systems 710L may include a light source assembly (e.g., a projector) 735 coupled to the frame 705 and configured to generate an image light representing a virtual image.

As shown in FIG. 7B, the left-eye display systems 710L may also include a viewing optical system 780 and an object tracking system 790 (e.g., eye tracking system and/or face tracking system). The viewing optical system 780 may be configured to guide the image light output from the left-eye display system 710L to the exit pupil 727. The exit pupil 257 may be a location where an eye pupil 258 of the eye 260 of the user is positioned in an eye-box region 759 of the left-eye display system 710L. In some embodiments, the eye-box region 759 may be a full eye-box region. In some embodiments, the eye-box region 759 may be an active eye-box. For example, the viewing optical system 780 may include one or more optical elements configured to, e.g., correct aberrations in an image light output from the left-eye display systems 710L, magnify an image light output from the left-eye display systems 710L, or perform another type of optical adjustment of an image light output from the left-eye display systems 710L. Examples of the one or more optical elements may include an aperture, a Fresnel lens, a convex lens, a concave lens, a filter, any other suitable optical element that affects an image light, or a combination thereof.

The object tracking system 790 may include an IR light source 791 configured to illuminate the eye 260 and/or the face, a deflecting element 792 (such as a grating), and an optical sensor 793 (such as a camera). The deflecting element 792 may deflect (e.g., diffract) the IR light reflected by the eye 260 toward the optical sensor 793. The optical sensor 793 may generate a tracking signal relating to the eye 260. The tracking signal may be an image of the eye 260. A controller (not shown), such as the controller 215, may control various optical elements, such as an active in-coupling element, an active out-coupling element, an active dimming element, etc., based on eye-tracking information obtained from analysis of the image of the eye 260. In some embodiments, the object tracking system 790 may include elements similar to the eye tracking system 450 shown in FIG. 4A-FIG. 5B.

In some embodiments, the NED 700 may include an adaptive or active dimming element configured to dynamically adjust the transmittance of lights reflected by real-world objects, thereby switching the NED 700 between a VR device and an AR device or between a VR device and an MR device. In some embodiments, along with switching between the AR/MR device and the VR device, the adaptive dimming element may be used in the AR and/MR device to mitigate differences in brightness of lights reflected by real-world objects and virtual image lights.

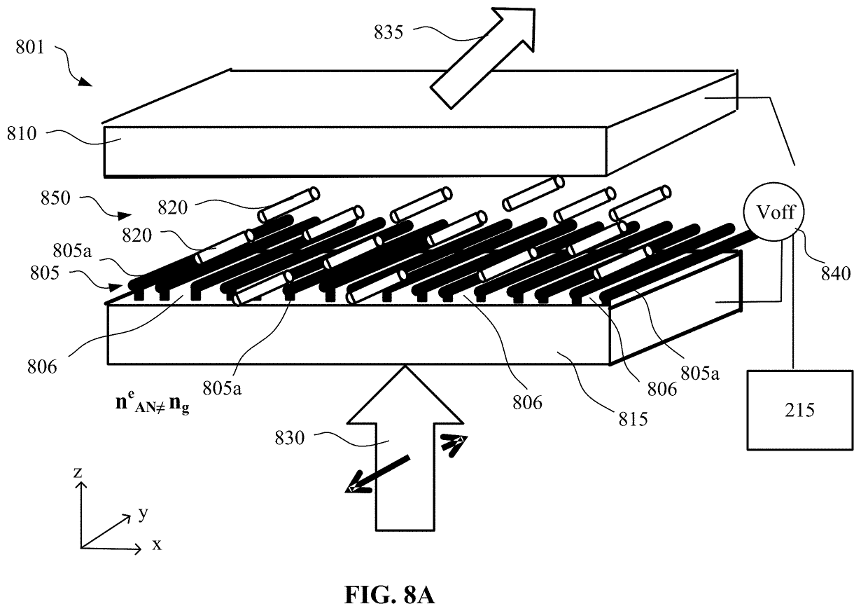

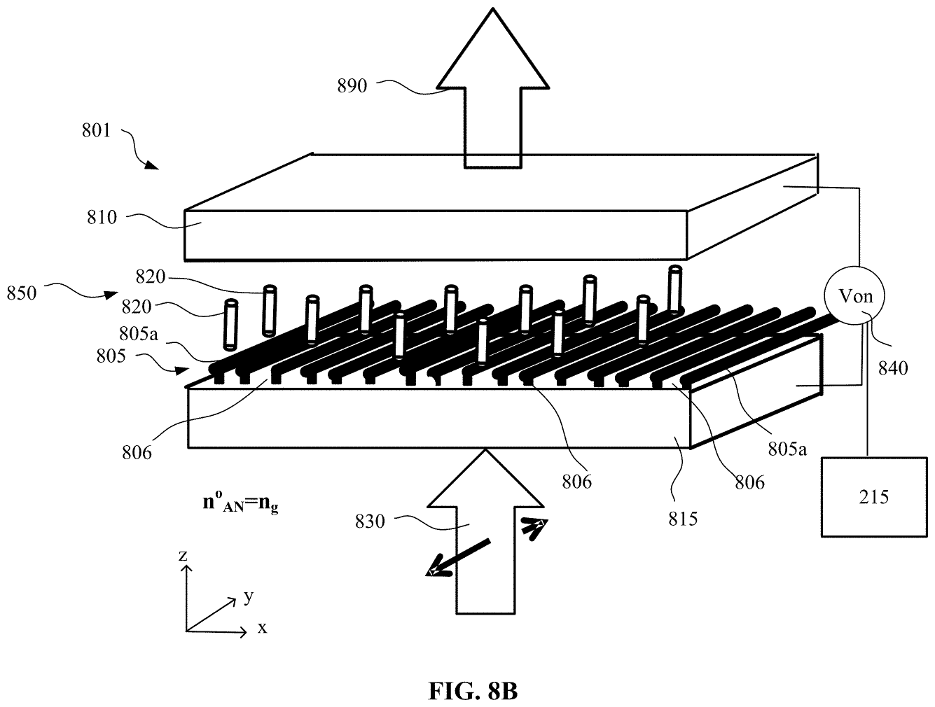

FIGS. 8A-11H illustrate exemplary active diffractive optical elements (e.g., active gratings), which may be implemented in various light guide display systems disclosed herein, for example, as gratings described above and shown in other figures for providing an increased input efficiency and/or an active eye-box. The active diffractive optical element (e.g., active grating) may be implemented as an in-coupling element, an out-coupling element, or a redirecting element.

FIGS. 8A and 8B illustrate a schematic diagram of an active grating 801 at a diffraction state and a non-diffraction state, respectively, according to an embodiment of the disclosure. The active grating 801 may be implemented into a light guide display system disclosed herein as an in-coupling grating, an out-coupling grating, or a redirecting grating. A power source 840 may be electrically coupled with the active grating 801 via electrodes (not shown) disposed at the active grating 801. The power source 840 may provide an electric field to the active grating 801 through the electrodes. The controller 215 may be electrically coupled (e.g., through a wired or wireless connection) with the power source 840, and may control the output voltage and/or current of the power source 840. The active grating 801 may be switchable between a diffraction state and a non-diffraction state, when the controller 215 controls the power source 840 to generate a suitable electric field in the active grating 801. As described above, an active grating may be polarization selective or polarization nonselective. For illustrative purposes, the active grating 801 is shown as a polarization selective grating.

As shown in FIGS. 8A and 8B, the active grating 801 may include an upper substrate 810 and a lower substrate 815 arranged opposing (e.g., facing) one another. In some embodiments, when the active grating 801 is implemented into a light guide display system disclosed herein, the active grating 801 may be disposed at a surface of the light guide (e.g., 210, 410, etc.). In some embodiments, one of the upper substrate 810 and the lower substrate 815 may be the light guide or a part of the light guide. In some embodiments, at least one (e.g., each) of the upper substrate 810 or the lower substrate 815 may be provided with a transparent electrode at a surface (e.g., an inner surface) of the substrate for supplying an electric field to the active grating 801, such as an indium tin oxide (“ITO”) electrode. The power source 840 may be coupled with the transparent electrodes to supply a voltage for providing the electric field to the active grating 801.

In some embodiments, the active grating 801 may include a surface relief grating (“SRG”) 805 disposed at (e.g., bonded to or formed on) a surface of the lower substrate 815 facing the upper substrate 810. The SRG 805 may include a plurality of microstructures 805a, with sizes in micron levels or nano levels, which define or form a plurality of grooves 806. The microstructures 805a are schematically illustrated as solid black longitudinal structures, and the grooves 806 are shown as white portions between the solid black portions. The number of the grooves 806 may be determined by the grating period and the size of the SRG 805. The grooves 806 may be at least partially provided (e.g., filled) with a birefringent material 850. Optically anisotropic molecules 820 of the birefringent material 850 may have an elongated shape (represented by white rods in FIGS. 8A and 8B). The optically anisotropic molecules 820 may be aligned within the grooves 806 in any suitable alignment manner, such as homeotropic alignment, or homogeneous alignment, etc. The birefringent material 850 may have a first principal refractive index (e.g., n^{e}_{AN}) along a groove direction (e.g., y-axis direction, length direction, or longitudinal direction) of the grooves 806. The birefringent material 850 may have a second principal refractive index (e.g., n^{o}_{AN}) along an in-plane direction (e.g., x-axis direction, width direction, or lateral direction) perpendicular to the groove direction of the SRG 805.

When the grooves 806 have a substantially rectangular prism shape, or a longitudinal shape, the groove direction may be a groove length direction. In some embodiments, the grooves 806 may have other shapes. Accordingly, the groove direction may be other suitable directions. The birefringent material 850 may be an active, optically anisotropic material, such as active liquid crystals (“LCs”) with LC directors reorientable by an external field, e.g., the electric field provided by the power source 840. The optically anisotropic molecules 820 of the birefringent material 850 may also be referred to as LC molecules 820. The active LCs may have a positive or negative dielectric anisotropy.

The SRG 805 may be fabricated based on an organic material, such as amorphous or liquid crystalline polymers, or cross-linkable monomers including those having LC properties (reactive mesogens (“RMs”)). In some embodiments, the SRG 805 may be fabricated based on an inorganic material, such as metals or oxides used for manufacturing metasurfaces. The materials of the SRG 805 may be isotropic or anisotropic. In some embodiments, the SRG 805 may provide an alignment for the birefringent material 850. That is, the SRG 805 may function as an alignment layer to align the birefringent material 850. In some embodiments, the optically anisotropic molecules 820 may be aligned within the grooves 806 by a suitable alignment method, such as by a mechanical force (e.g., a stretch), a light (e.g., through photoalignment), an electric field, a magnetic field, or a combination thereof.

For illustrative purposes, FIGS. 8A and 8B show that the SRG 805 may be a binary non-slanted grating with a periodic rectangular profile. That is, the cross-sectional profile of the grooves 806 of the SRG 805 may have a periodic rectangular shape. In some embodiments, the SRG 805 may be a binary slanted grating, in which the microstructures 805a are slanted at a slant angle relative to a surface of the substrate 815, on which the microstructures 805a are disposed. In some embodiments, the slant angle of the SRG 805 may continuously vary in a predetermined direction, such as the x-axis direction in FIG. 8A. In some embodiments, the cross-sectional profile of the grooves 806 of the SRG 805 may be non-rectangular, for example, sinusoidal, triangular, parallelogrammic (e.g., when the microstructures 805a are slanted), or saw-tooth shaped.

In some embodiments, the alignment of the birefringent material 850 may be provided by one or more alignment structures (e.g., alignment layers) other than by the SRG 805. An alignment structure may be disposed at the substrate 810 and/or 815 (e.g., two alignment layers may be disposed at the respective opposing surfaces of the substrates 810 and 815). In some embodiments, the alignment structures provided at both of the substrates 810 and 815 may provide parallel planar alignments or hybrid alignments. For example, the alignment structure disposed at one of the substrates 810 and 815 may be configured to provide a planar alignment, and the alignment structure disposed at the other one of the substrates 810 and 815 may be configured to provide a homeotropic alignment. In some embodiments, the alignment of the birefringent material 850 may be provided by both the SRG 805 and one or more alignment structures (e.g., alignment layers) disposed at the substrate 810 and/or 815.

In some embodiments, as shown in FIG. 8A, the birefringent material 850 may include active LCs having a positive anisotropy, such as nematic liquid crystals (“NLCs”). The LC molecules 820 of the birefringent material 850 may be homogeneously aligned within the grooves 806 in the groove direction (e.g., y-axis direction). The second principal refractive index (e.g., n^{o}_{AN}) may substantially match with a refractive index n_{g} of the SRG 805, and the first principal refractive index (e.g., n^{e}_{AN}) may not match with the refractive index n_{g} of the SRG 805. The active grating 801 may be linear polarization dependent.

For example, referring to FIG. 8A, when a linearly polarized input light 830 polarized in the groove direction (e.g., y-axis direction) is incident onto the active grating 801, due to the refractive index difference between n^{e}_{AN} and n_{g}, the input light 830 may experience a periodic modulation of the refractive index in the active grating 801. As a result, the active grating 801 may diffract the input light 830 as a light 835. Due to the substantial match between the refractive indices n^{o}_{AN} and n_{g}, the active grating 801 may function as a substantially optically uniform plate for a linearly polarized input light polarized in the in-plane direction (e.g., x-axis direction) perpendicular to the groove direction (e.g., y-axis direction). That is, the active grating 801 may not diffract the input light linearly polarized in the in-plane direction perpendicular to the groove direction. Rather, the active grating 801 may transmit the input light polarized in the in-plane direction with substantially zero or negligible diffraction.

In some embodiments, the active grating 801 may be an active grating, which may be directly switchable between a diffraction state (or an activated state) and a non-diffraction state (or a deactivated state) by an external field, e.g., an external electric field provided by the power source 840. For example, the active grating 801 may include electrodes (not shown) disposed at the upper and lower substrate 810 and 815, and the power source 840 may be electrically coupled with the electrodes to provide the electric field to the active grating 801. The controller 215 may control an output (e.g., a voltage and/or current) of the power source 840. For discussion purposes, the voltage is used as an example output of the power source 840. By controlling the voltage output by the power source 840, the controller 215 may control the switching of the active grating 801 between the diffraction state and the non-diffraction state. For example, the controller 215 may control the voltage supplied by the power source 840 to switch the active grating 801 between the diffraction state and the non-diffraction state. When the active grating 801 operates in the diffraction state, the controller 215 may adjust the voltage supplied by the power source 840 to the electrodes to adjust the diffraction efficiency.

In some embodiments, the controller 215 may control the voltage supplied by the power source 840 to be lower than or equal to a threshold voltage, thereby configuring the active grating 801 to operate in the diffraction state (or activated state). In some embodiments, the threshold voltage may be determined by physical parameters of the active grating 801. When the voltage is lower than or equal to the threshold voltage, the electric field generated by the supplied voltage may be insufficient to reorient the LC molecules 820. When the controller 215 controls the supplied voltage to be higher than the threshold voltage (and sufficiently high) to reorient the LC molecules 820 to substantially follow (e.g., be parallel with) the direction of the electric field, the active grating 801 may operate in the non-diffraction state (or deactivated state).

As shown in FIG. 8A, when the controller 215 controls the power source 840 to supply a voltage that is lower than or equal to the threshold voltage (e.g., when the power source 840 supplies a substantially zero voltage), for the linearly polarized input light 830 polarized in the groove direction (e.g., y-axis direction) of the SRG 805, due to the difference between the refractive indices n^{e}_{AN} and n_{g}, the light 830 may experience a periodic modulation of the refractive index in the active grating 801 while propagating therethrough. As a result, the active grating 801 may diffract the light 830 as the light 835. That is, the controller 215 may control the power source 840 to supply a voltage that is lower than or equal to the threshold voltage, thereby configuring the active grating 801 to operate in the diffraction state to diffract the linearly polarized input light 830. In some embodiments, when the active grating 801 operates in the diffraction state, the diffraction angle of the light 835 may be tunable (or adjustable). For example, the controller 215 may tune (or adjust) a magnitude of the supplied voltage to tune the modulation of the refractive index in the active grating 801, thereby tuning the diffraction angle of the light 835.

As shown in FIG. 8B, when a voltage is supplied to the active grating 801, an electric field (which may extend in the z-axis direction) may be generated between the parallel substrates 810 and 815. When the voltage is higher than the threshold voltage and is gradually increased, the LC molecules 820 (of LCs having the positive dielectric anisotropy) may gradually become reoriented by the electric field to align in parallel with the electric field direction. As the voltage changes, for the linearly polarized input light 830 polarized in the groove direction (e.g., y-axis direction), the modulation of the refractive index nm (i.e., the difference between n^{e}_{AN} and n_{g}) provided by the active grating 801 to the light 830 may change accordingly, which in turn may change the diffraction efficiency.

When the voltage is sufficiently high, as shown in FIG. 8B, directors of the LC molecules 820 (of LCs having the positive dielectric anisotropy) may be reoriented to be parallel with the electric field direction (e.g., z-axis direction). Due to the substantial match between the refractive indices n^{o}_{AN} and n_{g}, the active grating 801 may function as a substantially optically uniform plate for the input light 830 polarized in the groove direction. The active grating 801 may operate in a non-diffraction state to transmit the light 830 therethrough as a light 890 with substantially zero or negligible diffraction.

In the embodiment shown in FIGS. 8A and 8B, the active grating 801 is configured to operate in the diffraction state when the voltage supplied by the power source 840 is lower than or equal to the threshold voltage, and operate in the non-diffraction state when the voltage is sufficiently higher than the threshold voltage. In other embodiments, by configuring the initial orientations of the LC molecules 820 differently, the active grating 801 may be configured to operate in the diffraction state when the voltage is sufficiently higher than the threshold voltage, and operate in the non-diffraction state when the voltage is lower than or equal to the threshold voltage.

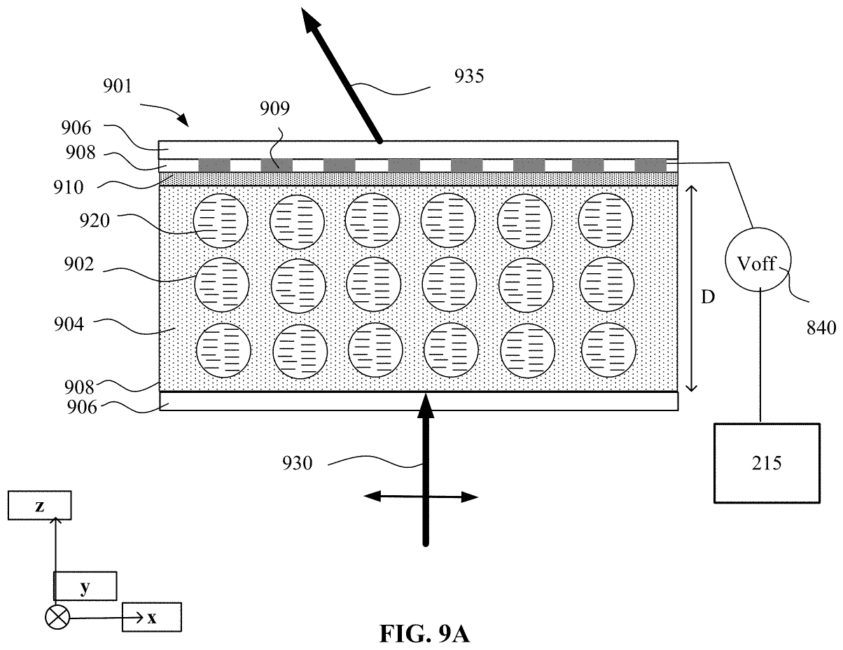

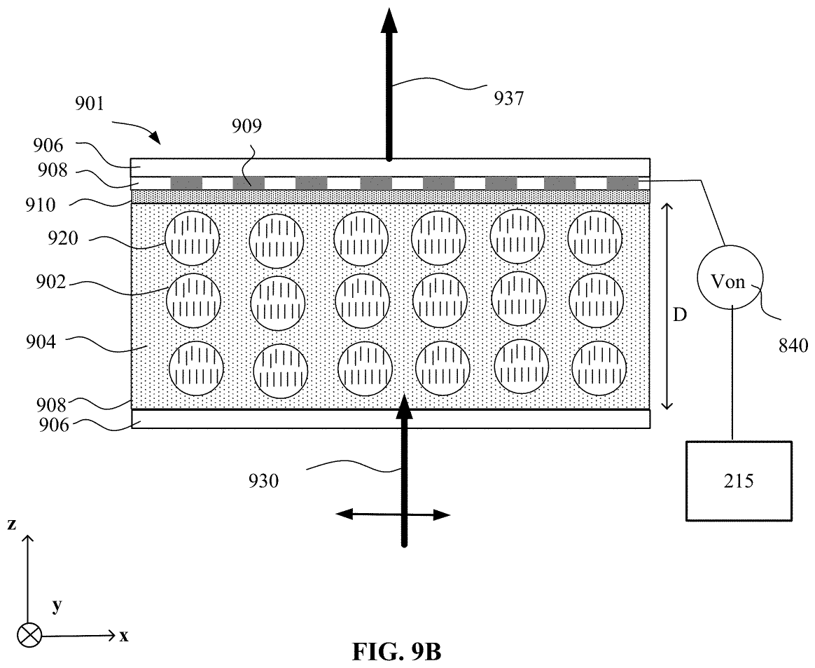

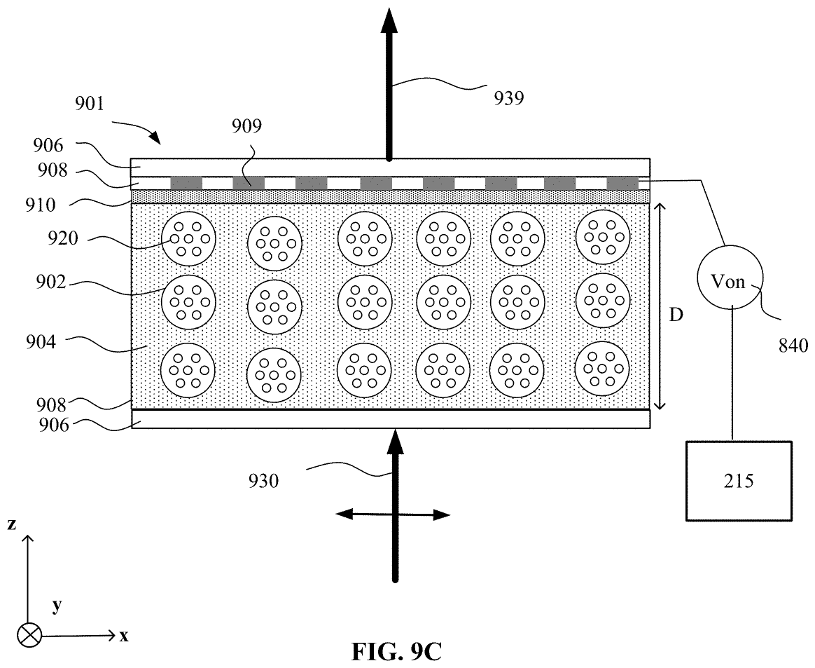

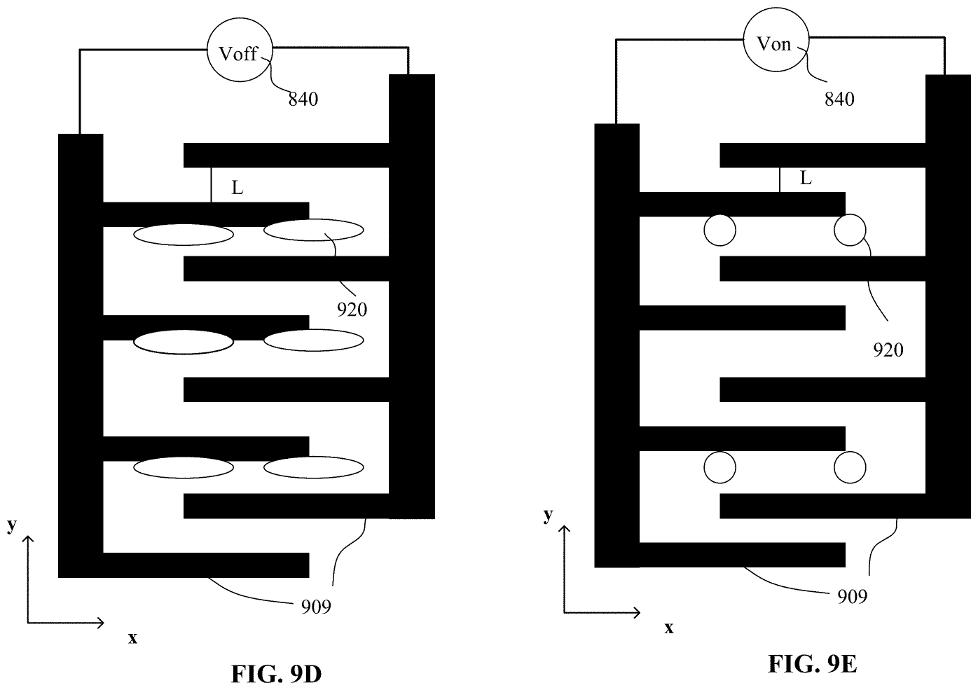

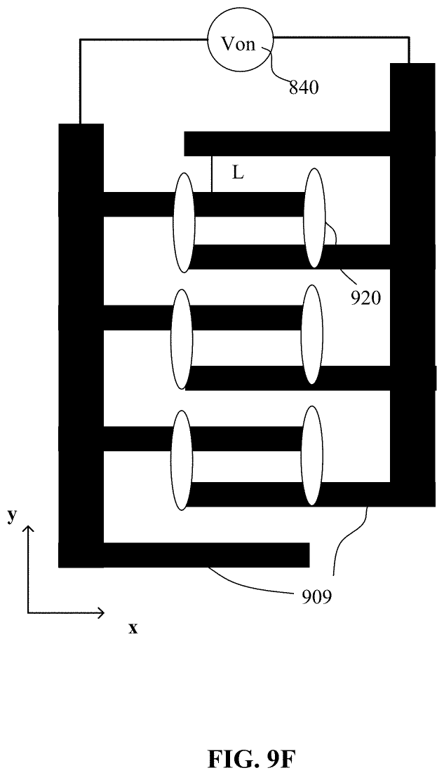

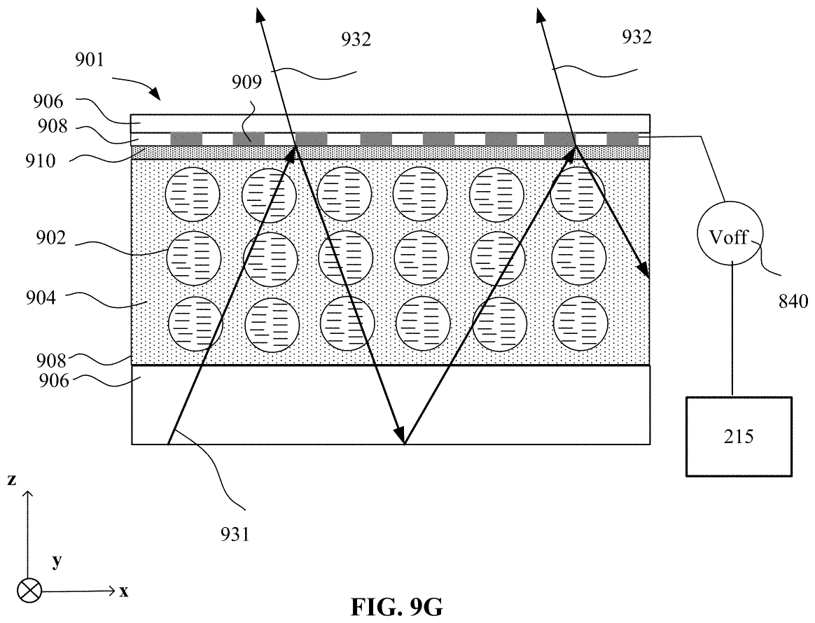

FIGS. 9A-9E illustrate schematic diagrams of an active grating 901, according to an embodiment of the disclosure. The active grating 901 may be implemented into a light guide display system disclosed herein as an in-coupling grating, an out-coupling grating, or a redirecting grating. As shown in FIG. 9A, the power source 840 may be electrically coupled with the active grating 901 to provide an electric field to the active grating 901. The controller 215 may be electrically coupled (e.g., through wired or wireless connection) with the power source 840, and may control the output of a voltage and/or current from the power source 840. The active grating 901 may be switchable between a diffraction state and a non-diffraction state, when the controller 215 controls the power source 840 to generate a suitable electric field. For illustrative purposes, the active grating 901 is shown as an active, polarization selective grating.

FIGS. 9A and 9D illustrate schematic diagrams of the active grating 901 in the diffraction state, according to an embodiment of the present disclosure. FIG. 9A illustrates an x-z sectional view of the active grating 901 in the diffraction state, and FIG. 9D illustrates an x-y sectional view of the active grating 901 in the diffraction state. As shown in FIGS. 9A and 9D, the active grating 901 may be an H-PDLC grating 901, which may be fabricated by polymerizing an isotropic photosensitive liquid mixture of monomers and LCs under a laser interference irradiation. The H-PDLC grating 901 may include layers of LC droplets 902 embedded in a polymer matrix 904 disposed between two substrates 906. One of the two substrate 906 may be provided with a transparent conductive electrode layer 908, such as an ITO electrode layer. In some embodiments, the electrode layer 908 may include interdigitated electrodes 909. In addition, at least one (e.g., each) of the substrates 906 may be provided with an alignment layer (not shown), which may be configured to homogeneously (or horizontally) align LC molecules 920 in a predetermined alignment direction, e.g., an x-axis direction in FIG. 9A.

The substrate 906 provided with the electrode layer 908 may also be provided with a low refractive index layer 910. In some embodiments, the low refractive index layer 910 may be configured to have a refractive index that is less than a refractive index nₚ of the material of the polymer matrix 904. For example, the refractive index nₚ of the material of the polymer matrix 904 may be about 1.3, and the refractive index of the low refractive index layer 910 may be less than 1.3 and close to the refractive index of air. For discussion purposes, FIG. 9A shows that the upper substrate 906 is provided with the electrode layer 908 and the low refractive index layer 910. The low refractive index layer 910 may be disposed between the electrode layer 908 and the alignment layer of the upper substrate 906. The lower substrate 906 may not be provided with an electrode layer 908.

Referring to FIG. 9A, an ordinary refractive index no of the LCs within the LC droplets 902 may be sufficiently close to the refractive index nₚ of the material of the polymer matrix 904, and an extraordinary refractive index nₑ of the LCs within the LC droplets 902 may be substantially different from the refractive index nₚ of the material of the polymer matrix 904. Due to the refractive index difference between the extraordinary refractive index nₑ of the LCs and the refractive index nₚ of the material of the polymer matrix 904, the spatial modulation of the LCs may produce a modulation in the average refractive index, resulting in an optical phase grating. When an input light 930 that is linearly polarized in the predetermined alignment direction (e.g., an x-axis direction) is incident onto the active grating 901 from the lower substrate 906, due to the refractive index difference between nₑ and nₚ, the input light 930 may experience a periodic modulation of the refractive index in the active grating 901. As a result, the active grating 901 may diffract the input light 930 as a light 935. For illustrative purposes, FIG. 9A shows that the active grating 901 forwardly diffracts the input light 930 as the light 935. In some embodiments, although not shown, the active grating 901 may backwardly diffract the input light 930 as the light 935.

The LC droplets 902 are usually small (dimensions in sub-wavelength ranges) so that scattering due to refractive index mismatch of the LC and polymer may be minimized, and phase modulation may play a primary role. In other words, H-PDLC may belong to a class of nano-PDLC. The haze of the H-PDLC grating 901 caused by the scattering of the LC droplets 902 may be substantially small.

For an input light linearly polarized in a direction (e.g., a y-axis direction) perpendicular to the predetermined alignment direction (e.g., an x-axis direction) of the H-PDLC grating 901, due to the substantial match between the refractive indices no and n_{g}, the H-PDLC grating 901 may function as a substantially optically uniform plate. That is, the H-PDLC grating 901 may not diffract, but may transmit the input light linearly polarized in the direction (e.g., a y-axis direction) perpendicular to the predetermined alignment direction (e.g., an x-axis direction).

The controller 215 may control an output (e.g., a voltage and/or current) of the power source 840. For example, by controlling the voltage output by the power source 840, the controller 215 may control the switching of the H-PDLC grating 901 between the diffraction state and the non-diffraction state. When the H-PDLC grating 901 operates in the diffraction state, the controller 215 may adjust the voltage supplied by the power source 840 to adjust the diffraction angle. In some embodiments, the controller 215 may configure the active grating 901 to operate in the diffraction state by controlling a voltage supplied by the power source 840 to be lower than or equal to a threshold voltage. When the voltage is lower than or equal to the threshold voltage, the electric field generated by the supplied voltage may be insufficient to reorient the LC molecules 920 in the LC droplets 902. In some embodiments, the controller 215 may configure the H-PDLC grating 901 to operate in the non-diffraction state by controlling the supplied voltage to be higher than the threshold voltage (and sufficiently high) to reorient the LC molecules 920 to be parallel with the direction of the electric field.

FIGS. 9B and 9E illustrate schematic diagrams of the active grating 901 in the non-diffraction state, according to an embodiment of the present disclosure. FIG. 9B illustrates an x-z sectional view of the active grating 901 in the non-diffraction state, and FIG. 9E illustrates an x-y sectional view of the active grating 901 in the non-diffraction state. As shown in FIGS. 9B and 9E, when a voltage is supplied to the H-PDLC grating 901, an electric field (e.g., along a z-axis direction) may be generated between the interdigitated electrodes 909. When the voltage is higher than the threshold voltage and is gradually increased, the LC molecules 920 (of LCs having the positive dielectric anisotropy) may gradually become reoriented by the electric field to align in parallel with the electric field direction. Depending on the gap L between the two neighboring interdigitated electrodes and the thickness D of the active grating 901, the generated electric field may be an in plane electric field that is within a plane (e.g., within the x-y plane) perpendicular to a thickness direction of the active grating 901 or a vertical electric field that is in a thickness direction (e.g., the z-axis direction) of the active grating 901.

In the embodiment shown in FIGS. 9B and 9E, the gap L between the two neighboring interdigitated electrodes and the thickness D of the active grating 901 may be configured, such that the generated electric field may be a vertical electric field that is in a thickness direction (e.g., the z-axis direction) of the active grating 901. When the voltage is sufficiently high, as shown in FIGS. 9B and 9E, directors of the LC molecules 920 (of LCs having the positive dielectric anisotropy) may be reoriented to be parallel with the electric field direction (e.g., the z-axis direction). Due to the substantial match between the refractive indices no and n_{g}, the H-PDLC grating 901 may function as a substantially optically uniform plate for the input light 930. As shown in FIG. 9B, the H-PDLC grating 901 may operate in a non-diffraction state for the light 930 polarized in the predetermined alignment direction (e.g., the x-axis direction), and may transmit the light 930 therethrough as a light 937 with substantially zero or negligible diffraction.

FIGS. 9C and 9F illustrate schematic diagrams of the active grating 901 in the non-diffraction state, according to an embodiment of the present disclosure. FIG. 9C illustrates an x-z sectional view of the active grating 901 in the non-diffraction state, and FIG. 9F illustrates an x-y sectional view of the active grating 901 in the non-diffraction state. In the embodiment shown in FIGS. 9C and 9F, the gap L between the two neighboring interdigitated electrodes and the thickness D of the active grating 901 may be configured, such that the generated electric field may be an in-plane electric field that is within a plane (e.g., the x-y plane) perpendicular to a thickness direction of the active grating 901. When the voltage is sufficiently high, as shown in FIGS. 9C and 9F, directors of the LC molecules 920 (of LCs having the positive dielectric anisotropy) may be reoriented to be parallel with the electric field direction (e.g., the y-axis direction). Due to the substantial match between the refractive indices no and n_{g}, the H-PDLC grating 901 may function as a substantially optically uniform plate for the input light 930. As shown in FIG. 9C, the H-PDLC grating 901 may operate in a non-diffraction state for the light 930 polarized in the predetermined alignment direction (e.g., the x-axis direction), and may transmit the light 930 therethrough as a light 939 with substantially zero or negligible diffraction.

FIGS. 9A-9C show that the H-PDLC grating 901 includes layers (e.g., three layers) of LC droplets 902 embedded in the polymer matrix 904, and the LC droplets 902 in the same layer may be separated from one another. In some embodiments, although not shown, the LC droplets 902 in the same layer may not be separated from one another. Instead, the LC droplets 902 may be in contact with one another to form a continuous LC layer. Two neighboring LC layers may be separated by the polymer matrix 904. In other words, the active grating 901 may include LC layers and polymer layers alternately arranged. Thus, the scattering of the LC droplets 902 may be reduced and, accordingly, the haze of the H-PDLC grating 901 caused by the scattering of the LC droplets 902 may be reduced.

In the embodiment shown in FIGS. 9A-9E, the H-PDLC grating 901 is configured to operate in the diffraction state when the voltage supplied by the power source 840 is lower than or equal to the threshold voltage, and to operate in the non-diffraction state when the voltage is sufficiently higher than the threshold voltage. In other embodiments, by configuring the initial orientations of the LC molecules 920 differently (e.g., homeotropically aligning LCs having a negative dielectric anisotropy), the H-PDLC grating 901 may be configured to operate in the diffraction state when the voltage supplied by the power source 840 is sufficiently higher than the threshold voltage, and to operate in the non-diffraction state when the voltage supplied by the power source 840 is lower than or equal to the threshold voltage.

In some embodiments, when the active grating 901 is implemented in a light guide display system disclosed herein as an in-coupling grating, an out-coupling grating, or a redirecting grating, the lower substrate 906 may be a light guide or a part of the light guide in a light guide display system disclosed herein. That is, the polymer matrix 904 embedded with the LC droplets 902 may be disposed between the upper substrate 906 (that is provided with the electrode layer 908 and the low refractive index layer 910), and the light guide of the light guide display system. FIG. 9G illustrates an x-z sectional view of the active grating 901 implemented in a light guide display system disclosed herein, such as the light guide display system 200 shown in FIG. 2A, the light guide display system 250 shown in FIG. 2B, the light guide display system 270 shown in FIGS. 2C-2E, the light guide display system 300 shown in FIG. 3A, the light guide display system 350 shown in FIG. 3B, the light guide display system 400 shown in FIGS. 4A and 4B, or the light guide display system 500 shown in FIGS. 5A-5C

For discussion purposes, FIG. 9G shows that the active grating 901 functions as an out-coupling grating in the light guide display system disclosed herein. An input image light output from a light source assembly may be coupled, via an in-coupling element, into the lower substrate 906 (or the light guide 906) as an in-coupled image light (or a TIR propagating image light) 931. The in-coupled image light 931 may propagate toward the active grating 901 (or the out-coupling grating 901) via TIR. When the in-coupled image light 931 interacts with the polymer matrix 904 embedded with the LC droplets 902, the polymer matrix 904 embedded with the LC droplets 902 may diffract a first portion of the in-coupled image light 931 as an output image light 932 out of the active grating 901. A second portion of the in-coupled image light 931 may propagate toward the upper substrate 906 provided with the low refractive index layer 910 and the electrode layer 908. As the refractive index of the low refractive index layer 910 is configured to be less than the average refractive index of the polymer matrix 904 embedded with the LC droplets 902, the second portion of the in-coupled image light 931 may be totally internally reflected at the interface between the polymer matrix 904 embedded with the LC droplets 902 and the low refractive index layer 910 toward the light guide 906. Thus, the second portion of the in-coupled image light 931 may not be incident onto the electrode layer (e.g., ITO electrode layer) 908, and may not be absorbed by the electrode layer 908. Thus, when the in-coupled image light 931 propagating inside the light guide 906 is gradually coupled out of the light guide 906 as the output image lights 932, the absorption of the in-coupled image light 931 caused by the electrode layer (e.g., ITO electrode layer) 908 may be reduced. For illustrative purposes, FIG. 9G shows that the active grating 901 forwardly diffracts the in-coupled image light 931 as the output image light 932. In some embodiments, although not shown, the active grating 901 may backwardly diffract the in-coupled image light 931 as the output image light 932.

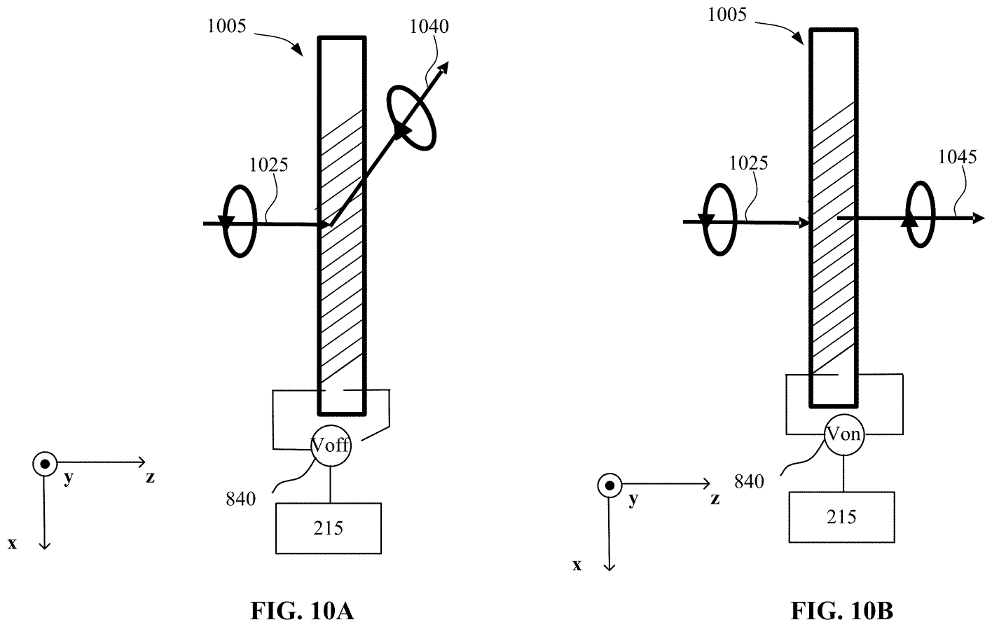

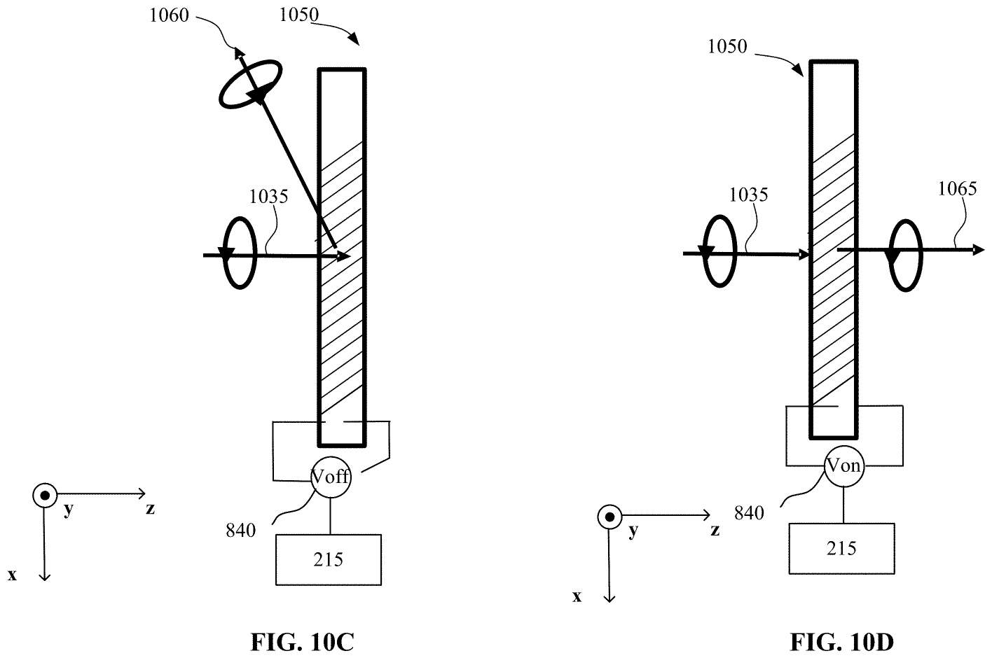

FIGS. 10A-10D illustrate schematic diagrams of liquid crystal polarization hologram (“LCPH”) gratings, according to various embodiments of the present disclosure. Liquid crystal polarization holograms (“LCPHs”) refer to the intersection of liquid crystal devices and polarization holograms. LCPH elements have features such as flatness, compactness, high efficiency, high aperture ratio, absence of on-axis aberrations, flexible design, simple fabrication, and low cost, etc. Thus, LCPH elements can be implemented in various applications such as portable or wearable optical devices or systems. Among LCPH elements, liquid crystal (“LC”) based Pancharatnam-Berry phase (“PBP”) elements and polarization volume hologram (“PVH”) elements have been extensively studied. A PBP element may modulate a circularly polarized light based on a phase profile provided through a geometric phase. A PVH element may modulate a circularly polarized light based on Bragg diffraction.

An LCPH grating (e.g., a PBP grating, a PVH grating, etc.) may be formed by a thin layer of one or more birefringent materials with intrinsic or induced (e.g., photo-induced) optical anisotropy (referred to as an optically anisotropic layer or a birefringent medium layer). A desirable predetermined grating phase profile may be directly encoded into local orientations of the optic axis of the birefringent medium layer. An LCPH grating described herein may be fabricated based on various methods, such as holographic interference, laser direct writing, ink-jet printing, and various other forms of lithography. Thus, a “hologram” described herein is not limited to creation by holographic interference, or “holography.”

An LCPH grating may be switchable between a diffraction state and a non-diffraction state. In some embodiments, an LCPH grating operating in the diffraction state may provide a tunable diffraction angle to an incident light. An LCPH grating may be transmissive or reflective. An LCPH grating may be polarization selective or polarization non-selective. An LCPH grating may be implemented into a light guide display system disclosed herein as an in-coupling grating, an out-coupling grating, or a redirecting grating.

FIGS. 10A and 10B illustrate schematic diagrams a transmissive-type LCPH grating 1005 in a diffraction state and a non-diffraction state, respectively, according to an embodiment of the present disclosure. For discussion purposes, the LCPH grating 1005 is polarization selective. As shown in FIGS. 10A and 10B, the power source 840 may be electrically coupled with the LCPH grating 1005 to provide an electric field to the LCPH grating 1005. The controller 215 may be electrically coupled (e.g., through wired or wireless connection) with the power source 840, to control an output (e.g., a voltage and/or current) of the power source 840. For example, by controlling the voltage output by the power source 840, the controller 215 may control the switching of the LCPH grating 1005 between the diffraction state and the non-diffraction state.

In some embodiments, the controller 215 may control the LCPH grating 1005 to operate in the diffraction state by controlling a voltage supplied by the power source 840 to be lower than or equal to a threshold voltage. When the voltage is lower than or equal to the threshold voltage, the electric field generated by the supplied voltage may be insufficient to reorient the LC molecules in the LCPH grating 1005. As shown in FIG. 10A, the LCPH grating 1005 that operates in the diffraction state may substantially forwardly diffract an incident light 1035 with a predetermined polarization (e.g., a circularly polarized light with a predetermined handedness) as a light of a predetermined order, such as, a +1^{st} order diffracted light 1040. In some embodiments, the polarization of the diffracted light 1040 may be opposite or orthogonal to the polarization of the incident light 1035. For example, the diffracted light 1040 may be a circularly polarized light with handedness that is opposite or orthogonal to the predetermined handedness. In some embodiments, when the LCPH grating 1005 operates in the diffraction state, the controller 215 may adjust the voltage supplied by the power source 840 to adjust the diffraction angle of the diffracted light 1040. For example, as the voltage supplied by the power source 840 increases, the grating period of the LCPH grating 1005 may increase, and the diffraction angle of the diffracted light 1040 may decrease.

In some embodiments, the controller 215 may control the LCPH grating 1005 to operate in the non-diffraction state by controlling the supplied voltage to be higher than the threshold voltage (and sufficiently high) to reorient the LC molecules LCPH grating 1005 to be parallel with the direction of the electric field. As shown in FIG. 10B, the LCPH grating 1005 operating in the non-diffraction state may substantially transmit the incident light 1035 as a light 1045, with negligible or zero diffraction. In some embodiments, transmission of the incident light 1035 as the transmitted light 1045 may be polarization independent. In some embodiments, the LCPH grating 1005 may transmit the incident light 1035 without affecting the polarization thereof. For example, the incident light 1035 and the transmitted light 1045 may have the same polarization. For example, the incident light 1035 and the transmitted light 1045 may be circular polarized lights with the same handedness. In some embodiments, the LCPH grating 1005 may change the polarization of the incident light 1035, while transmitting the incident light 1035. For example, the incident light 1035 and the transmitted light 1045 may be circular polarized lights with opposite handednesses.

FIGS. 10C and 10D illustrate schematic diagrams a reflective-type LCPH grating 1050 in a diffraction state and a non-diffraction state, respectively, according to an embodiment of the present disclosure. For discussion purposes, the LCPH grating 1050 is presumed to be polarization selective. As shown in FIGS. 10C and 10D, the power source 840 may be electrically coupled with the LCPH grating 1050 to provide an electric field to the LCPH grating 1050. The controller 215 may be electrically coupled (e.g., through wired or wireless connection) with the power source 840, to control an output (e.g., a voltage and/or current) of the power source 840. For example, by controlling the voltage output by the power source 840, the controller 215 may control the switching of the LCPH grating 1050 between the diffraction state and the non-diffraction state.

In some embodiments, the controller 215 may configure the LCPH grating 1050 to operate in the diffraction state by controlling a voltage supplied by the power source 840 to be lower than or equal to a threshold voltage. When the voltage is lower than or equal to the threshold voltage, the electric field generated by the supplied voltage may be insufficient to reorient the LC molecules in the LCPH grating 1050. As shown in FIG. 10C, the LCPH grating 1050 operating in the diffraction state may substantially backwardly diffract an incident light 1035 with a predetermined polarization (e.g., a circularly polarized light with a predetermined handedness) as a light of a predetermined order, such as, a +1^{st} order diffracted light 1060. In some embodiments, the diffracted light 1060 and the incident light 1035 may have the same polarization. For example, the diffracted light 1060 and the incident light 1035 may be circular polarized lights with the same handedness. In some embodiments, when the LCPH grating 1050 operates in the diffraction state, the controller 215 may adjust the voltage supplied by the power source 840 to adjust the diffraction angle of the diffracted light 1060. For example, as the voltage supplied by the power source 840 increases, the grating period of the LCPH grating 1050 may increase, and the diffraction angle of the diffracted light 1060 may decrease.

In some embodiments, the controller 215 may control the LCPH grating 1050 to operate in the non-diffraction state by controlling the supplied voltage to be higher than the threshold voltage (and sufficiently high) to reorient the LC molecules LCPH grating 1050 to be parallel with the direction of the electric field. As shown in FIG. 10D, the LCPH grating 1050 operating in the non-diffraction state may substantially transmit the incident light 1035 as a light 1065, with negligible or zero diffraction. In some embodiments, the LCPH grating 1050 operating in the non-diffraction state may substantially transmit the incident light 1035 as the transmitted light 1065. The transmission of the incident light 1035 as the light 1065 may be independent of the polarization of the incident light 1035. In some embodiments, the LCPH grating 1050 may transmit the incident light 1035 without affecting the polarization thereof. For example, the incident light 1035 and the transmitted light 1065 may be circular polarized lights with the same handedness. In some embodiments, the LCPH grating 1050 may change the polarization of the incident light 1035, while transmitting the incident light 1035. In some embodiments, the incident light 1035 and the transmitted light 1065 may have opposite or orthogonal polarizations. For example, the incident light 1035 and the transmitted light 1065 may be circular polarized lights with opposite handednesses.

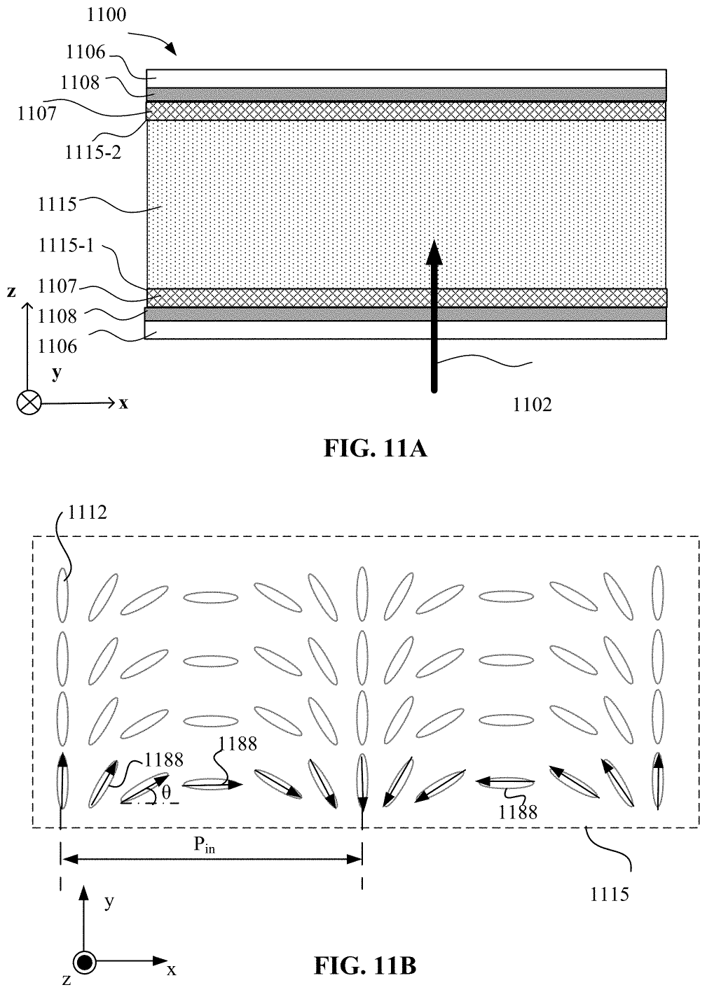

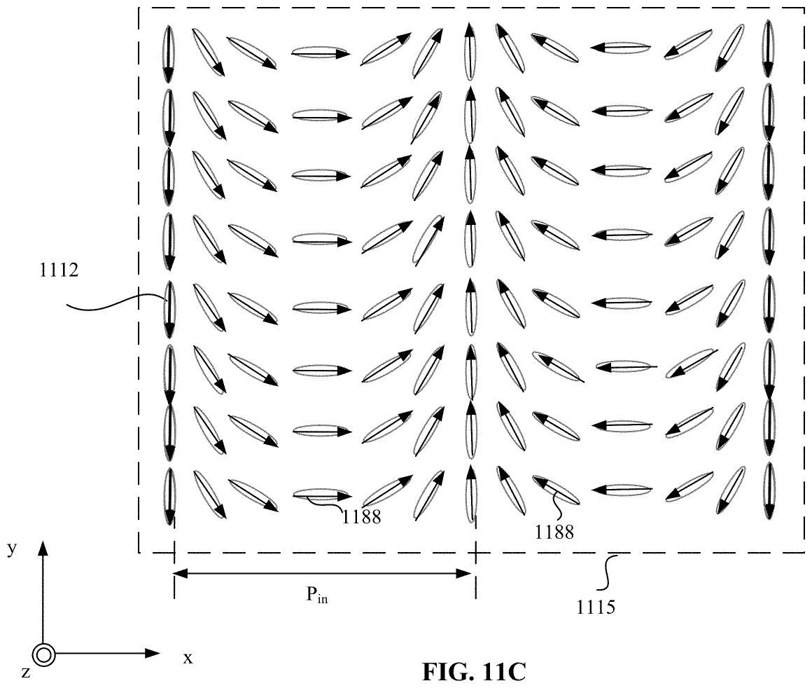

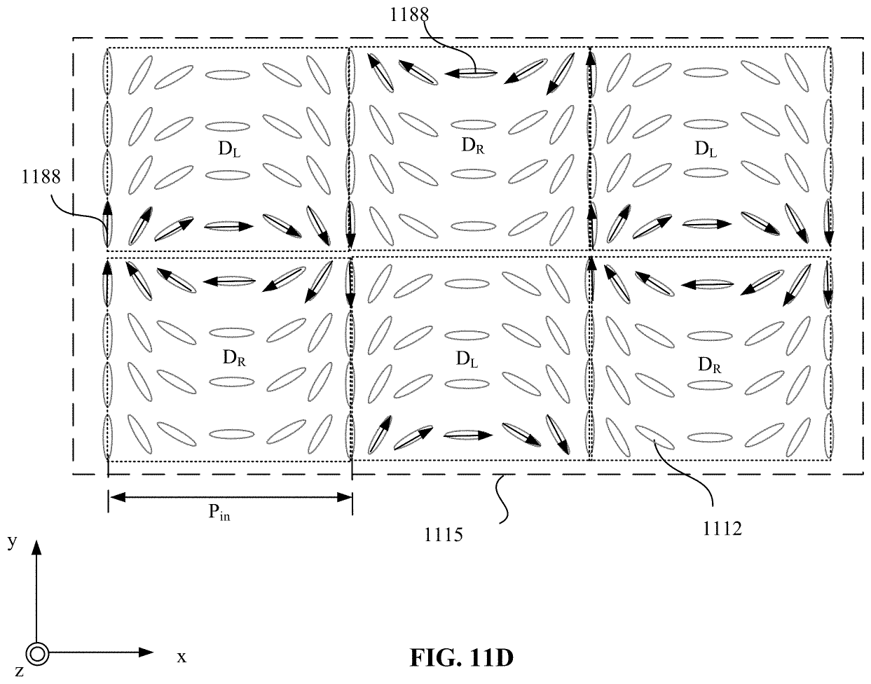

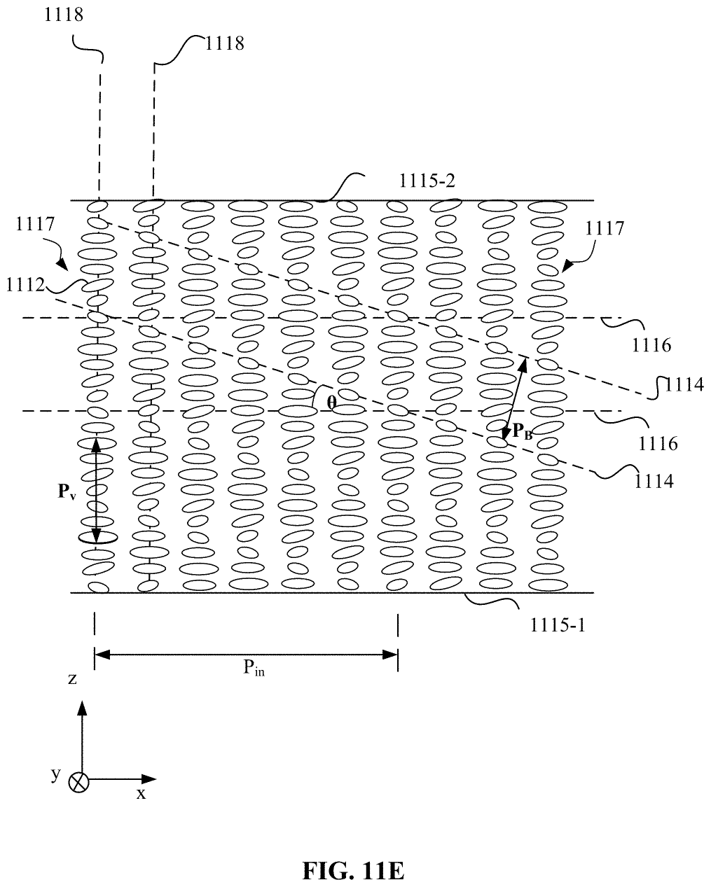

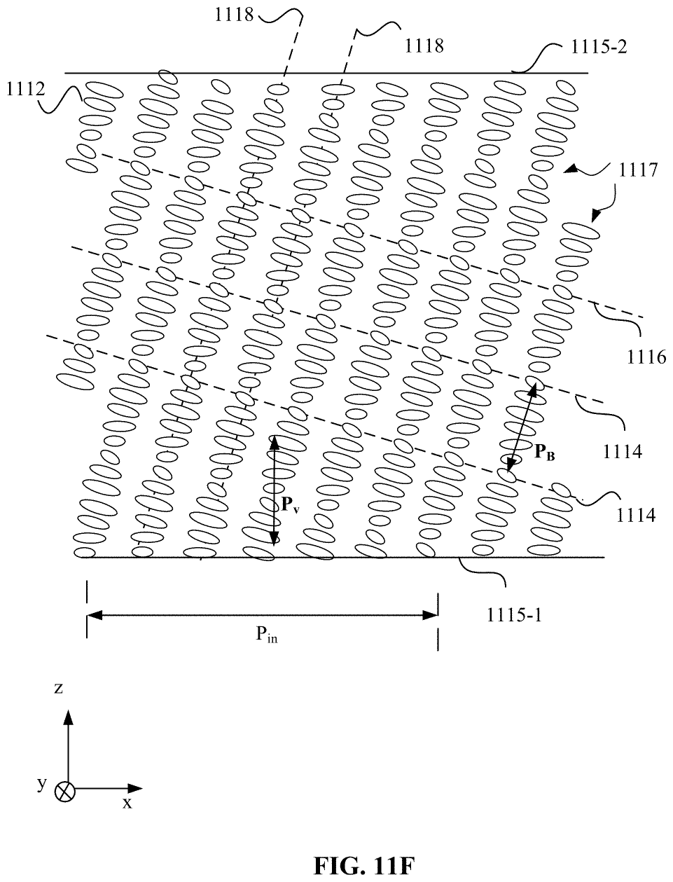

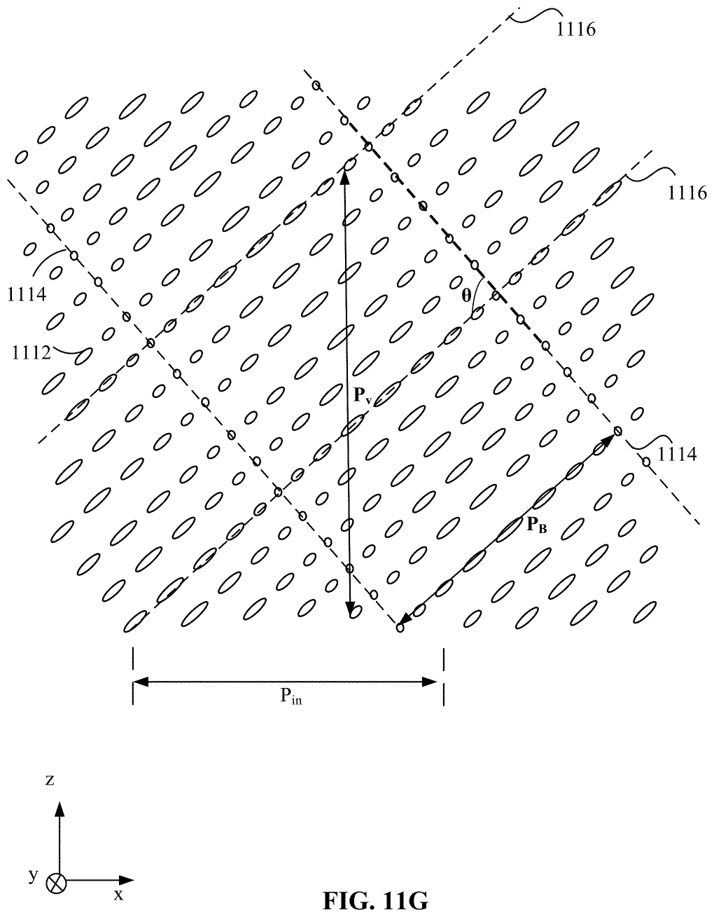

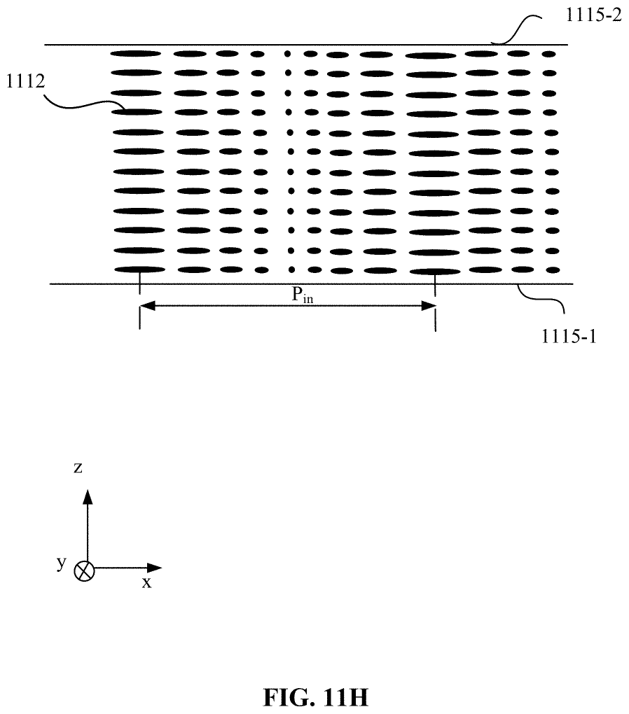

FIG. 11A illustrates an x-z sectional view of a liquid crystal polarization hologram (“LCPH”) element 1100 with a light 1102 incident onto the LCPH element 1100 along a −z-axis, according to an embodiment of the present disclosure. FIGS. 11B-11D schematically illustrate various views of a portion of the LCPH element 1100 shown in FIG. 11A, showing in-plane orientations of optically anisotropic molecules in the LCPH element 1100, according to various embodiments of the present disclosure. FIGS. 11E-11H schematically illustrate various views of a portion of the LCPH element 1100 shown in FIG. 11A, showing out-of-plane orientations of optically anisotropic molecules in the LCPH element 1100, according to various embodiments of the present disclosure. The LCPH element 1100 may be an active LCPH grating, such as the LCPH grating 1005 shown in FIGS. 10A and 10B, or the LCPH grating 1050 shown in FIGS. 10C and 10D.

As shown in FIG. 11A, although the LCPH element 1100 is shown as a rectangular plate shape for illustrative purposes, the LCPH element 1100 may have any suitable shape, such as a circular shape. In some embodiments, one or both surfaces along the light propagating path of the light 1102 may have curved shapes. The LCPH element 1100 may include two opposite substrates 1106, and a thin layer (or film) 1115 of one or more birefringent materials disposed between the two substrates 1106. The one or more birefringent materials may have an intrinsic or induced (e.g., photo-induced) optical anisotropy, such as liquid crystals, liquid crystal polymers, amorphous polymers. Such a thin layer 1115 may also be referred to as a birefringent medium layer (or film) 1115, or an LCPH layer (or film) 1115. In some embodiments, the birefringent medium layer 1115 may include active LCs, such as nematic LCs, twist-bend LCs, chiral nematic LCs, smectic LCs, or any combination thereof.

In some embodiments, at least one (e.g., each) of the two substrates 1106 may be provided with an alignment structure 1107. The alignment structure 1107 may provide a suitable alignment pattern to optically anisotropic molecules in the birefringent medium layer 1115. The alignment pattern may correspond to a predetermined in-plane orientation pattern, such as an in-plane orientation pattern with periodic linear orientations. The alignment structure 1107 may include a suitable alignment structure, such as a photo-alignment material (“PAM”) layer, a mechanically rubbed alignment layer, an alignment layer with anisotropic nanoimprint, an anisotropic relief, or a ferroelectric or ferromagnetic material layer, etc.

In some embodiments, at least one (e.g., each) of the two substrates 1106 may be provided with a transparent conductive electrode layer (e.g., ITO electrode) layer 1108. One or more power sources (not shown) may be electrically coupled with the LCPH element 1100. The one or more power sources may provide one or more electric fields to the LCPH element 1100 via the electrode layer 1108. In some embodiments, the LCPH element 1100 may include two electrode layers 1108, and a power source may provide an electric field to the LCPH element 1100 via the two electrode layers 1108. In some embodiments, the two electrode layers 1108 may be disposed at the two substrates 1106, respectively. In some embodiments, both of the two electrode layers 1108 may include planar continuous electrodes. In some embodiments, both of the two electrode layers 1108 may include patterned electrodes, e.g., slit electrodes. In some embodiments, one of the two electrode layers 1108 may include a planar continuous electrode, and the other one of the two electrode layers 1108 may include patterned electrodes, e.g., slit electrodes.

In some embodiments, each electrode layer 1108 may include two sub-electrode layers, and an electrically insulating layer disposed between the two sub-electrode layers. A respective power source may be electrically coupled with the two sub-electrode layers in each electrode layer 1108, thereby providing a respective electric field to the LCPH element 1100. In some embodiments, the two sub-electrode layers may include a planar continuous electrode and patterned electrodes.

The birefringent medium layer 1115 may have a first surface 1115-1 on one side and a second surface 1115-2 on an opposite side. The first surface 1115-1 and the second surface 1115-2 may be surfaces along the light propagating path of the incident light 1102. The birefringent medium layer 1115 may include optically anisotropic molecules (e.g., LC molecules) configured with a three-dimensional (“3D”) orientational pattern to provide a polarization selective optical response. In some embodiments, an optic axis of the LC material or birefringent medium layer 1115 may be configured with a spatially varying orientation in at least one in-plane direction. The in-plane direction may be an in-plane linear direction (e.g., an x-axis direction, a y-axis direction), an in-plane radial direction, an in-plane circumferential (e.g., azimuthal) direction, or a combination thereof. The LC molecules may be configured with an in-plane orientation pattern, in which the directors of the LC molecules may periodically or non-periodically vary in the at least one in-plane direction. In some embodiments, the optic axis of the LC material may also be configured with a spatially varying orientation in an out-of-plane direction. The directors of the LC molecules may also be configured with spatially varying orientations in an out-of-plane direction. For example, the optic axis of the LC material (or directors of the LC molecules) may twist in a helical fashion in the out-of-plane direction.

FIGS. 11B-11D schematically illustrate x-y sectional views of a portion of the LCPH element 1100 shown in FIG. 11A, showing in-plane orientations of the optically anisotropic molecules 1112 in the LCPH element 1100, according to various embodiments of the present disclosure. The in-plane orientations of the optically anisotropic molecules 1112 in the LCPH element 1100 shown in FIGS. 11B-11D are for illustrative purposes. In some embodiments, the optically anisotropic molecules 1112 in the LCPH element 1100 may have other in-plane orientation patterns. For discussion purposes, rod-like LC molecules 1112 are used as examples of the optically anisotropic molecules 1112. The rod-like LC molecule 1112 may have a longitudinal axis (or an axis in the length direction) and a lateral axis (or an axis in the width direction). The longitudinal axis of the LC molecule 1112 may be referred to as a director of the LC molecule 1112 or an LC director. An orientation of the LC director may determine a local optic axis orientation or an orientation of the optic axis at a local point of the birefringent medium layer 1115. The term “optic axis” may refer to a direction in a crystal. A light propagating in the optic axis direction may not experience birefringence (or double refraction). An optic axis may be a direction rather than a single line: lights that are parallel with that direction may experience no birefringence. The local optic axis may refer to an optic axis within a predetermined region of a crystal. For illustrative purposes, the LC directors of the LC molecules 1112 shown in FIGS. 11B-11D are presumed to be in the surface of the birefringent medium layer 1115 or in a plane parallel with the surface with substantially small tilt angles with respect to the surface.

FIG. 11B schematically illustrates an x-y sectional view of a portion of the LCPH element 1100, showing a periodic in-plane orientation pattern of the orientations of the LC directors (indicated by arrows 1188 in FIG. 11B) of the LC molecules 1112 located in a film plane of the birefringent medium layer 1115, e.g., a plane parallel with at least one of the first surface 1115-1 or the second surface 1115-2. The film plane may be perpendicular to the thickness direction of the birefringent medium layer 1115. The orientations of the LC directors located in the film plane of the birefringent medium layer 1115 may exhibit a periodic rotation in at least one in-plane direction. The at least one in-plane direction is shown as the x-axis direction in FIG. 11B. The periodically varying in-plane orientations of the LC directors form a pattern. The in-plane orientation pattern of the LC directors shown in FIG. 11B may also be referred to as an in-plane grating pattern. Accordingly, the LCPH element 1100 may function as a polarization selective grating, e.g., a PVH grating, or a PBP grating, etc.

As shown in FIG. 11B, the LC molecules 1112 located in the film plane of the birefringent medium layer 1115 may be configured with orientations of LC directors continuously changing (e.g., rotating) in a first predetermined in-plane direction in the film plane. The first predetermined in-plane direction is the shown as the x-axis in-plane direction. The continuous rotation exhibited in the orientations of the LC directors may follow a periodic rotation pattern with a uniform (e.g., same) in-plane pitch Pᵢₙ. It is noted that the first predetermined in-plane direction may be any other suitable direction in the film plane of the birefringent medium layer 1115, such as the y-axis direction, the radial direction, or the circumferential direction within the x-y plane. The pitch Pᵢₙ along the first predetermined (or x-axis) in-plane direction may be referred to as an in-plane pitch or a horizontal pitch. In some embodiments, the in-plane pitch or a horizontal pitch Pᵢₙ may be tunable through adjusting a voltage applied to the LCPH element 1100. In some embodiments, the in-plane pitch or the horizontal pitch Pᵢₙ may be referred to as the grating period of the LCPH element 1100.

For simplicity of illustration and discussion, the LCPH element 1100 shown in FIG. 11B is presumed to be a 1D grating. Thus, the orientations in the y-axis direction are the same. In some embodiments, the LCPH element 1100 may be a 2D grating, and the orientations in the y-axis direction may also vary. The pattern with the uniform (or same) in-plane pitch Pᵢₙ may be referred to as a periodic LC director in-plane orientation pattern. The in-plane pitch Pᵢₙ may be defined as a distance along the first predetermined (or x-axis) in-plane direction over which the orientations of the LC directors exhibit a rotation by a predetermined value (e.g., 180°). In other words, in the film plane of the birefringent medium layer 1115, local optic axis orientations of the birefringent medium layer 1115 may vary periodically in the first predetermined (or x-axis) in-plane direction with a pattern having the uniform (or same) in-plane pitch Pᵢₙ.

In addition, in the film plane of the birefringent medium layer 1115, the orientations of the directors of the LC molecules 1112 may exhibit a rotation in a predetermined rotation direction, e.g., a clockwise direction or a counter-clockwise direction. Accordingly, the rotation exhibited in the orientations of the directors of the LC molecules 1112 in the film plane of the birefringent medium layer 1115 may exhibit a handedness, e.g., right handedness or left handedness. In the embodiment shown in FIG. 11B, in the film plane of the birefringent medium layer 1115, the orientations of the directors of the LC molecules 1112 may exhibit a rotation in a clockwise direction. Accordingly, the rotation of the orientations of the directors of the LC molecules 1112 in the film plane of the birefringent medium layer 1115 may exhibit a left handedness. In some embodiments, the LCPH element 1100 having the in-plane orientation pattern shown in FIG. 11B may be polarization selective.

In the embodiment shown in FIG. 11C, in the film plane of the birefringent medium layer 1115, the orientations of the directors of the LC molecules 1112 may exhibit a rotation in a counter-clockwise direction. Accordingly, the rotation exhibited in the orientations of the directors of the LC molecules 1112 the film plane of the birefringent medium layer 1115 may exhibit a right handedness. In some embodiments, the LCPH element 1100 having the in-plane orientation pattern shown in FIG. 11C may be polarization selective.

In the embodiment shown in FIG. 11D, in the film plane of the birefringent medium layer 1115, domains in which the orientations of the directors of the LC molecules 1112 exhibit a rotation in a clockwise direction (referred to as domains DL) and domains in which the orientations of the directors of the LC molecules 1112 exhibit a rotation in a counter-clockwise direction (referred to as domains DR) may be alternatingly arranged in at least one in-plane direction, e.g., a first (or x-axis) in-plane direction and/or a second (or y-axis) in-plane direction. In some embodiments, the LCPH element 1100 having the in-plane orientation pattern shown in FIG. 11D may be polarization non-selective.

FIGS. 11E-11H schematically illustrate y-z sectional views of a portion of the LCPH element 1100, showing out-of-plane orientations of the LC directors of the LC molecules 1112 in the LCPH element 1100, according to various embodiments of the present disclosure. The term “out-of-plane” means that a direction or orientation is not parallel with or within the film plane. Rather, the direction or orientation forms an angle with the film plane. In some embodiments, when the angle is 90°, the out-of-plane direction or orientation may be in the thickness direction of the LCPH element 1100. For discussion purposes, FIGS. 11E-11H schematically illustrate out-of-plane (e.g., along z-axis direction) orientations of the LC directors of the LC molecules 1112 when the in-plane orientation pattern is a periodic in-plane orientation pattern shown in FIG. 11B. As shown in FIG. 11E, within a volume of the birefringent medium layer 1115, the LC molecules 1112 may be arranged in a plurality of helical structures 1117 with a plurality of helical axes 1118 and a helical pitch Pₕ along the helical axes. The azimuthal angles of the LC molecules 1112 arranged along a single helical structure 1117 may continuously vary around a helical axis 1118 in a predetermined rotation direction, e.g., clockwise direction or counter-clockwise direction. In other words, the orientations of the LC directors of the LC molecules 1112 arranged along a single helical structure 1117 may exhibit a continuous rotation around the helical axis 1118 in a predetermined rotation direction. That is, the azimuthal angles associated of the LC directors may exhibit a continuous change around the helical axis in the predetermined rotation direction. Accordingly, the helical structure 1117 may exhibit a handedness, e.g., right handedness or left handedness. The helical pitch Pₕ may be defined as a distance along the helical axis 1118 over which the orientations of the LC directors exhibit a rotation around the helical axis 1118 by 360°, or the azimuthal angles of the LC molecules vary by 360°.

In the embodiment shown in FIG. 11E, the helical axes 1118 may be substantially perpendicular to the first surface 1115-1 and/or the second surface 1115-2 of the birefringent medium layer 1115. In other words, the helical axes 1118 of the helical structures 1117 may extend in a thickness direction (e.g., a z-axis direction) of the birefringent medium layer 1115. That is, the LC molecules 1112 may have substantially small tilt angles (including zero degree tilt angles), and the LC directors of the LC molecules 1112 may be substantially orthogonal to the helical axis 1118. The birefringent medium layer 1115 may have a vertical pitch Pᵥ, which may be defined as a distance along the thickness direction of the birefringent medium layer 1115 over which the orientations of the LC directors of the LC molecules 1112 exhibit a rotation around the helical axis 1118 by 180° (or the azimuthal angles of the LC directors vary by 180°). In the embodiment shown in FIG. 11E, the vertical pitch Pᵥ may be half of the helical pitch Pₕ.

As shown in FIG. 11E, the LC molecules 1112 from the plurality of helical structures 1117 having a first same orientation (e.g., same tilt angle and azimuthal angle) may form a first series of parallel refractive index planes 1114 periodically distributed within the volume of the birefringent medium layer 1115. Although not labeled, the LC molecules 1112 with a second same orientation (e.g., same tilt angle and azimuthal angle) different from the first same orientation may form a second series of parallel refractive index planes periodically distributed within the volume of the birefringent medium layer 1115. Different series of parallel refractive index planes may be formed by the LC molecules 1112 having different orientations. In the same series of parallel and periodically distributed refractive index planes 1114, the LC molecules 1112 may have the same orientation and the refractive index may be the same. Different series of refractive index planes 1114 may correspond to different refractive indices. When the number of the refractive index planes 1114 (or the thickness of the birefringent medium layer) increases to a sufficient value, Bragg diffraction may be established according to the principles of volume gratings. Thus, the periodically distributed refractive index planes 1114 may also be referred to as Bragg planes 1114. In some embodiments, as shown in FIG. 11E, the refractive index planes 1114 may be slanted with respect to the first surface 1115-1 or the second surface 1115-2. In some embodiments, the refractive index planes 1114 may be perpendicular to or parallel with the first surface 1115-1 or the second surface 1115-2. Within the birefringent medium layer 1115, there may exist different series of Bragg planes. A distance (or a period) between adjacent Bragg planes 1114 of the same series may be referred to as a Bragg period PB. The different series of Bragg planes formed within the volume of the birefringent medium layer 1115 may produce a varying refractive index profile that is periodically distributed in the volume of the birefringent medium layer 1115. The birefringent medium layer 1115 may diffract an input light satisfying a Bragg condition through Bragg diffraction.

As shown in FIG. 11E, the birefringent medium layer 1115 may also include a plurality of LC molecule director planes (or molecule director planes) 1116 arranged in parallel with one another within the volume of the birefringent medium layer 1115. An LC molecule director plane (or an LC director plane) 1116 may be a plane formed by or including the LC directors of the LC molecules 1112. In the example shown in FIG. 11E, the LC directors in the LC director plane 1116 have different orientations, i.e., the orientations of the LC directors vary in the x-axis direction. The Bragg plane 1114 may form an angle θ with respect to the LC molecule director plane 1116. In the embodiment shown in FIG. 11E, the angle θ may be an acute angle, e.g., 0°<θ<90°. The LCPH element 1100 including the birefringent medium layer 1115 shown in FIG. 11B may function as a transmissive PVH element, e.g., a transmissive PVH grating.

In the embodiment shown in FIG. 11F, the helical axes 1118 of helical structures 1117 may be tilted with respect to the first surface 1115-1 and/or the second surface 1115-2 of the birefringent medium layer 1115 (or with respect to the thickness direction of the birefringent medium layer 1115). For example, the helical axes 1118 of the helical structures 1117 may have an acute angle or obtuse angle with respect to the first surface 1115-1 and/or the second surface 1115-2 of the birefringent medium layer 1115. In some embodiments, the LC directors of the LC molecule 1112 may be substantially orthogonal to the helical axes 1118 (i.e., the tilt angle may be substantially zero degree). In some embodiments, the LC directors of the LC molecule 1112 may be tilted with respect to the helical axes 1118 at an acute angle. The birefringent medium layer 1115 may have a vertical periodicity (or pitch) Pᵥ. In the embodiment shown in FIG. 11F, an angle θ (not shown) between the LC director plane 1116 and the Bragg plane 1114 may be substantially 0° or 180°. That is, the LC director plane 1116 may be substantially parallel with the Bragg plane 1114. In the example shown in FIG. 11F, the orientations of the directors in the molecule director plane 1116 may be substantially the same. The LCPH element 1100 including the birefringent medium layer 1115 shown in FIG. 11F may function as a reflective PVH element, e.g., a reflective PVH grating.

In the embodiment shown in FIG. 11G, the birefringent medium layer 1115 may also include a plurality of LC director planes 1116 arranged in parallel within the volume of the birefringent medium layer 1115. In the embodiment shown in FIG. 11F, an angle θ between the LC director plane 1116 and the Bragg plane 1114 may be a substantially right angle, e.g., θ=90°. That is, the LC director plane 1116 may be substantially orthogonal to the Bragg plane 1114. In the example shown in FIG. 11F, the LC directors in the LC director plane 1116 may have different orientations. In some embodiments, the LCPH element 1100 including the birefringent medium layer 1115 shown in FIG. 11F may function as a transmissive PVH element, e.g., a transmissive PVH grating.

In the embodiment shown in FIG. 11H, in a volume of the birefringent medium layer 1115, along the thickness direction (e.g., the z-axis direction) of the birefringent medium layer 1115, the directors (or the azimuth angles) of the LC molecules 1112 may remain in the same orientation (or same angle value) from the first surface 1115-1 to the second surface 1115-2 of the birefringent medium layer 1115. In some embodiments, the thickness of the birefringent medium layer 1115 may be configured as d=λ/(2*Δn), where λ is a design wavelength, Δn is the birefringence of the LC material of the birefringent medium layer 1115, and Δn=nₑ−nₒ, where no and nₒ are the extraordinary and ordinary refractive indices of the LC material, respectively. In some embodiments, the LCPH element 1100 including the birefringent medium layer 1115 shown in FIG. 11F may function as a PBP element, e.g., a PBP grating.

In some embodiments, the present disclosure provides a device that includes a light guide. The device also includes an in-coupling element coupled with the light guide and configured to couple a first image light into the light guide as a second image light propagating inside the light guide via total internal reflection (“TIR”), and to couple a portion of the second image light out of the light guide as a third image light. The device further includes a recycling element coupled with the light guide and configured to couple the third image light back into the light guide as a fourth image light propagating inside the light guide via TIR.

In some embodiments, the portion of the second image light that is coupled, via the in-coupling element, out of the light guide as the third image light is a first portion of the second image light. A second portion of the second image light propagates inside the light guide via TIR. In some embodiments, the fourth image light and the second portion of the second image light have a same TIR propagation angle inside the light guide. In some embodiments, the device further includes an out-coupling element coupled with the light guide, and configured to couple the fourth image light and the second portion of the second image light having the same TIR propagation angle out of the light guide to form a same image.

In some embodiments, the in-coupling element includes an in-coupling grating configured to diffract the portion of the second image light out of the light guide as the third image light. In some embodiments, the recycling element includes a recycling grating configured to diffract the third image light back into the light guide as the fourth image light. In some embodiments, the recycling element includes a recycling grating configured to diffract the third image light as a fifth image light toward an interface between the recycling grating and an outside environment, wherein the fifth image light is reflected at the interface as the fourth image light. In some embodiments, the recycling element and the in-coupling element are disposed at opposite surfaces of the light guide.

In some embodiments, the present disclosure provides a device that includes a light guide. The device also includes an in-coupling grating coupled with the light guide and configured to couple, via diffraction, a first image light having a first polarization into the light guide as a second image light propagating inside the light guide via total internal reflection (“TIR”). The device also includes a retardation film coupled with the light guide and configured to convert the second image light incident thereon as a third image light having a second polarization that is orthogonal to the first polarization. The in-coupling grating is configured to enable the third image light having the second polarization to propagate inside the light guide via TIR as a fourth image light. In some embodiments, the second image light and the fourth image light have a same TIR propagation angle inside the light guide. In some embodiments, the in-coupling grating includes a polarization volume hologram grating configured to diffract a circularly polarized light when the circularly polarized light has a first handedness, and transmit the circularly polarized light when the circularly polarized light has a second handedness that is orthogonal to the first handedness. In some embodiments, the in-coupling grating and the retardation film are disposed at opposite surfaces of the light guide. In some embodiments, the in-coupling grating is disposed between the retardation film and the light guide.

In some embodiments, the present disclosure provides a device including a light guide. The device also includes an in-coupling element coupled with the light guide and configured to couple a first image light into the light guide as a second image light. The device also includes an out-coupling element coupled with the light guide and including a plurality of out-coupling gratings configured to be selectively activated to couple the second image light out of the light guide. The device also includes at least one redirecting element coupled with the light guide. The device further includes a controller configured to control the in-coupling element to selectively direct the second image light to propagate in one of a plurality of selectable directions inside the light guide. The at least one redirecting element is configured to redirect the second image light when the second image light is received from the in-coupling element, to propagate toward a predetermined portion of the out-coupling element.

In some embodiments, the predetermined portion of the out-coupling element is a first portion of the out-coupling element. In some embodiments, the plurality of selectable directions include a first direction toward one of the at least one redirecting element, and a second direction directly toward a second portion of the out-coupling element. In some embodiments, the controller is configured to control the in-coupling element to direct the second image light to propagate in the first direction toward one of the at least one redirecting element, or in the second direction directly toward the second portion the out-coupling element. In some embodiments, the at least one redirecting element is configured to diffract the second image light propagating in the first direction as a third image light propagating toward the first portion of the out-coupling element via total internal reflection (“TIR”). In some embodiments, the third image light have a same TIR propagation angle inside the light guide as the second image light propagating in the second direction toward the second portion of the out-coupling element.

In some embodiments, the at least one redirecting element includes a plurality of redirecting elements coupled with the light guide at different positions, and the plurality of selectable directions include directions from the in-coupling element to the plurality of redirecting elements. In some embodiments, the controller is configured to control the in-coupling element to direct the second image light to propagate in a direction selected from the plurality of selectable directions toward one of the plurality of redirecting elements. In some embodiments, the one of the plurality of redirecting elements is configured to redirect the second image light to propagate toward the predetermined portion of the out-coupling element. In some embodiments, the plurality of redirecting elements are configured to redirect the second image light to propagate toward different predetermined portions of the out-coupling element. In some embodiments, the device further includes a retardation film coupled with the light guide and configured to convert a polarization of the second image light incident thereon. In some embodiments, the device further includes a recycling element coupled with the light guide and configured to recycle a portion of the second image light that is coupled out of the light guide by the in-coupling element.

In some embodiments, the present disclosure provides a device including a light guide. The device also includes an in-coupling grating coupled with the light guide and configured to couple, via diffraction, a first image light having a first polarization into the light guide as a second image light propagating inside the light guide via total internal reflection (“TIR”). The device also includes a retardation film coupled with the light guide and configured to convert the second image light incident thereon as a third image light having a predetermined polarization. The in-coupling grating is configured to reflect the third image light propagating through a volume of the in-coupling grating at a surface of the in-coupling grating as a fourth image light having a second polarization that is orthogonal to the first polarization. The volume of the in-coupling grating is configured to transmit the fourth image light having the second polarization as a fifth image light propagating inside the light guide via TIR.

The foregoing description of the embodiments of the present disclosure have been presented for the purpose of illustration. It is not intended to be exhaustive or to limit the disclosure to the precise forms disclosed. Persons skilled in the relevant art can appreciate that modifications and variations are possible in light of the above disclosure.

Some portions of this description may describe the embodiments of the present disclosure in terms of algorithms and symbolic representations of operations on information. These operations, while described functionally, computationally, or logically, may be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Embodiments of the present disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Embodiments of the present disclosure may also relate to a product that is produced by a computing process described herein. Such a product may include information resulting from a computing process, where the information is stored on a non-transitory, tangible computer readable storage medium and may include any embodiment of a computer program product or other data combination described herein.

Further, when an embodiment illustrated in a drawing shows a single element, it is understood that the embodiment or an embodiment not shown in the figures but within the scope of the present disclosure may include a plurality of such elements. Likewise, when an embodiment illustrated in a drawing shows a plurality of such elements, it is understood that the embodiment or an embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
a light guide;
an in-coupling element coupled with the light guide and configured to couple a first image light into the light guide as a second image light propagating inside the light guide via total internal reflection (“TIR”), and to couple a portion of the second image light out of the light guide as a third image light; and
a recycling element coupled with the light guide and configured to couple the third image light back into the light guide as a fourth image light propagating inside the light guide via TIR.

2. The device of claim 1, wherein
the portion of the second image light that is coupled, via the in-coupling element, out of the light guide as the third image light is a first portion of the second image light, and
a second portion of the second image light propagates inside the light guide via TIR.

3. The device of claim 2, wherein the fourth image light and the second portion of the second image light have a same TIR propagation angle inside the light guide.

4. The device of claim 3, further comprising an out-coupling element coupled with the light guide, and configured to couple the fourth image light and the second portion of the second image light having the same TIR propagation angle out of the light guide to form a same image.

5. The device of claim 1, wherein the in-coupling element includes an in-coupling grating configured to diffract the portion of the second image light out of the light guide as the third image light.

6. The device of claim 1, wherein the recycling element includes a recycling grating configured to diffract the third image light back into the light guide as the fourth image light.

7. The device of claim 1, wherein the recycling element includes a recycling grating configured to diffract the third image light as a fifth image light toward an interface between the recycling grating and an outside environment, wherein the fifth image light is reflected at the interface as the fourth image light.

8. The device of claim 1, wherein the recycling element and the in-coupling element are disposed at opposite surfaces of the light guide.

9. A device, comprising:
a light guide;
an in-coupling grating coupled with the light guide and configured to couple, via diffraction, a first image light having a first polarization into the light guide as a second image light propagating inside the light guide via total internal reflection (“TIR”); and
a retardation film coupled with the light guide and configured to convert the second image light incident thereon as a third image light having a second polarization that is orthogonal to the first polarization,
wherein the in-coupling grating is configured to receive the third image light having the second polarization from the retardation film and enable the third image light to propagate inside the light guide via TIR as a fourth image light.

10. The device of claim 9, wherein the second image light and the fourth image light have a same TIR propagation angle inside the light guide.

11. The device of claim 9, wherein the in-coupling grating includes a polarization volume hologram grating configured to diffract a circularly polarized light when the circularly polarized light has a first handedness, and transmit the circularly polarized light when the circularly polarized light has a second handedness that is orthogonal to the first handedness.

12. The device of claim 9, wherein the in-coupling grating and the retardation film are disposed at opposite surfaces of the light guide.

13. The device of claim 9, wherein the in-coupling grating is disposed between the retardation film and the light guide.

14. A device, comprising:
a light guide;
an in-coupling element coupled with the light guide and configured to couple a first image light into the light guide as a second image light;
an out-coupling element coupled with the light guide and including a plurality of out-coupling gratings configured to be selectively activated to couple the second image light out of the light guide;
at least one redirecting element coupled with the light guide; and
a controller configured to control the in-coupling element to selectively direct the second image light to propagate in one of a plurality of selectable directions inside the light guide,
wherein the at least one redirecting element is configured to redirect the second image light when the second image light is received from the in-coupling element, to propagate toward a predetermined portion of the out-coupling element.

15. The device of claim 14, wherein
the predetermined portion of the out-coupling element is a first portion of the out-coupling element,
the plurality of selectable directions include a first direction toward one of the at least one redirecting element, and a second direction directly toward a second portion of the out-coupling element, and
the controller is configured to control the in-coupling element to direct the second image light to propagate in the first direction toward one of the at least one redirecting element, or in the second direction directly toward the second portion the out-coupling element.

16. The device of claim 15, wherein the at least one redirecting element is configured to diffract the second image light propagating in the first direction as a third image light propagating toward the first portion of the out-coupling element via total internal reflection (“TIR”).

17. The device of claim 16, wherein the third image light have a same TIR propagation angle inside the light guide as the second image light propagating in the second direction toward the second portion of the out-coupling element.

18. The device of claim 14, wherein
the at least one redirecting element includes a plurality of redirecting elements coupled with the light guide at different positions, and the plurality of selectable directions include directions from the in-coupling element to the plurality of redirecting elements,
the controller is configured to control the in-coupling element to direct the second image light to propagate in a direction selected from the plurality of selectable directions toward one of the plurality of redirecting elements,
the one of the plurality of redirecting elements is configured to redirect the second image light to propagate toward the predetermined portion of the out-coupling element, and
the plurality of redirecting elements are configured to redirect the second image light to propagate toward different predetermined portions of the out-coupling element.

19. The device of claim 14, further comprising a retardation film coupled with the light guide and configured to convert a polarization of the second image light incident thereon.

20. The device of claim 14, further comprising a recycling element coupled with the light guide and configured to recycle a portion of the second image light that is coupled out of the light guide by the in-coupling element.
